(19) United States
(12) Patent Application Publication
(10) Pub. No.: US 2015/0006420 A1
(43) Pub. Date: Jan. 1, 2015

(54) CONCEPTS FOR REPLENISHING SUPPLIES AND DEMAND DRIVEN ADVERTISING

(71) Applicant: LiveCareer Limited, HAMILTON (BM)

(72) Inventor: Brent Andrew Pearson, Wahroonga (AU)

(21) Appl. No.: 14/317,957

(22) Filed: Jun. 27, 2014

Related U.S. Application Data
(60) Provisional application No. 61/840,619, filed on Jun. 28, 2013.

(51) Int. Cl. G06Q 10/10

(52) U.S. Cl. CPC G06Q 10/1053
USPC 705/321

(57) ABSTRACT

Computer program products, methods, systems, apparatus, and computing entities are provided for concepts for replenishing supplies and demand driven advertising. In one embodiment, a campaign to fill an employment position can be initiated. For the campaign, a supply of active candidates can be maintained a various desired levels. Further, the active candidates can be automatically contacted for the employment position.

### CROSS-REFERENCE TO RELATED APPLICATIONS

This application claims priority to U.S. Provisional Application No. 61/840,619 filed Jun. 28, 2013, which is hereby incorporated herein in its entirety by reference.

### BACKGROUND

In the employment market, employers often have a difficult time finding candidates for various positions. Thus, a need exists to help employers find appropriately qualified candidates efficiently and to maintain a supply of the same.

### BRIEF SUMMARY

In general, embodiments of the present invention provide methods, apparatus, systems, computing devices, computing entities, and/or the like.

In accordance with one aspect, a method is provided. In one embodiment, the method comprises (1) determining whether a number of active candidate profiles for a campaign for an employment position satisfies a configurable threshold; (2) responsive to determining that the number of active candidate profiles for the campaign for the employment position does not satisfy the configurable threshold, automatically generating an electronic posting for the employment position; and (3) automatically providing the electronic posting for the employment position to one or more candidate source computing entities for display.

In accordance with another aspect, a computer program product is provided. The computer program product may comprise at least one computer-readable storage medium having computer-readable program code portions stored therein, the computer-readable program code portions comprising executable portions configured to (1) determine whether a number of active candidate profiles for a campaign for an employment position satisfies a configurable threshold; (2) responsive to determining that the number of active candidate profiles for the campaign for the employment position does not satisfy the configurable threshold, automatically generate an electronic posting for the employment position; and (3) automatically provide the electronic posting for the employment position to one or more candidate source computing entities for display.

In accordance with yet another aspect, an apparatus comprising at least one processor and at least one memory including computer program code is provided. In one embodiment, the at least one memory and the computer program code may be configured to, with the processor, cause the apparatus to (1) determine whether a number of active candidate profiles for a campaign for an employment position satisfies a configurable threshold; (2) responsive to determining that the number of active candidate profiles for the campaign for the employment position does not satisfy the configurable threshold, automatically generate an electronic posting for the employment position; and (3) automatically provide the electronic posting for the employment position to one or more candidate source computing entities for display.

In accordance with one aspect, a method is provided. In one embodiment, the method comprises for a campaign for an employment position, identifying one or more active candidate profiles from a first plurality of active candidate profiles for the campaign for the employment position, wherein (a) an active candidate profile identifies a candidate who has responded to a notification within a configurable time period indicating interest in the employment position, and (b) each of the one or more active candidate profiles indicate that the respective candidates are within an acceptable range from the location of the employment position.

In accordance with another aspect, a computer program product is provided. The computer program product may comprise at least one computer-readable storage medium having computer-readable program code portions stored therein, the computer-readable program code portions comprising executable portions configured to for a campaign for an employment position, identify one or more active candidate profiles from a first plurality of active candidate profiles for the campaign for the employment position, wherein (a) an active candidate profile identifies a candidate who has responded to a notification within a configurable time period indicating interest in the employment position, and (b) each of the one or more active candidate profiles indicate that the respective candidates are within an acceptable range from the location of the employment position.

In accordance with yet another aspect, an apparatus comprising at least one processor and at least one memory including computer program code is provided. In one embodiment, the at least one memory and the computer program code may be configured to, with the processor, cause the apparatus to for a campaign for an employment position, identify one or more active candidate profiles from a first plurality of active candidate profiles for the campaign for the employment position, wherein (a) an active candidate profile identifies a candidate who has responded to a notification within a configurable time period indicating interest in the employment position, and (b) each of the one or more active candidate profiles indicate that the respective candidates are within an acceptable range from the location of the employment position.

In accordance with one aspect, a method is provided. In one embodiment, the method comprises (1) for a campaign for an employment position, identifying one or more active candidate profiles from a plurality of active candidate profiles for the campaign for the employment position, wherein (a) an active candidate profile identifies a candidate who has responded to a notification within a configurable time period indicating interest in the employment position and (b) each of the one or more candidate profiles comprises communications preferences; (2) generating a notification for at least one of the one or more active candidate profiles from based at least in part on the notification preferences; and (3) providing the notification for the at least one of the one or more active candidate profiles to an electronic destination address based at least in part on the notification preferences.

In accordance with another aspect, a computer program product is provided. The computer program product may comprise at least one computer-readable storage medium having computer-readable program code portions stored therein, the computer-readable program code portions comprising executable portions configured to (1) for a campaign for an employment position, identify one or more active candidate profiles from a plurality of active candidate profiles for the campaign for the employment position, wherein (a) an active candidate profile identifies a candidate who has responded to a notification within a configurable time period indicating interest in the employment position and (b) each of the one or more candidate profiles comprises communications preferences; (2) generate a notification for at least one of the one or more active candidate profiles from based at least in part on the notification preferences; and (3) provide the notification for the at least one of the one or more active candidate profiles to an electronic destination address based at least in part on the notification preferences.

In accordance with yet another aspect, an apparatus comprising at least one processor and at least one memory including computer program code is provided. In one embodiment, the at least one memory and the computer program code may be configured to, with the processor, cause the apparatus to (1) for a campaign for an employment position, identify one or more active candidate profiles from a plurality of active candidate profiles for the campaign for the employment position, wherein (a) an active candidate profile identifies a candidate who has responded to a notification within a configurable time period indicating interest in the employment position and (b) each of the one or more candidate profiles comprises communications preferences; (2) generate a notification for at least one of the one or more active candidate profiles from based at least in part on the notification preferences; and (3) provide the notification for the at least one of the one or more active candidate profiles to an electronic destination address based at least in part on the notification preferences.

In accordance with one aspect, a method is provided. In one embodiment, the method comprises (1) for a first active search for a first employment position and a second active search for a second employment position, automatically generating a first electronic posting for the first employment position and a second electronic posting for the second employment position, wherein (a) each of the first active search and the second active search identifies one or more active candidate profiles from a plurality of active candidate profiles, (b) the first active search is associated with a first employer, and (c) the second active search is associated with a second employer; (2) providing the first electronic posting and the second electronic posting to one or more candidate source computing entities for display; (3) receiving data associated with the first electronic posting from at least one of the one or more candidate source computing entities; and (4) responsive to receiving the data associated with the first electronic posting, determining a first brand score for the first employer.

In accordance with another aspect, a computer program product is provided. The computer program product may comprise at least one computer-readable storage medium having computer-readable program code portions stored therein, the computer-readable program code portions comprising executable portions configured to (1) for a first active search for a first employment position and a second active search for a second employment position, automatically generate a first electronic posting for the first employment position and a second electronic posting for the second employment position, wherein (a) each of the first active search and the second active search identifies one or more active candidate profiles from a plurality of active candidate profiles, (b) the first active search is associated with a first employer, and (c) the second active search is associated with a second employer; (2) provide the first electronic posting and the second electronic posting to one or more candidate source computing entities for display; (3) receive data associated with the first electronic posting from at least one of the one or more candidate source computing entities; and (4) responsive to receiving the data associated with the first electronic posting, determine a first brand score for the first employer.

In accordance with yet another aspect, an apparatus comprising at least one processor and at least one memory including computer program code is provided. In one embodiment, the at least one memory and the computer program code may be configured to, with the processor, cause the apparatus to (1) for a first active search for a first employment position and a second active search for a second employment position, automatically generate a first electronic posting for the first employment position and a second electronic posting for the second employment position, wherein (a) each of the first active search and the second active search identifies one or more active candidate profiles from a plurality of active candidate profiles, (b) the first active search is associated with a first employer, and (c) the second active search is associated with a second employer; (2) provide the first electronic posting and the second electronic posting to one or more candidate source computing entities for display; (3) receive data associated with the first electronic posting from at least one of the one or more candidate source computing entities; and (4) responsive to receiving the data associated with the first electronic posting, determine a first brand score for the first employer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 10000 is an overview of a system that can be used to practice embodiments of the present invention.

FIG. 10001 is an exemplary schematic diagram of a management computing entity 100 according to one embodiment of the present invention.

FIG. 10002 is an exemplary schematic diagram of a customer/employer computing entity and/or a candidate computing entity according to one embodiment of the present invention.

FIGS. 10003A, 10003B, and 10003C are flowcharts illustrating operations and processes that can be used in accordance with various embodiments of the present invention.

FIGS. 10004-10097 are exemplary input and output that can be produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

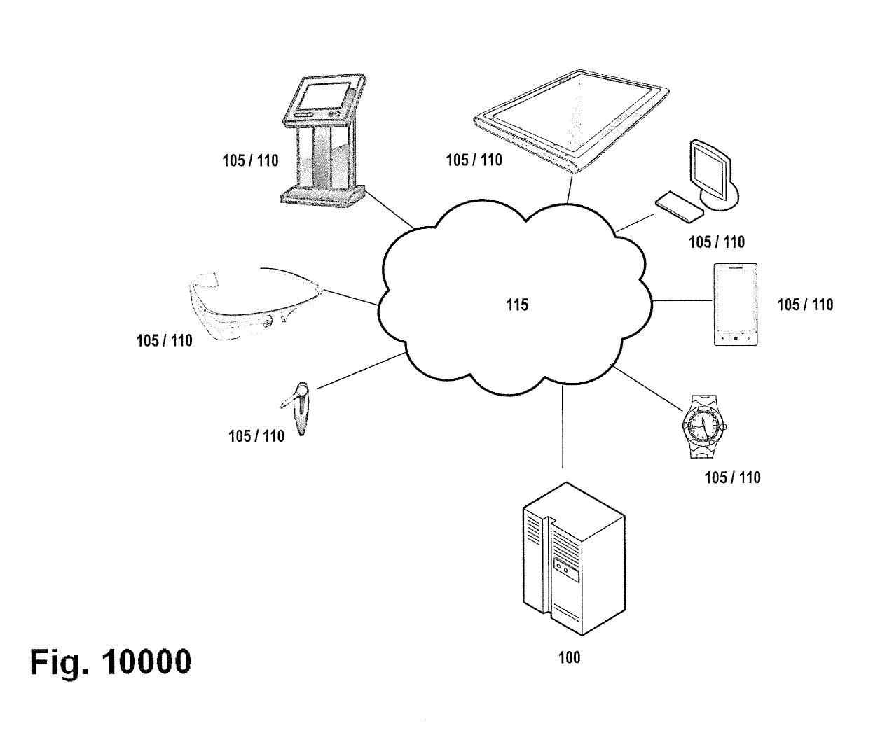

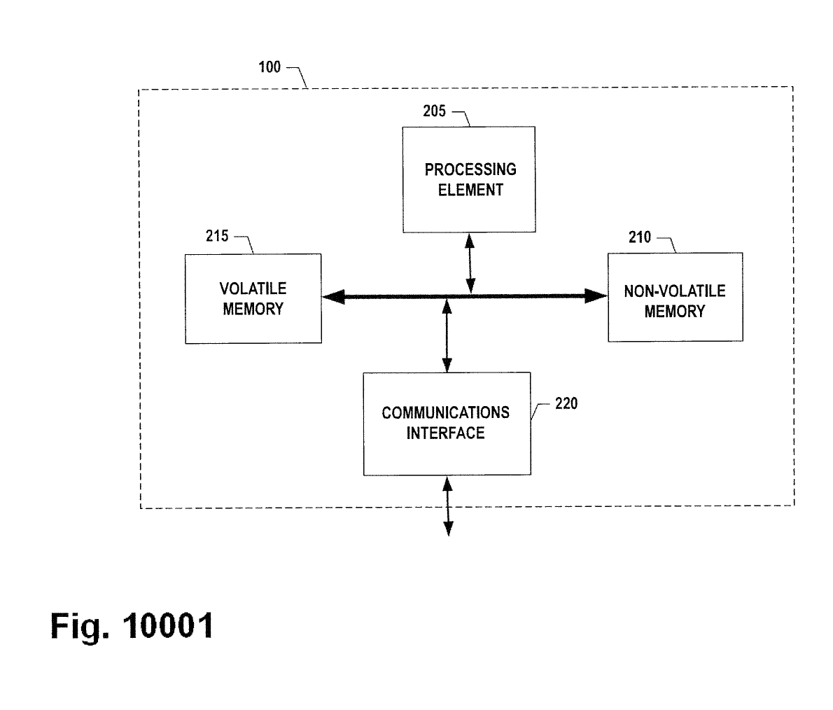

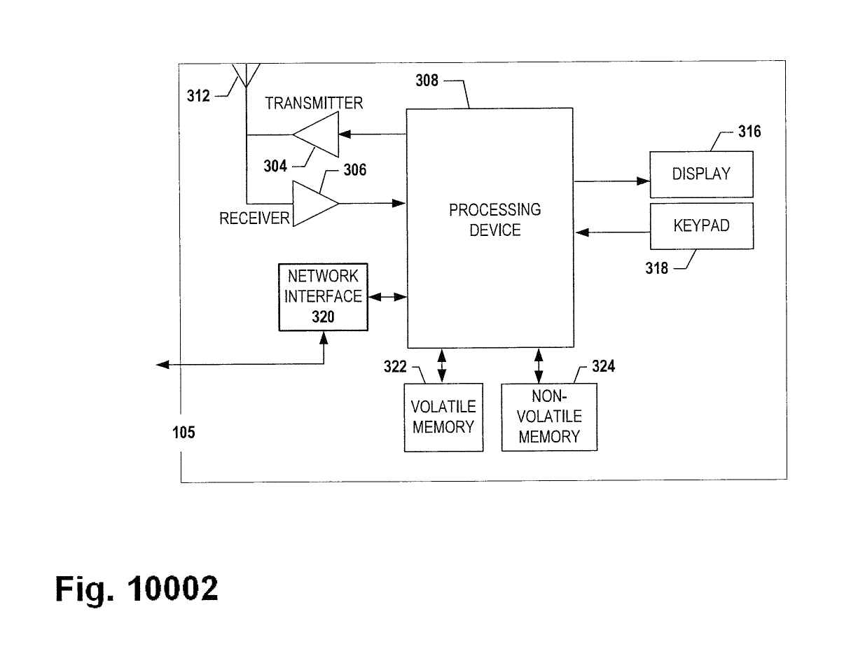

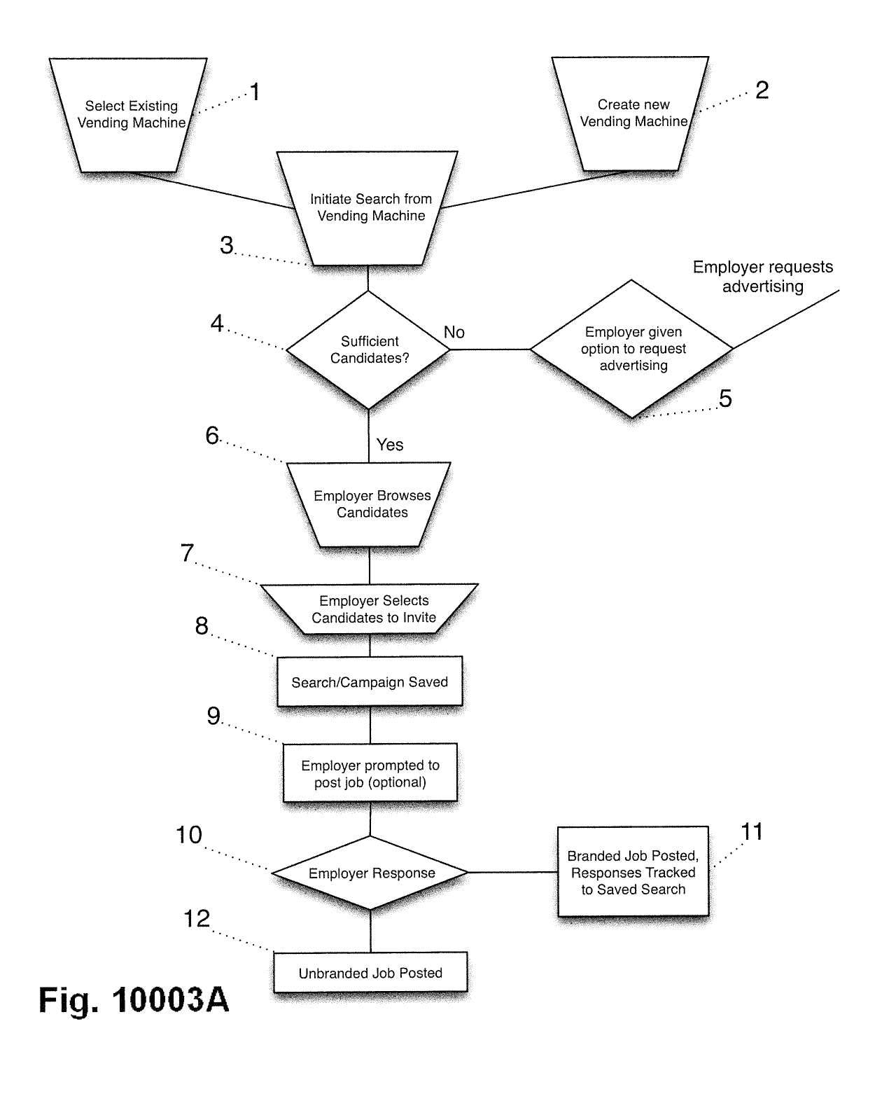

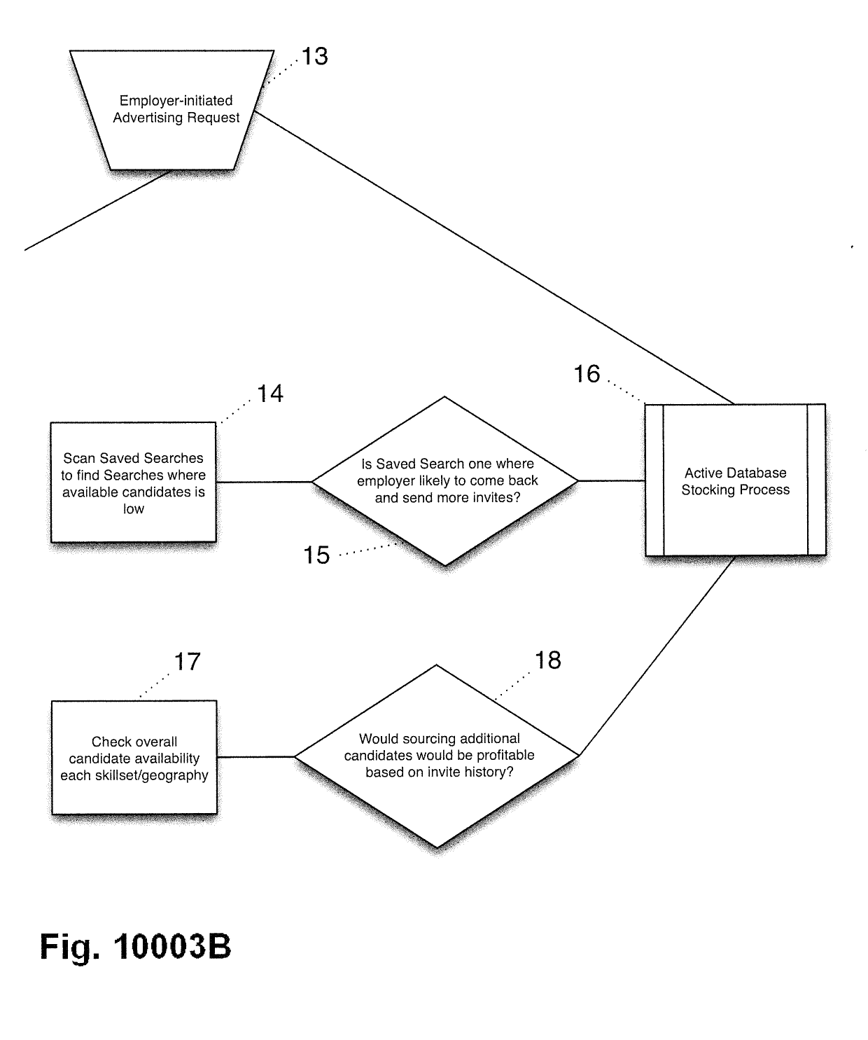

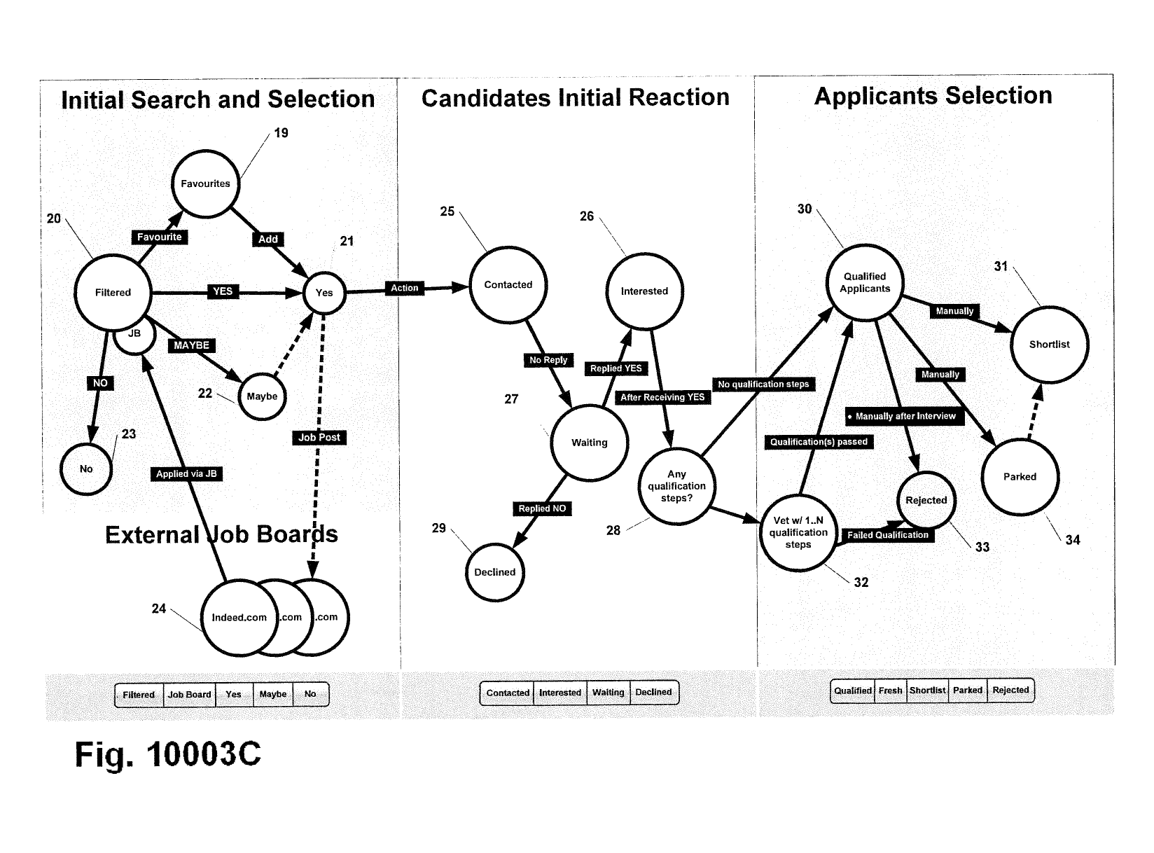

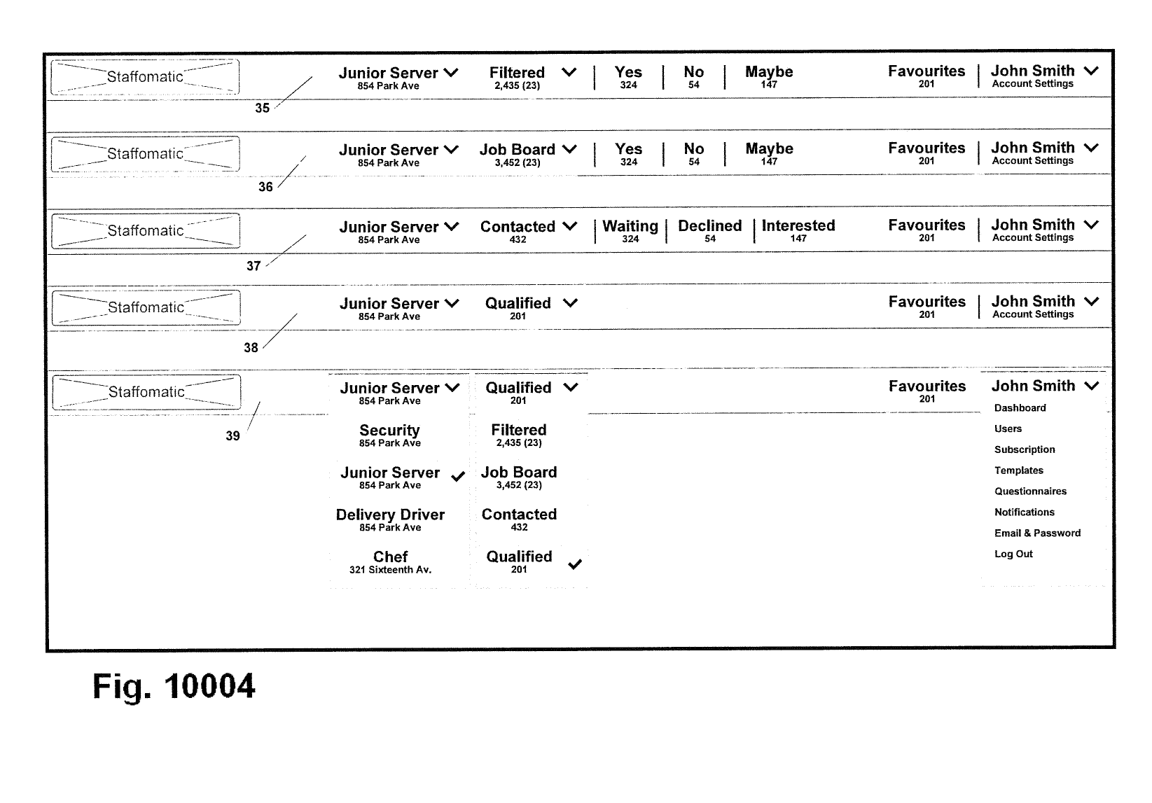

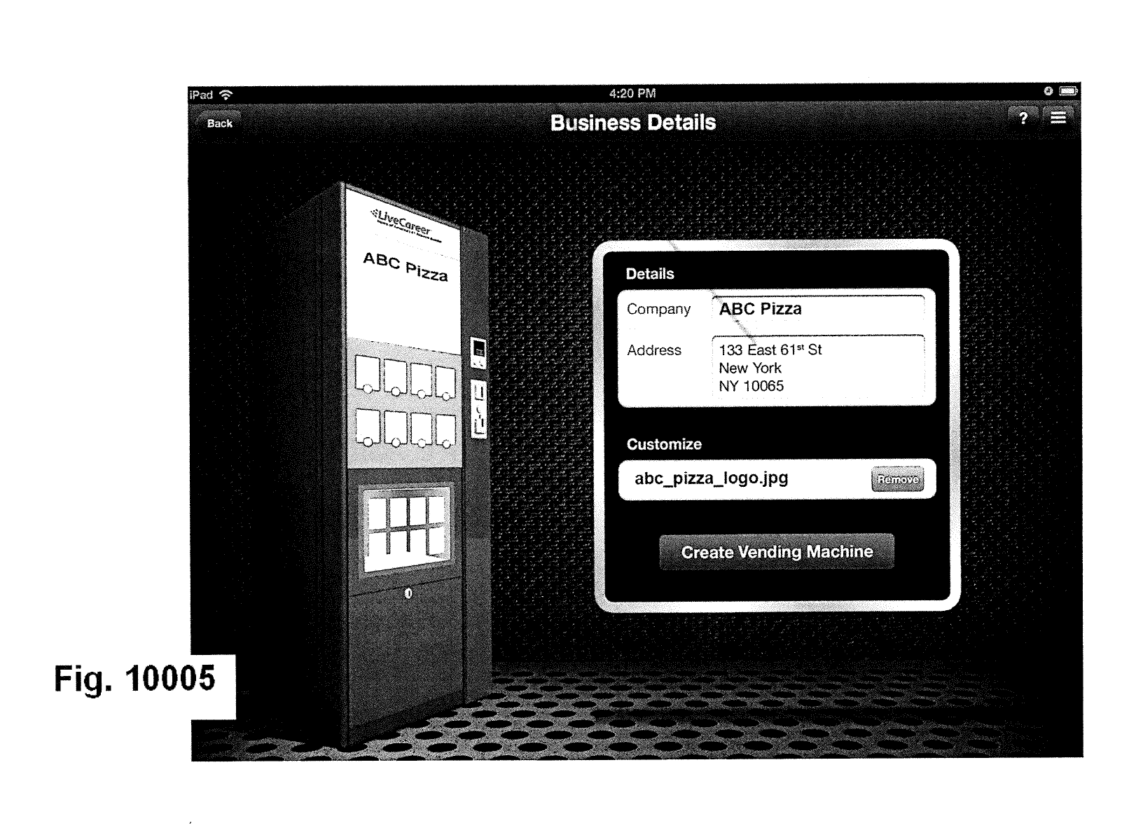

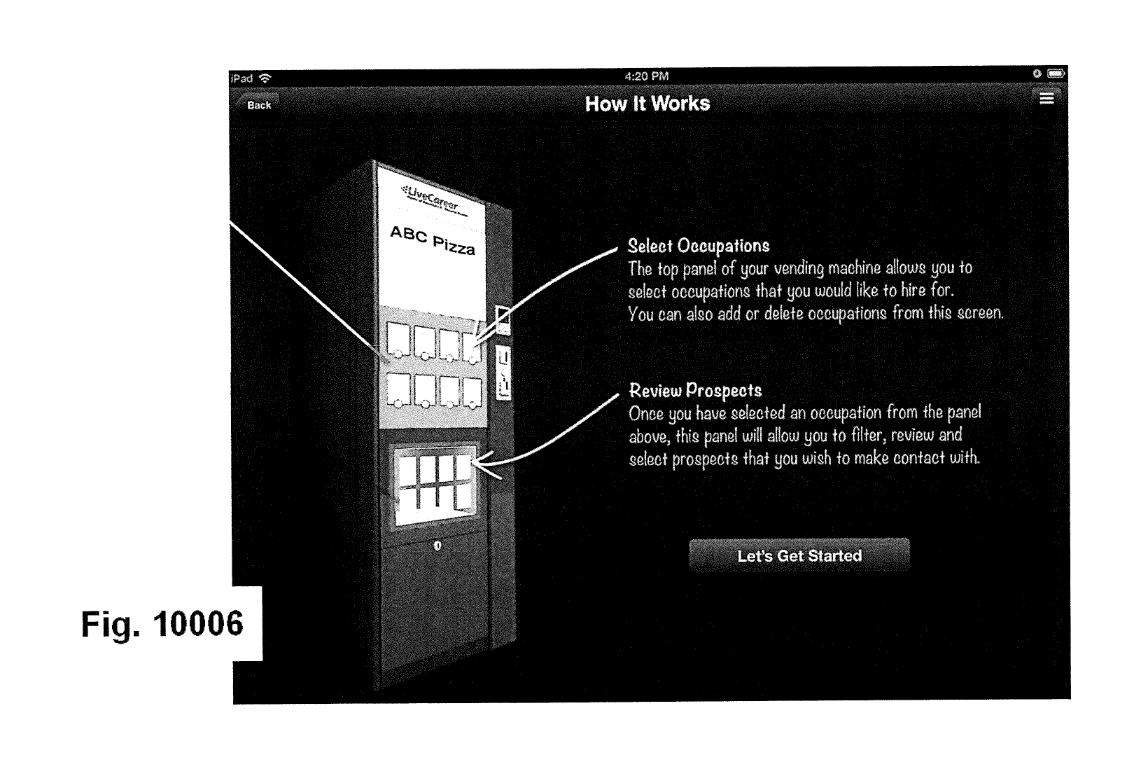

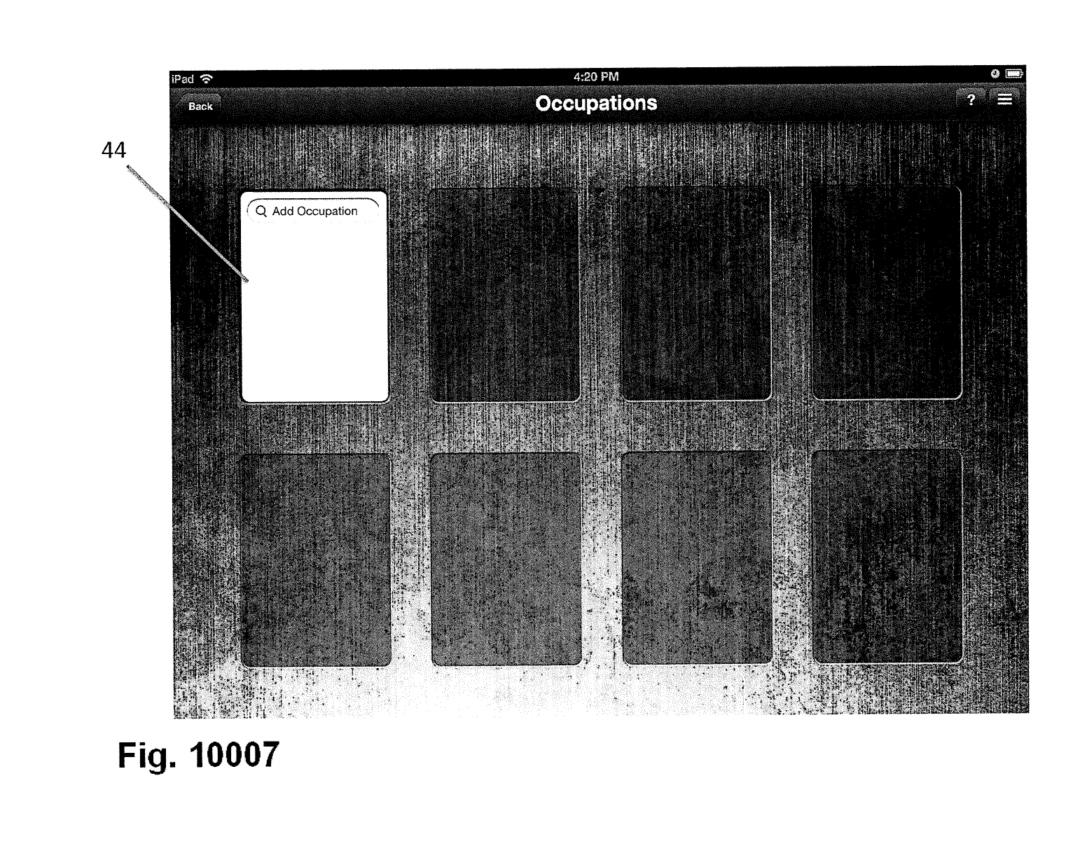

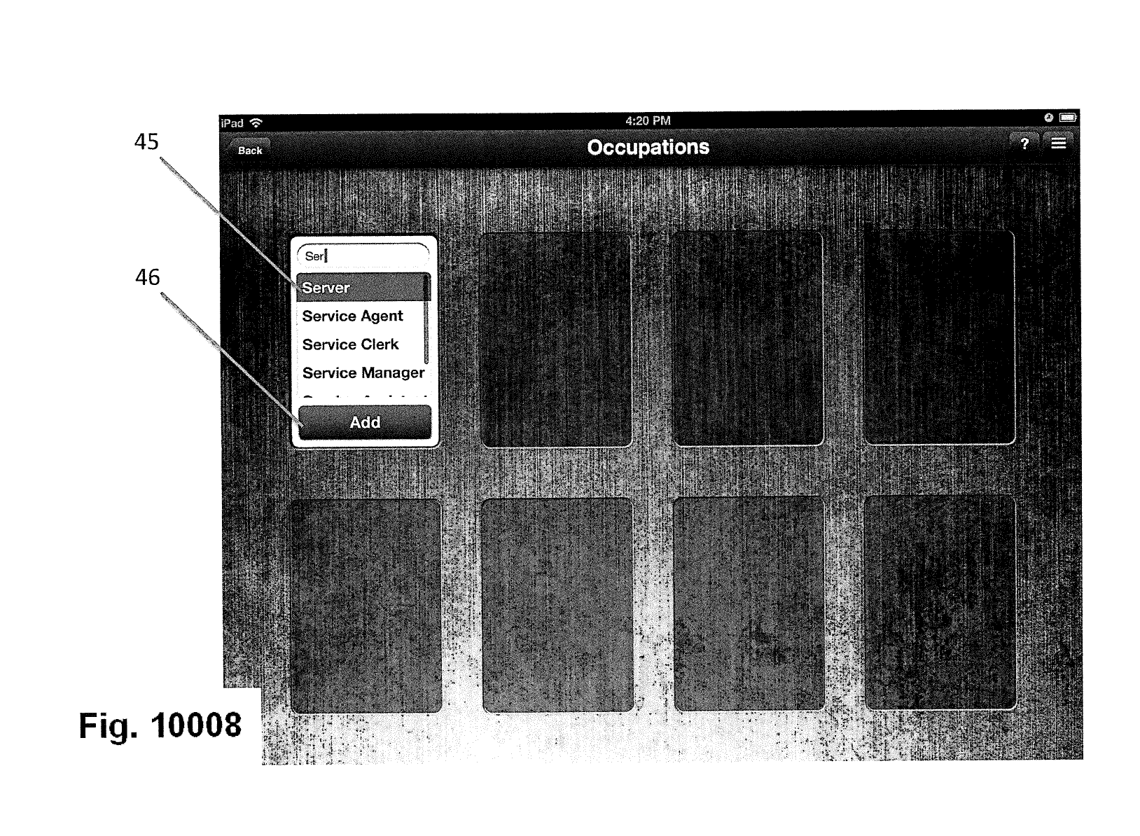

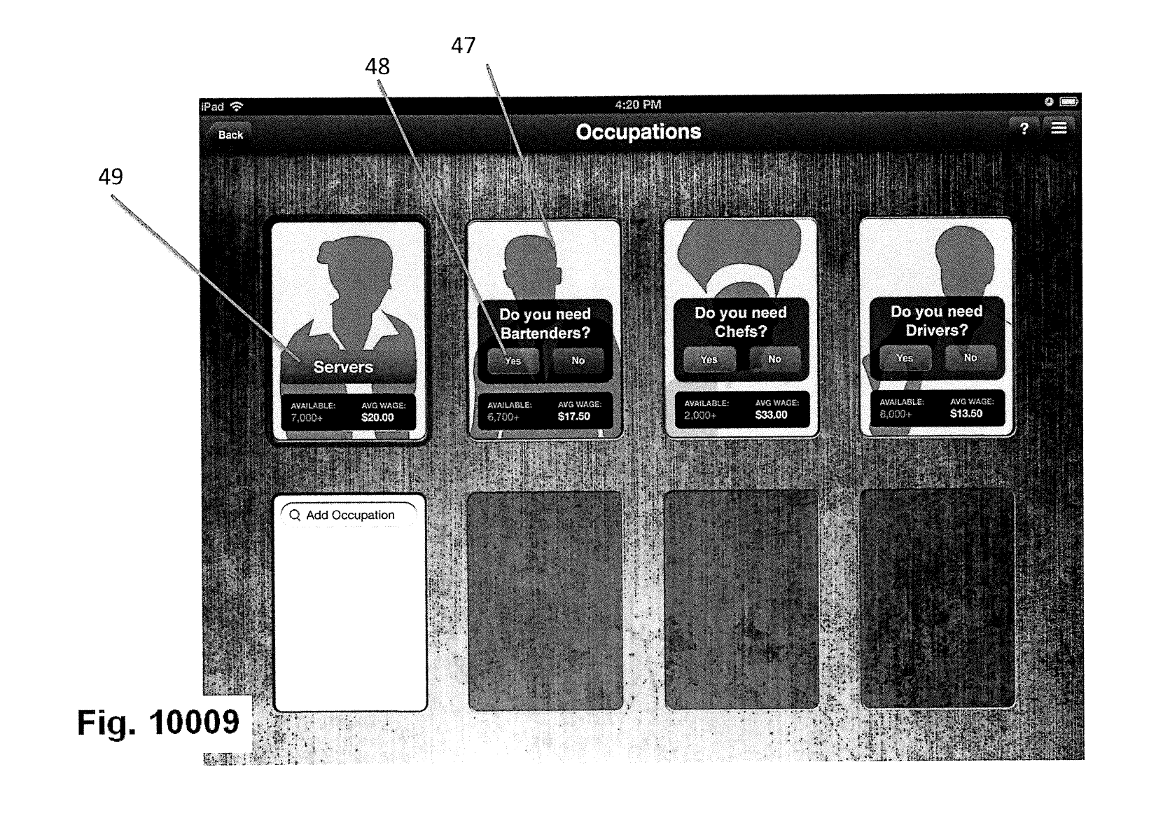

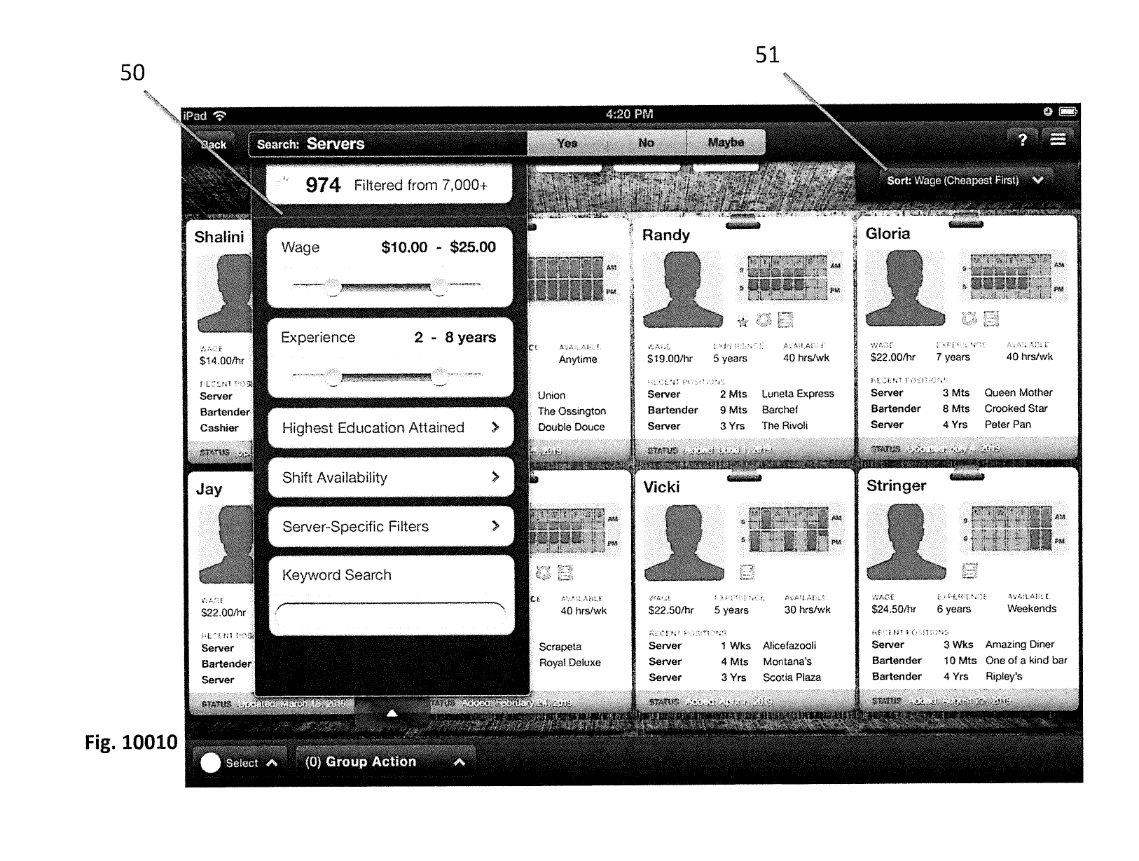

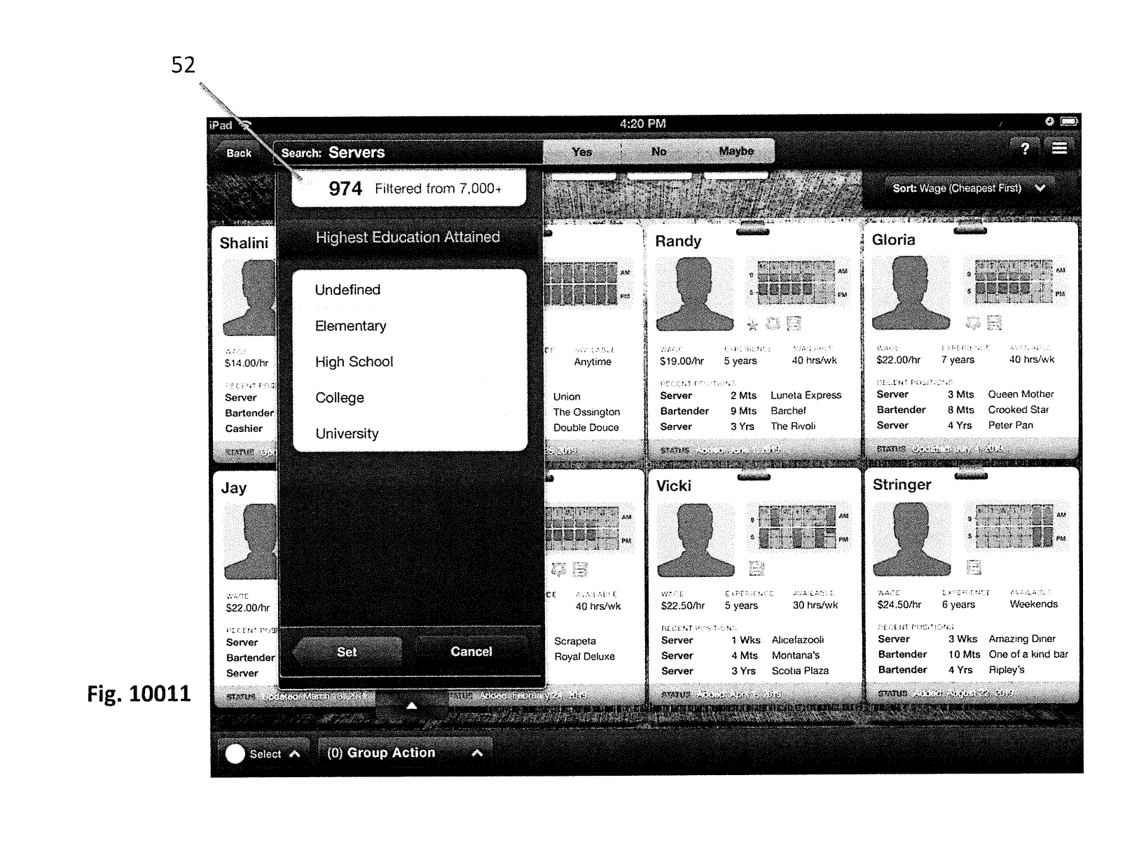

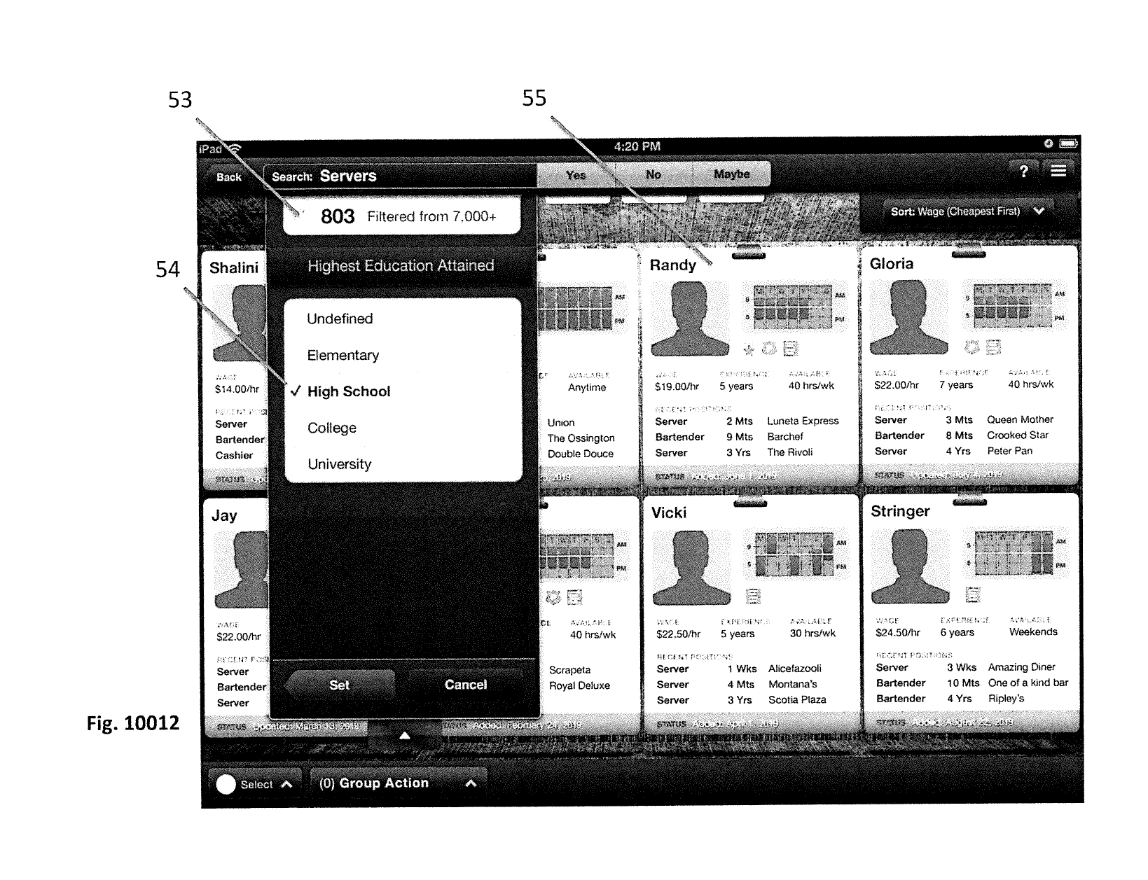

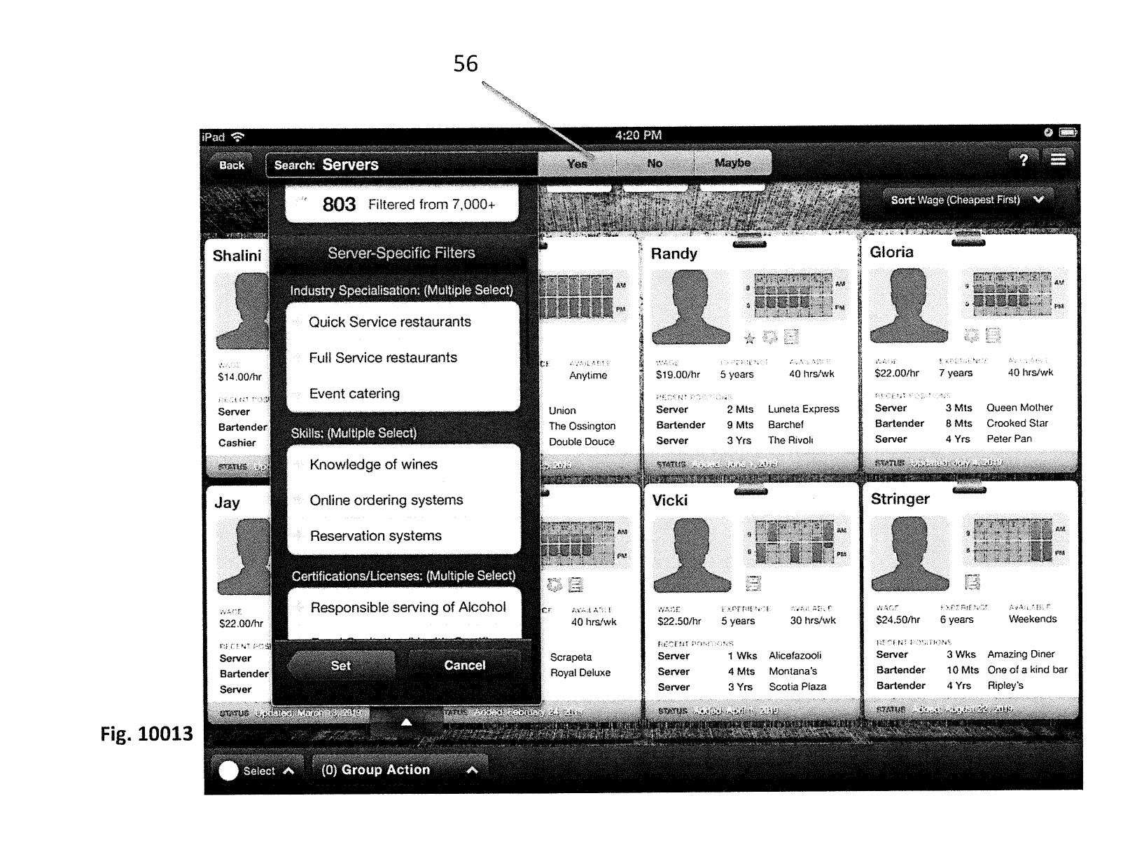

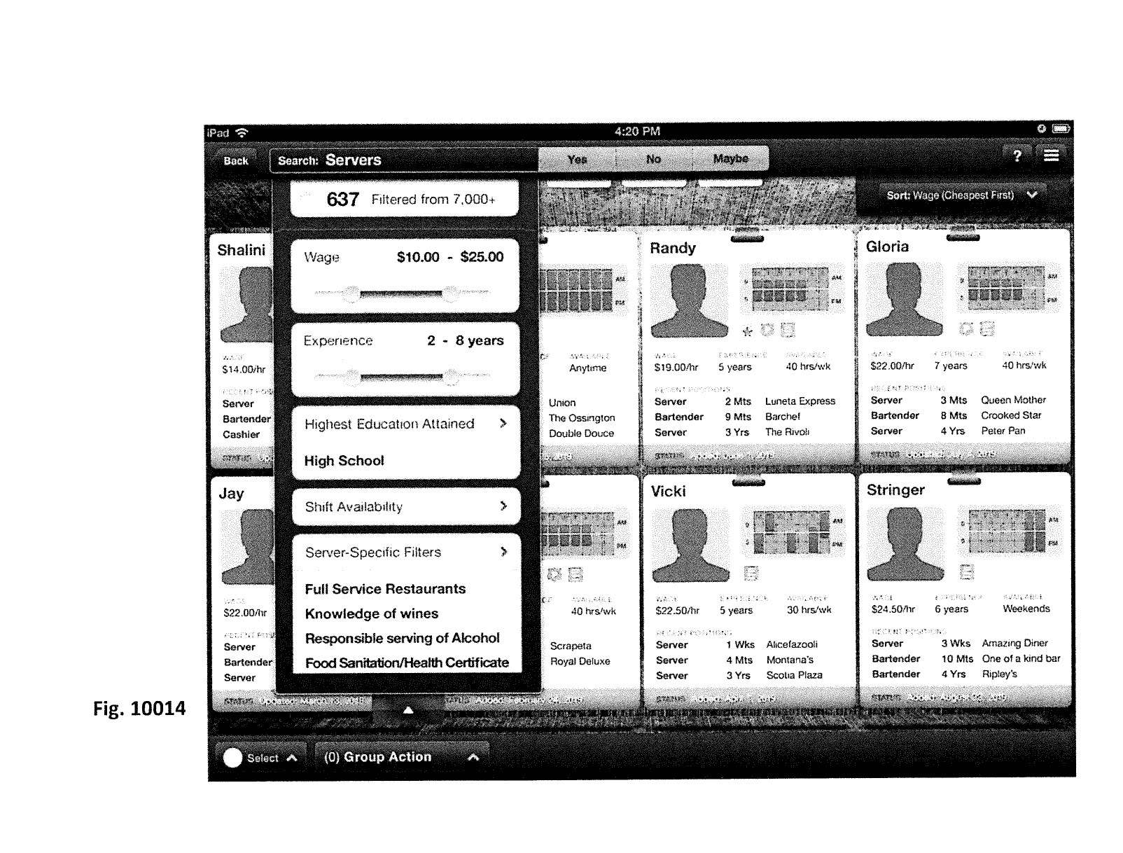

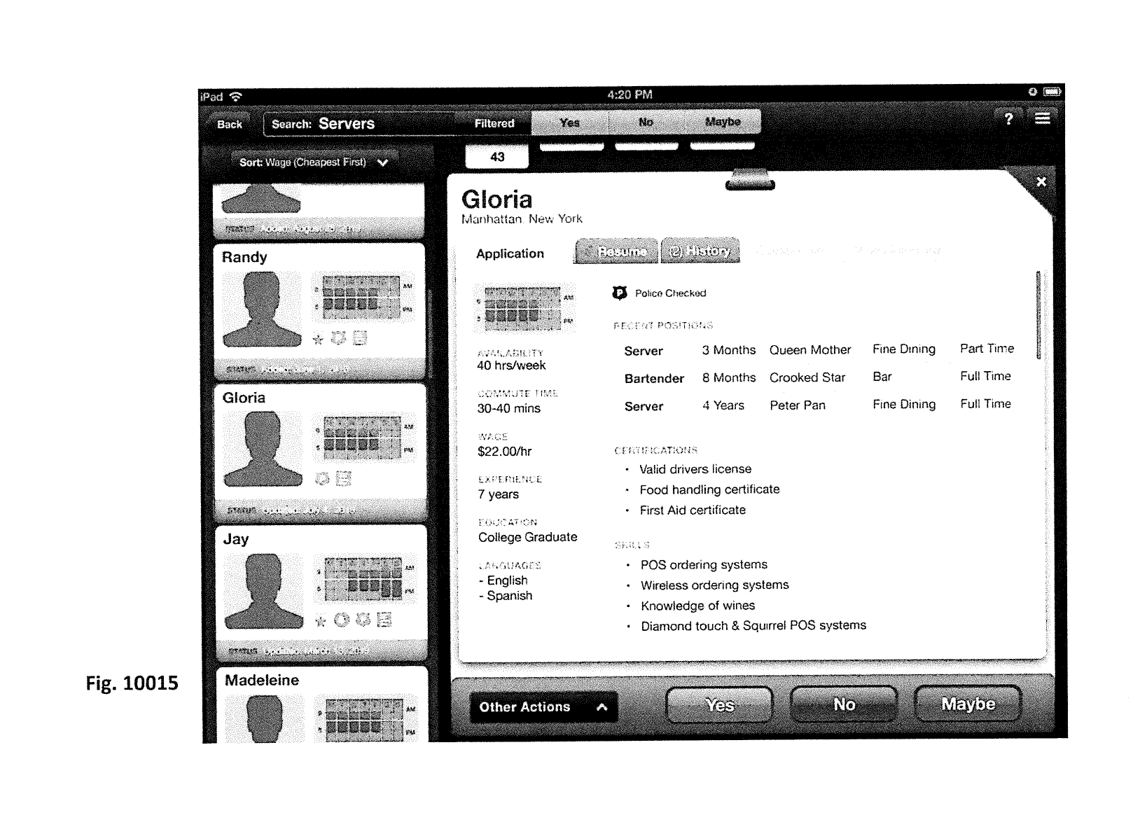

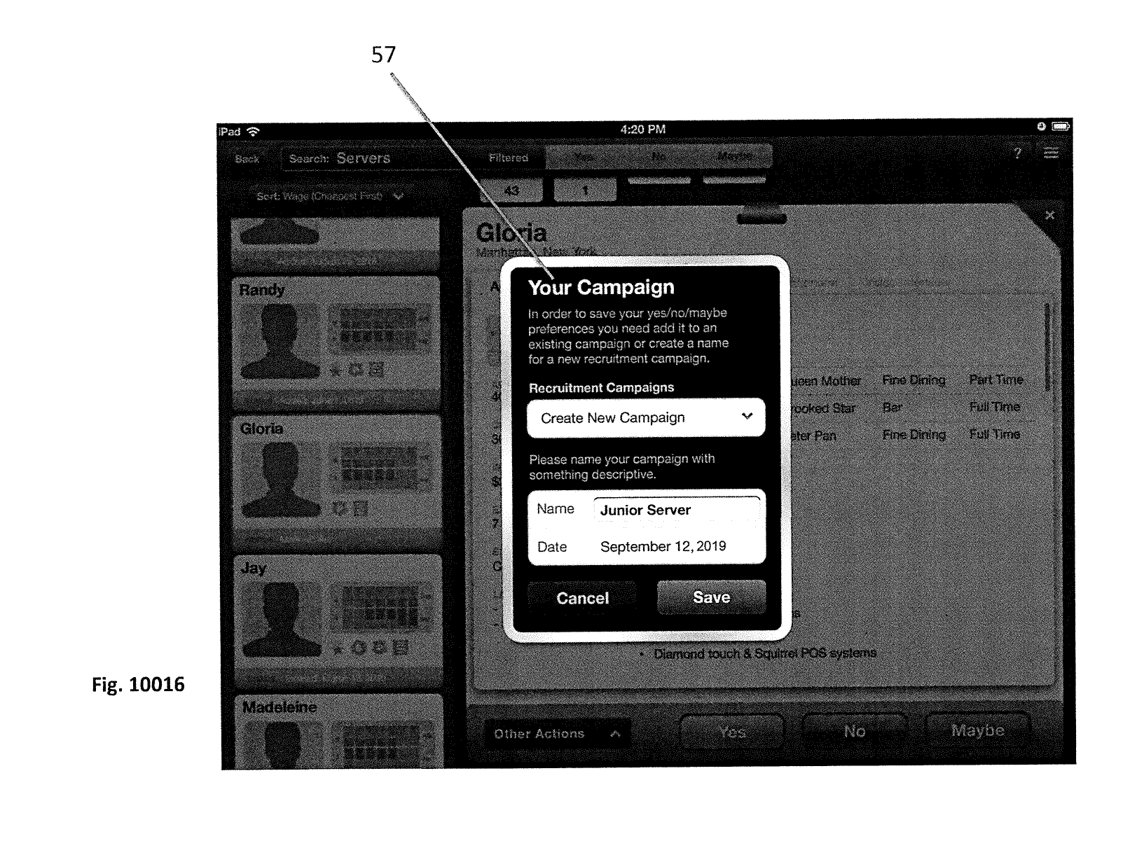

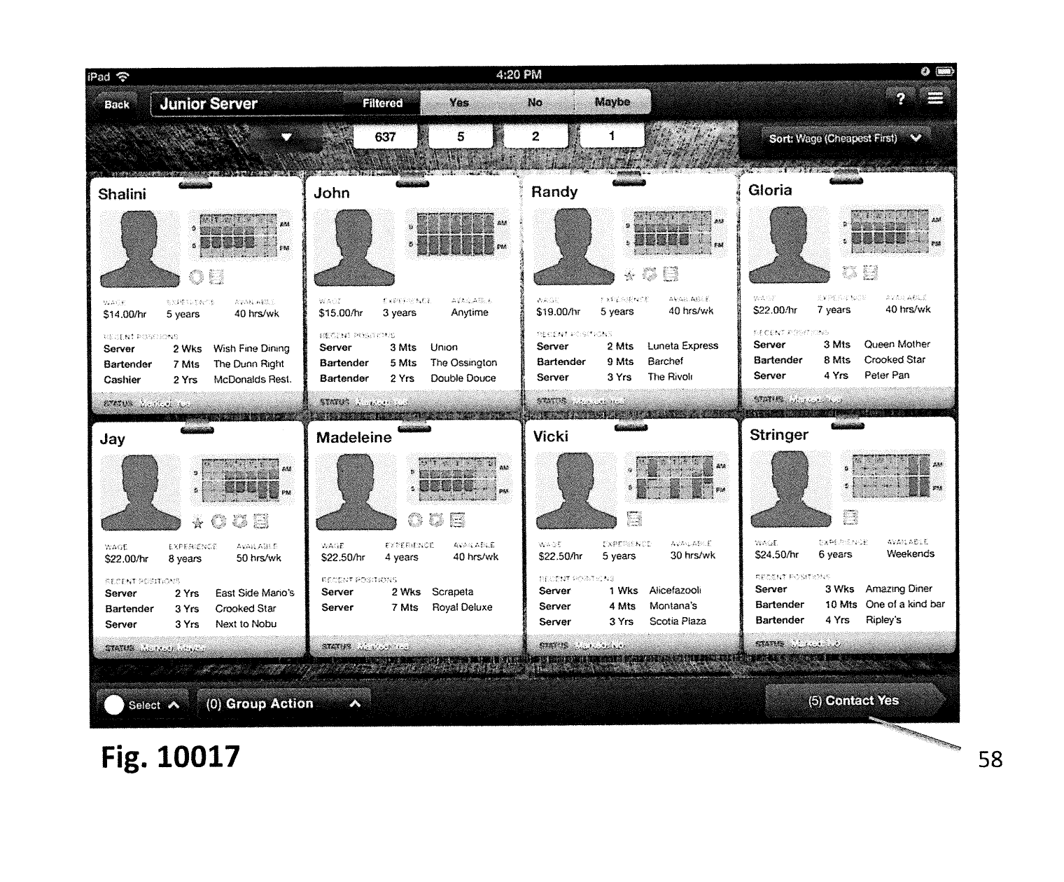

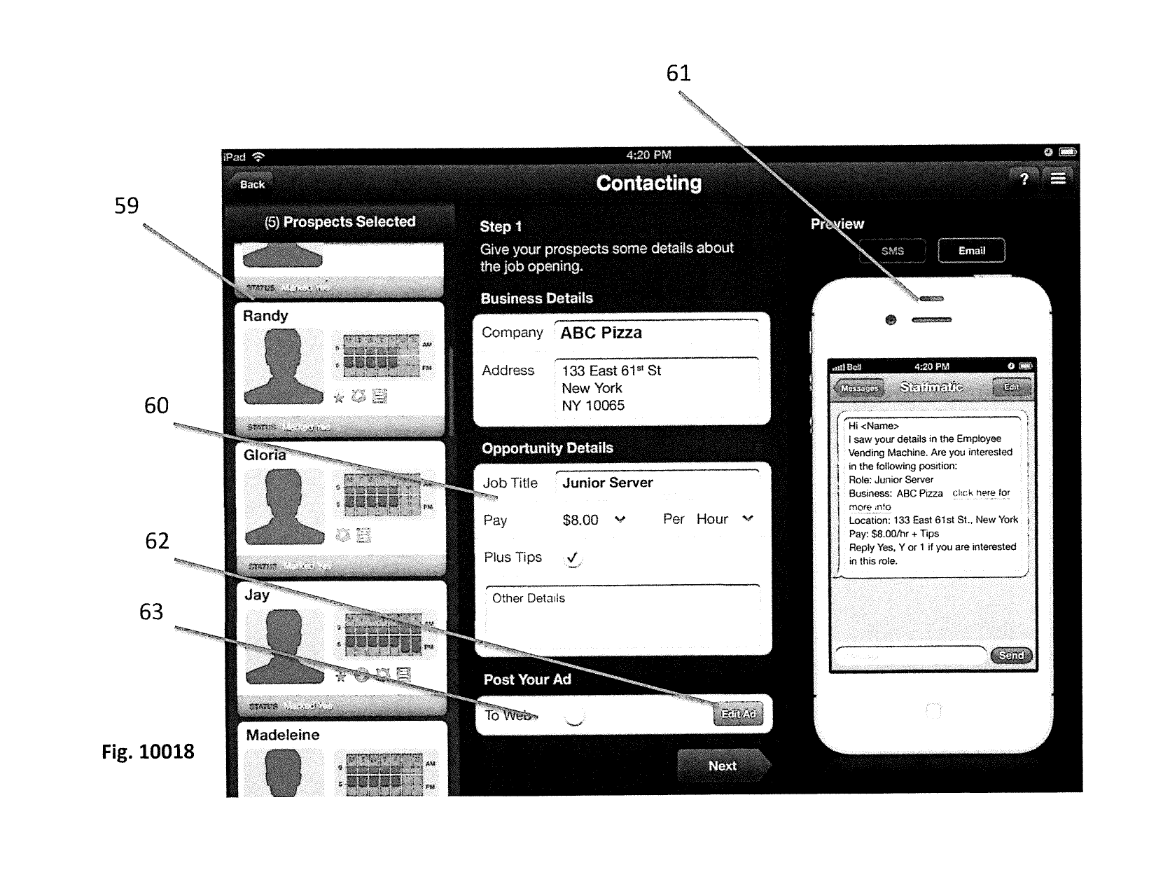

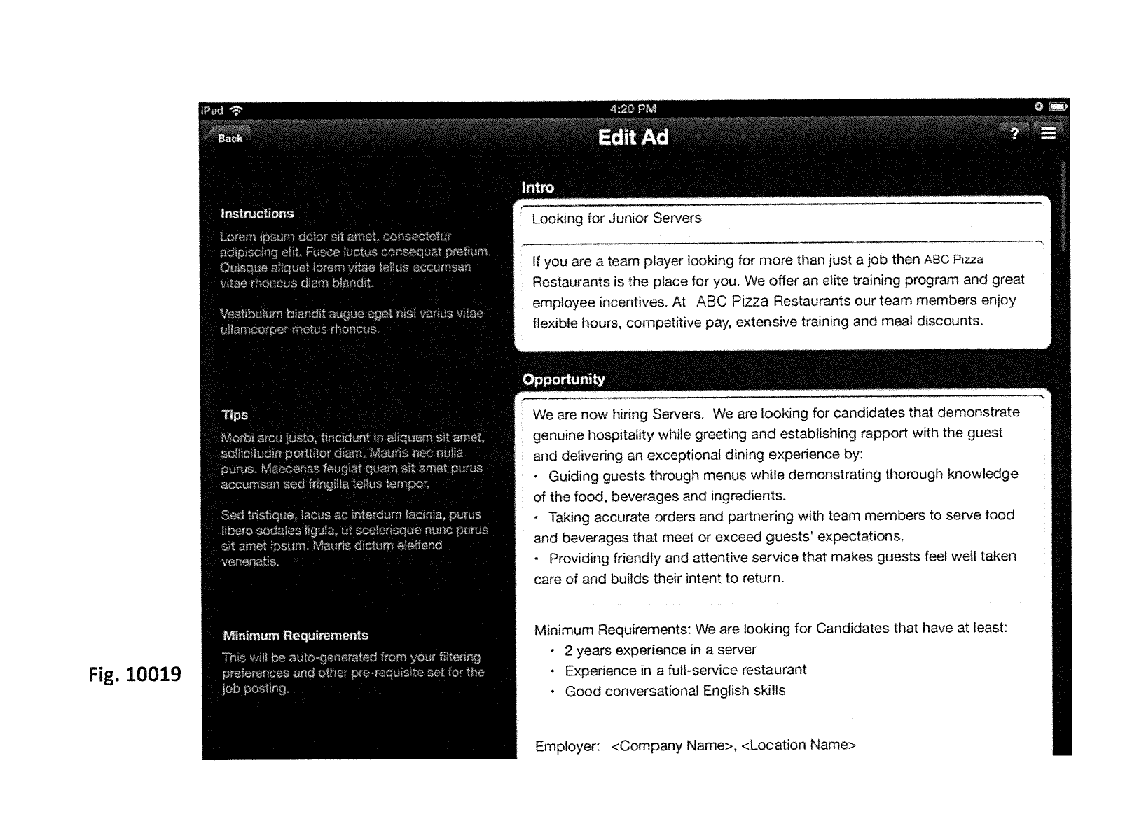

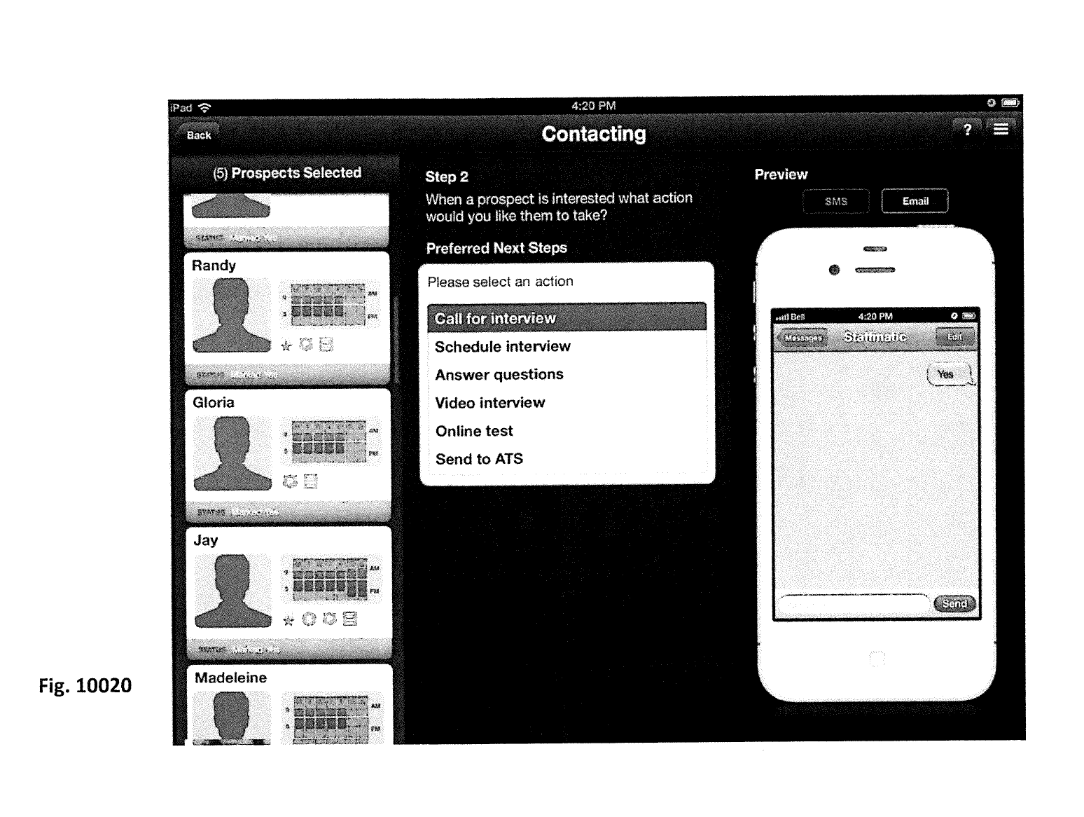

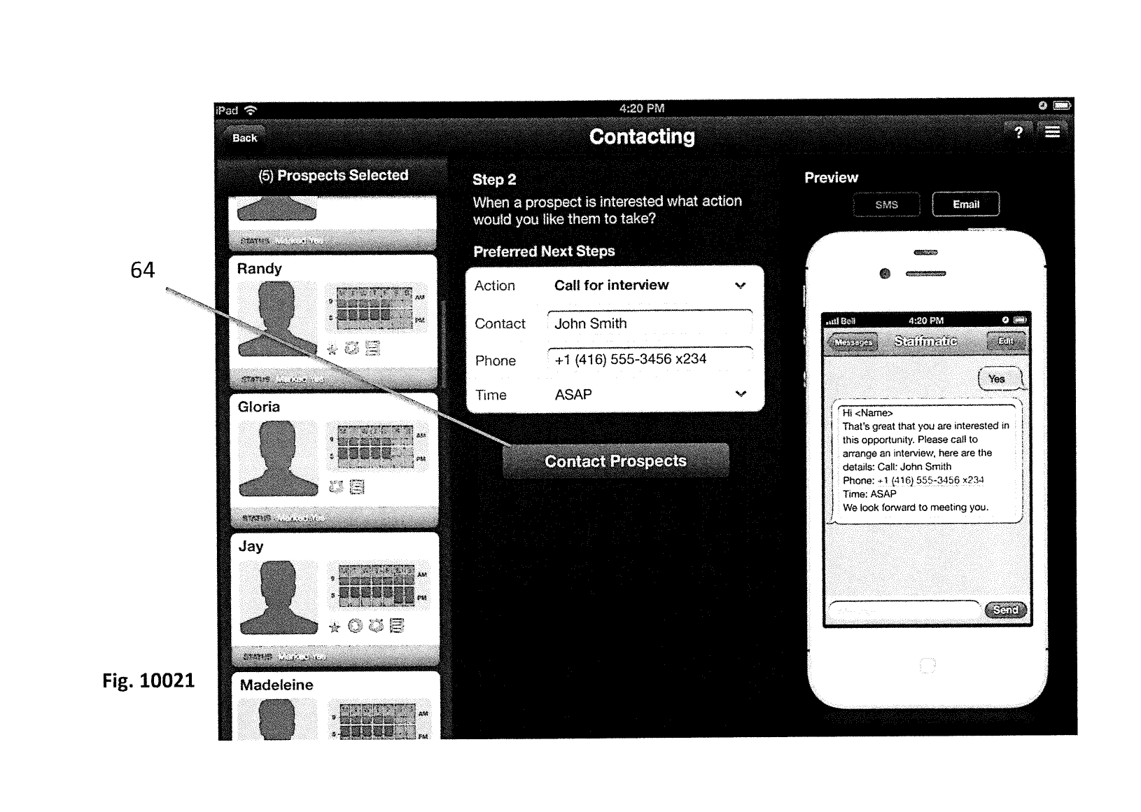

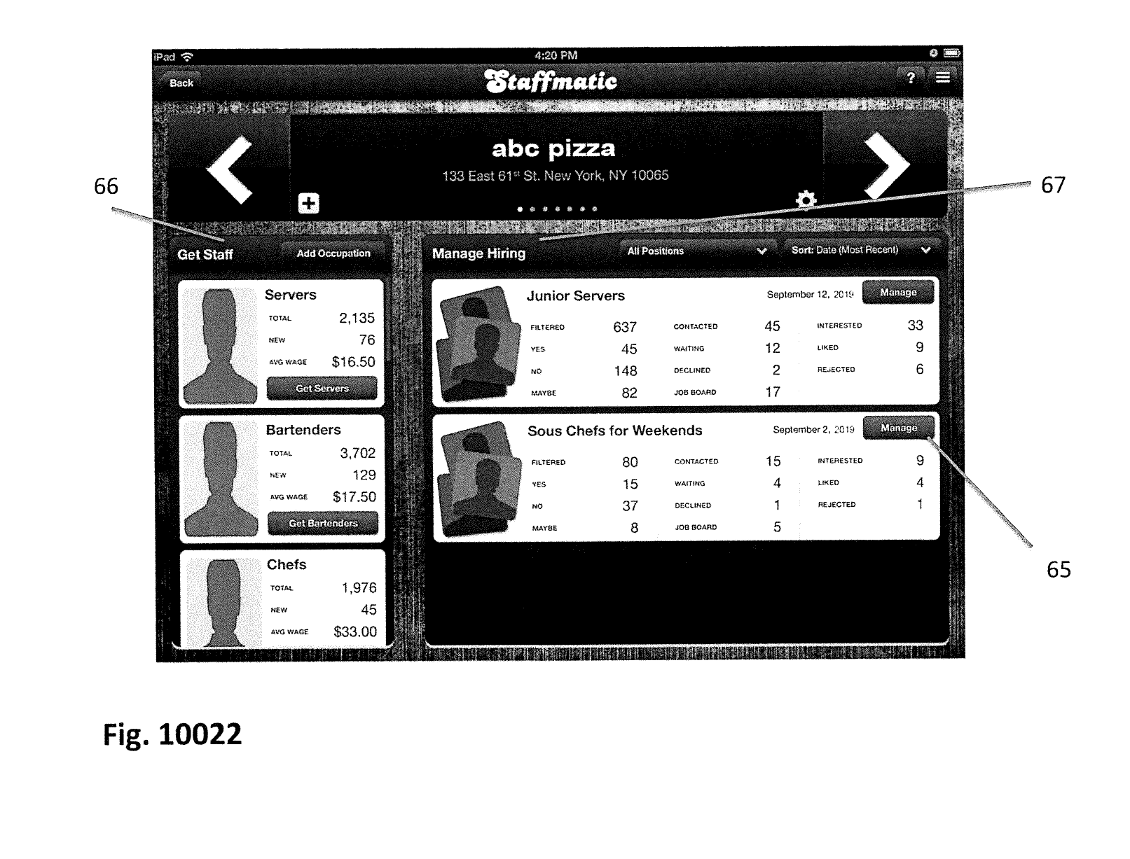

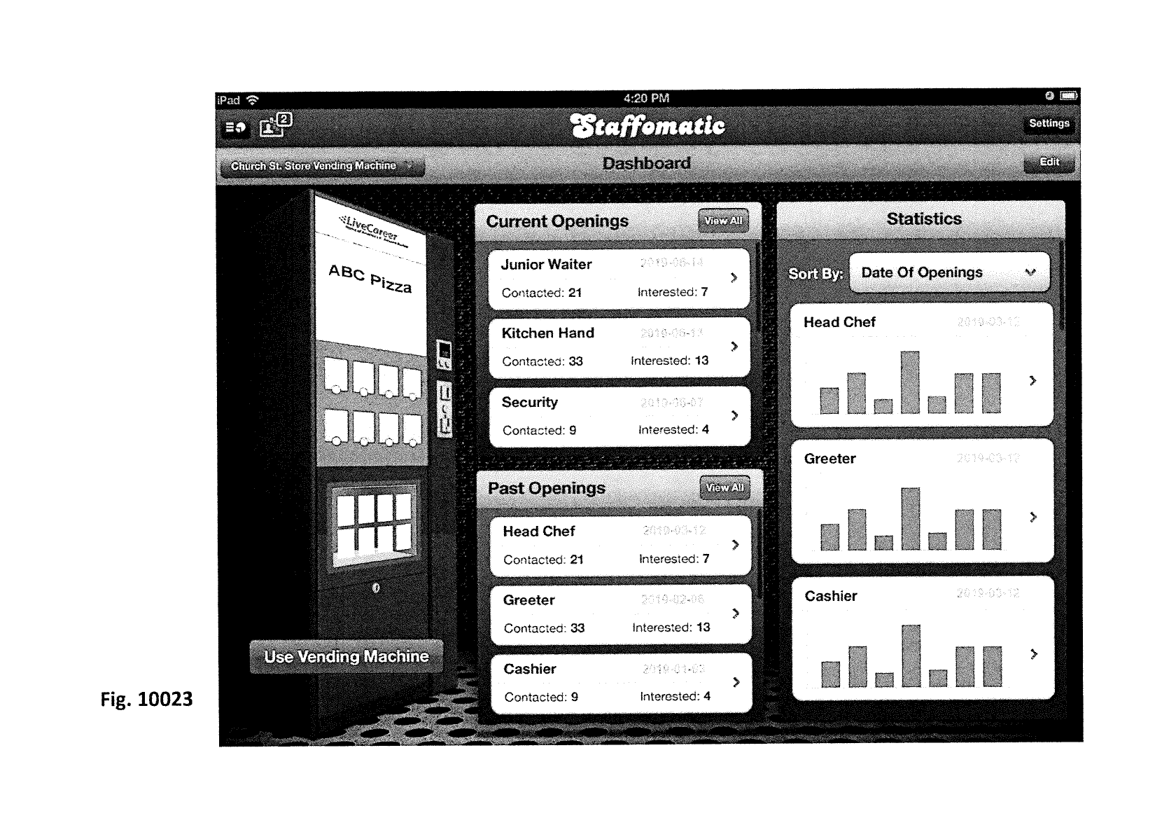

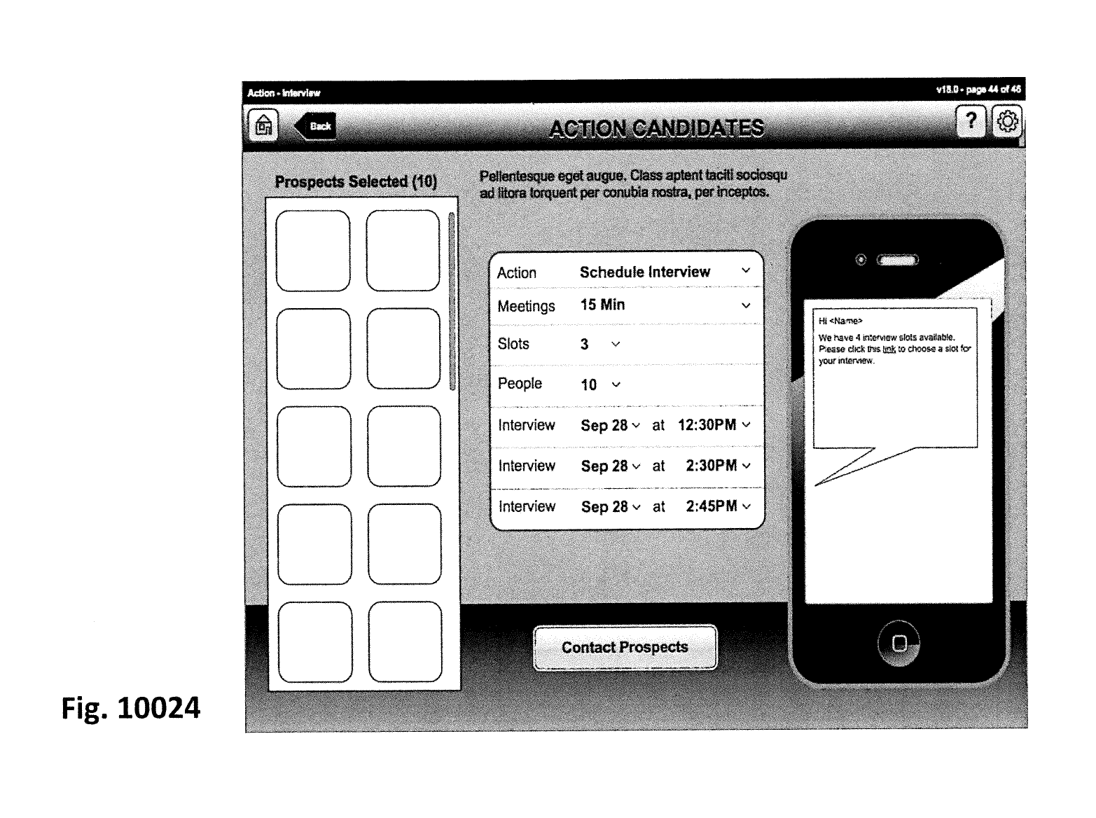

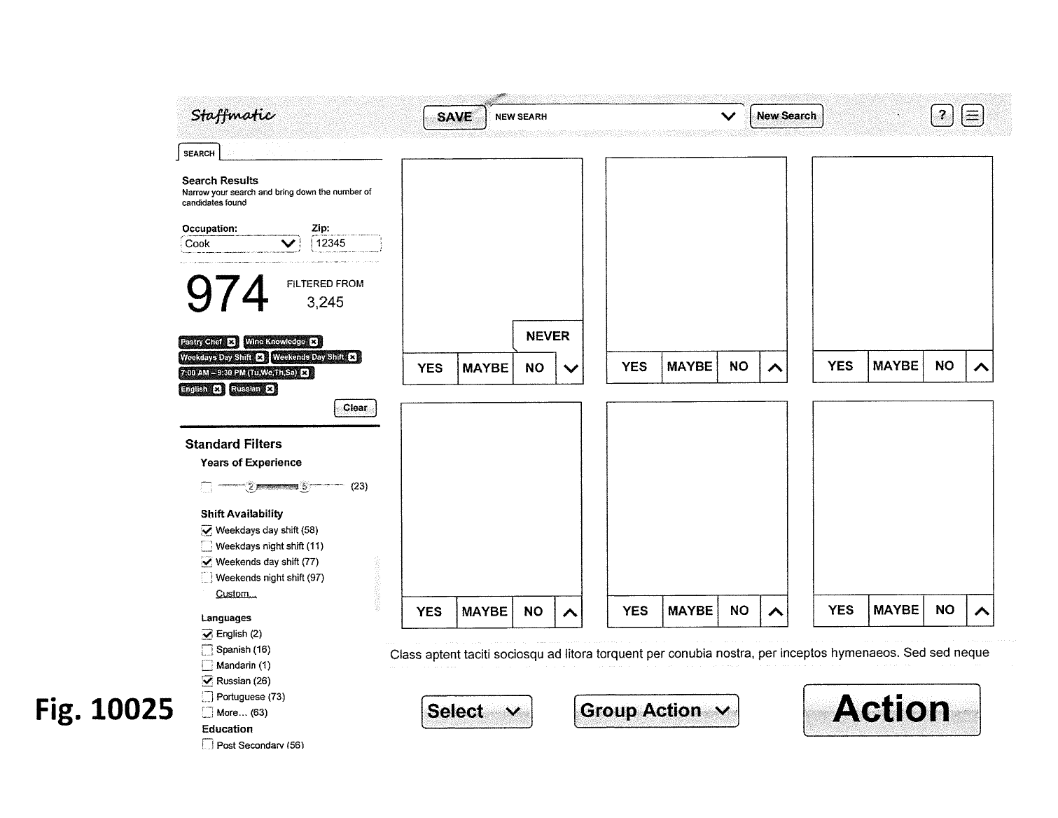

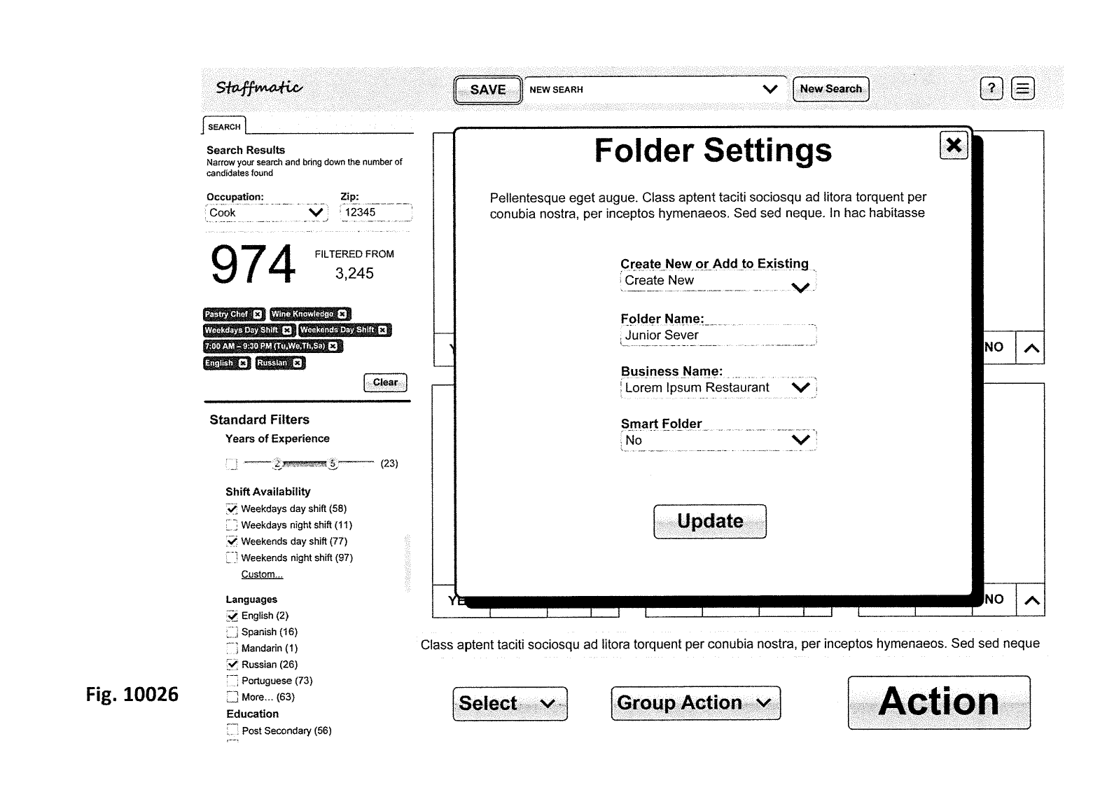

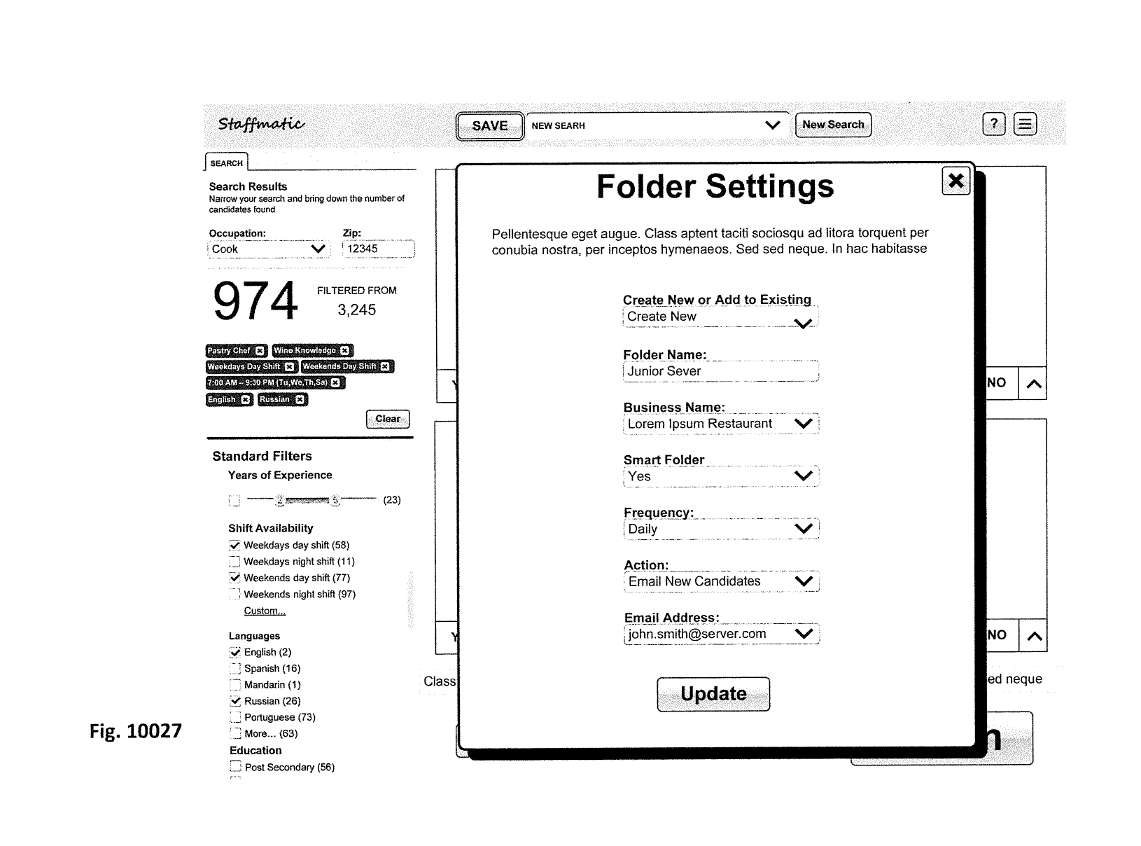

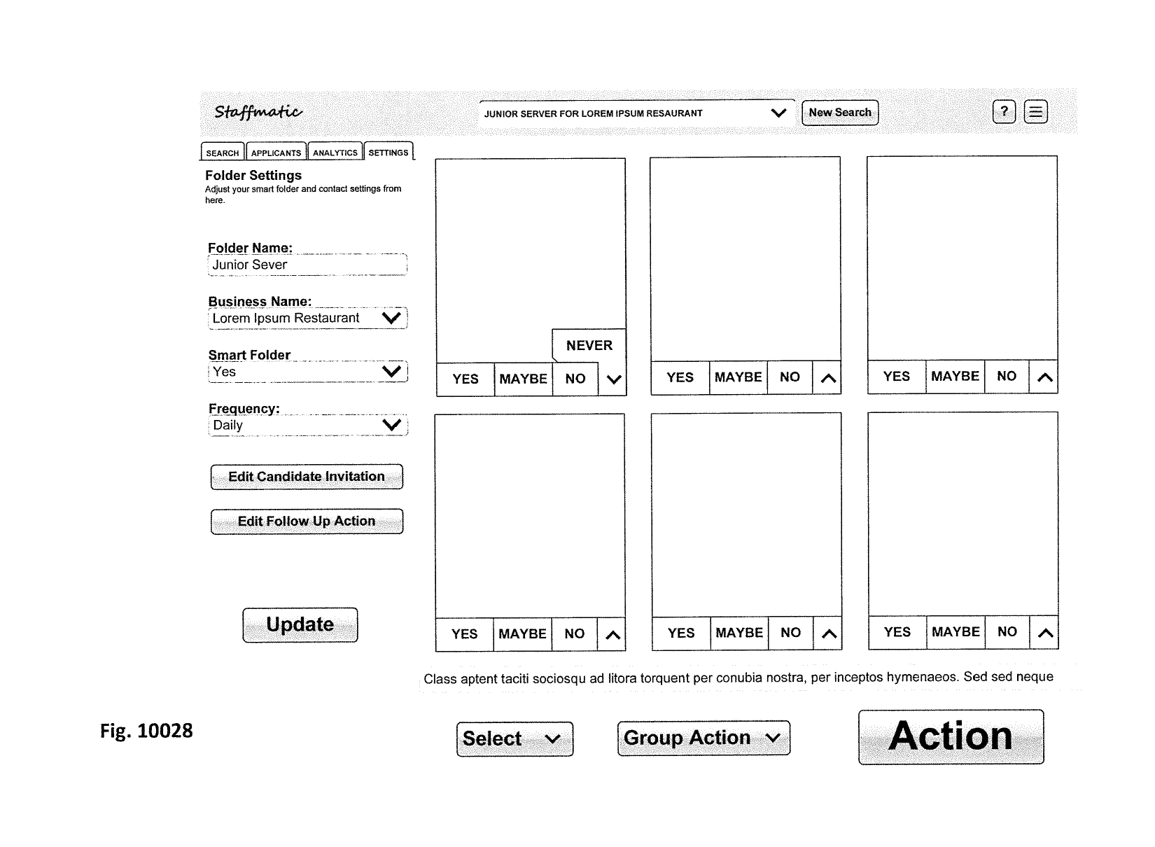

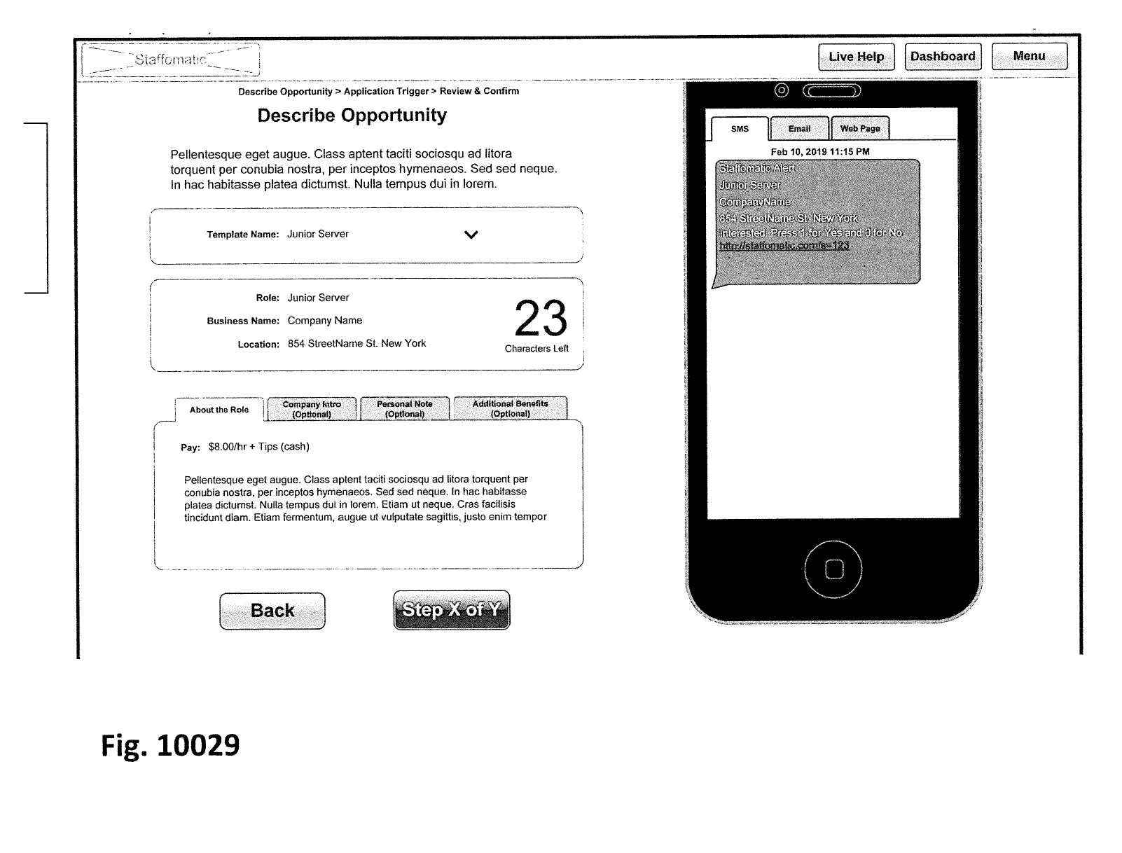

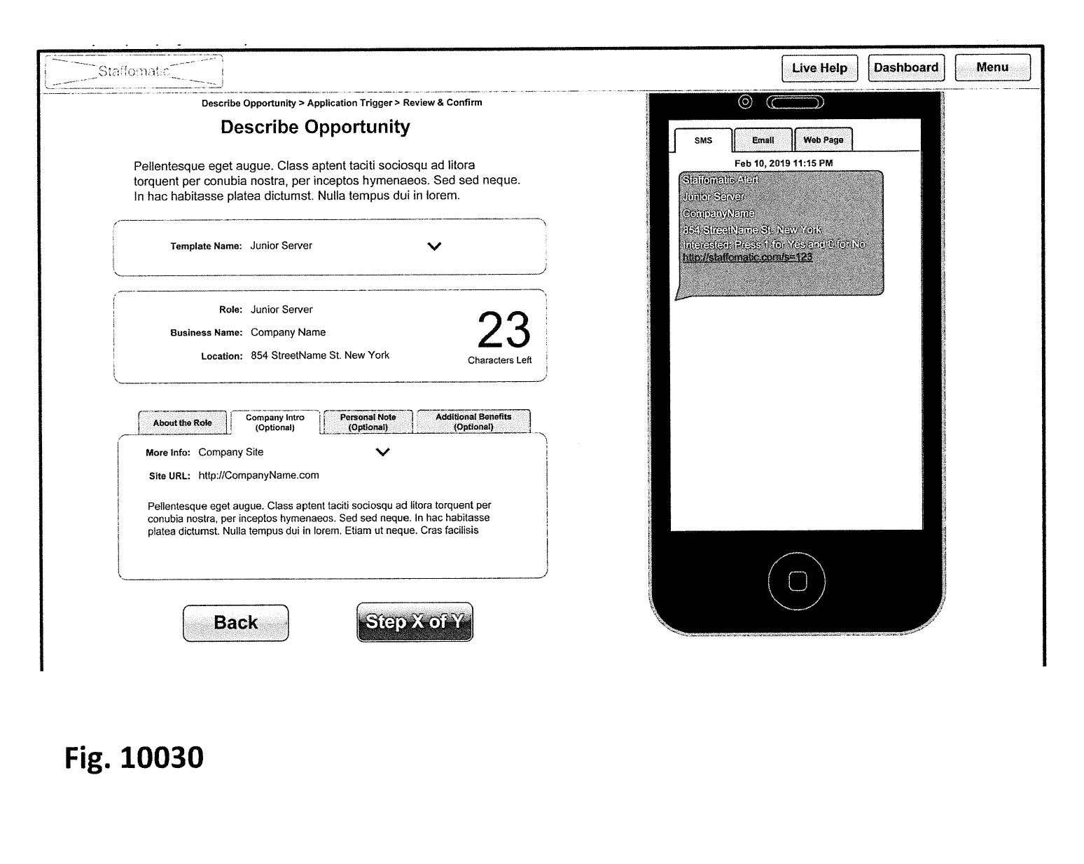

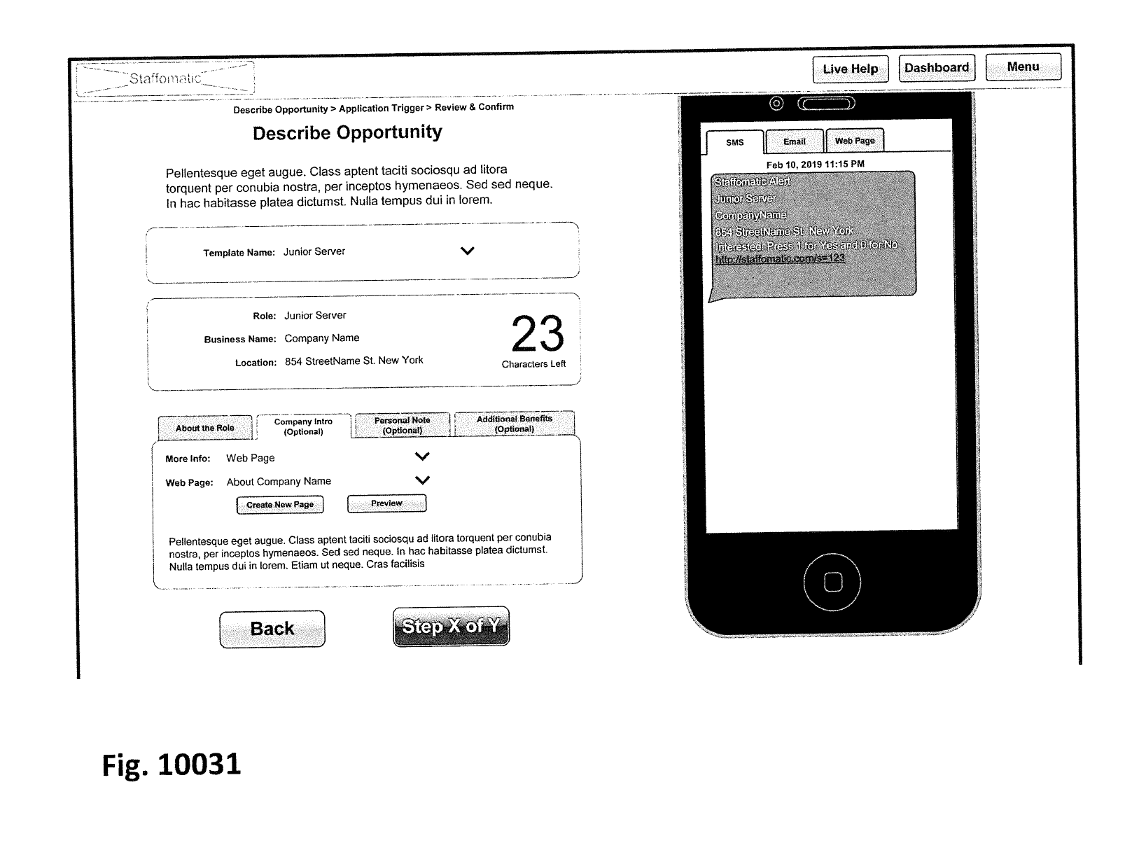

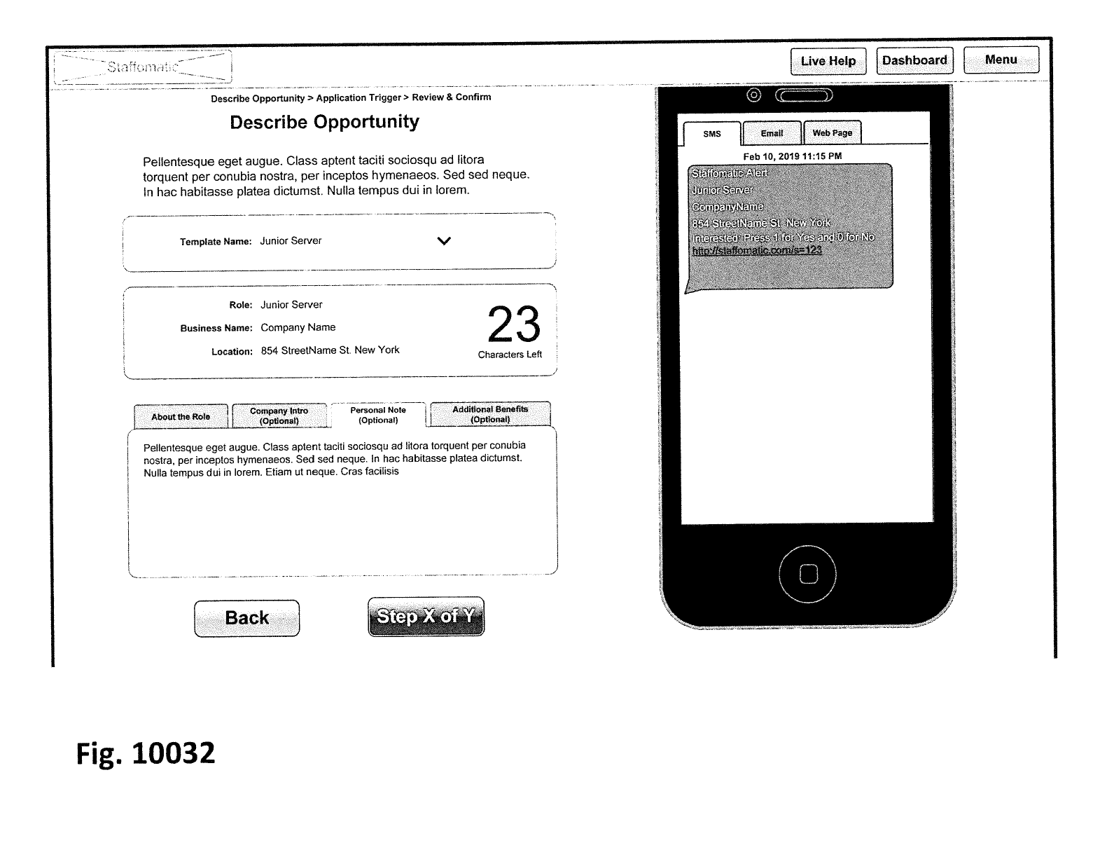

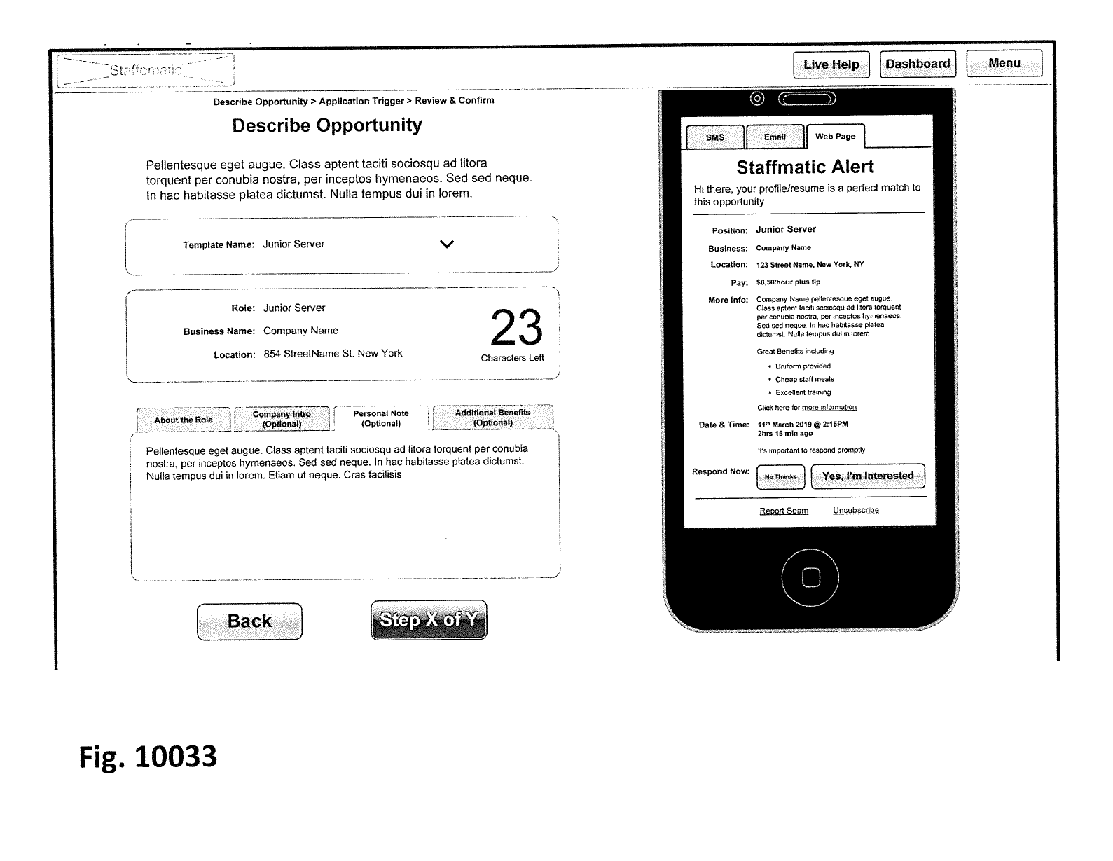

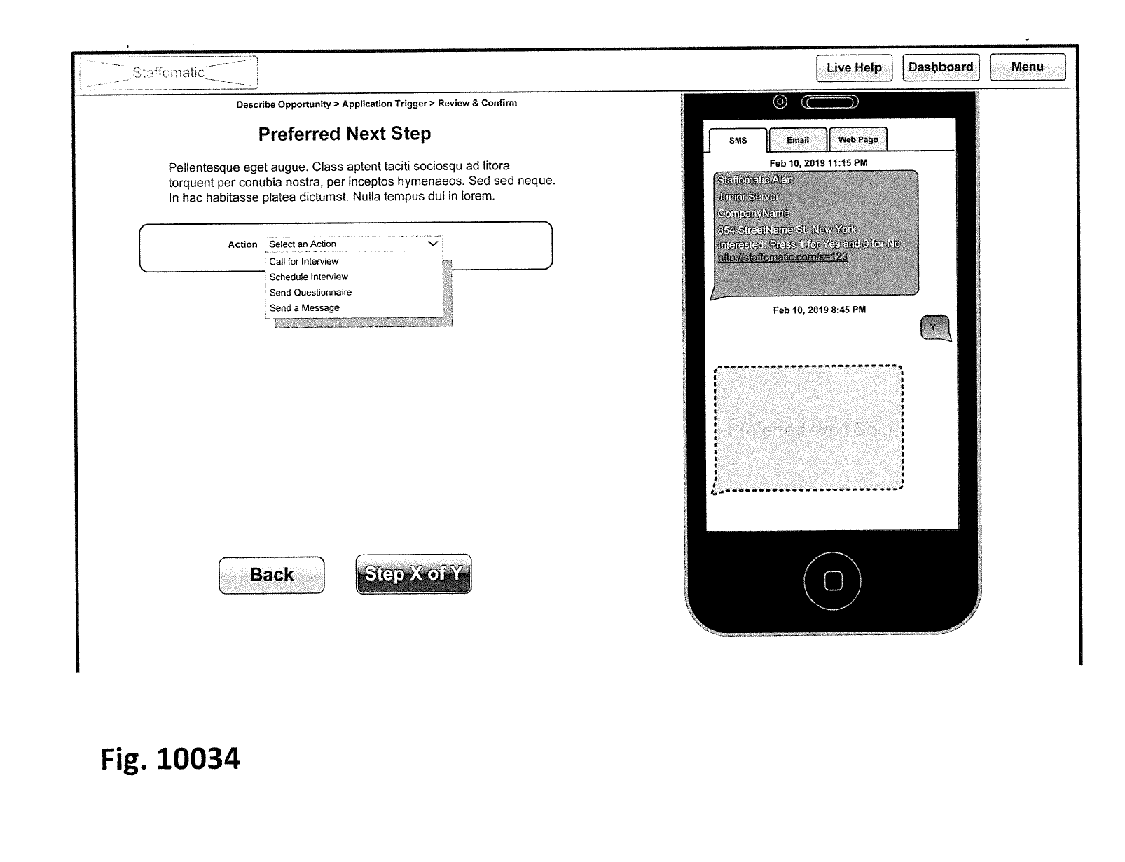

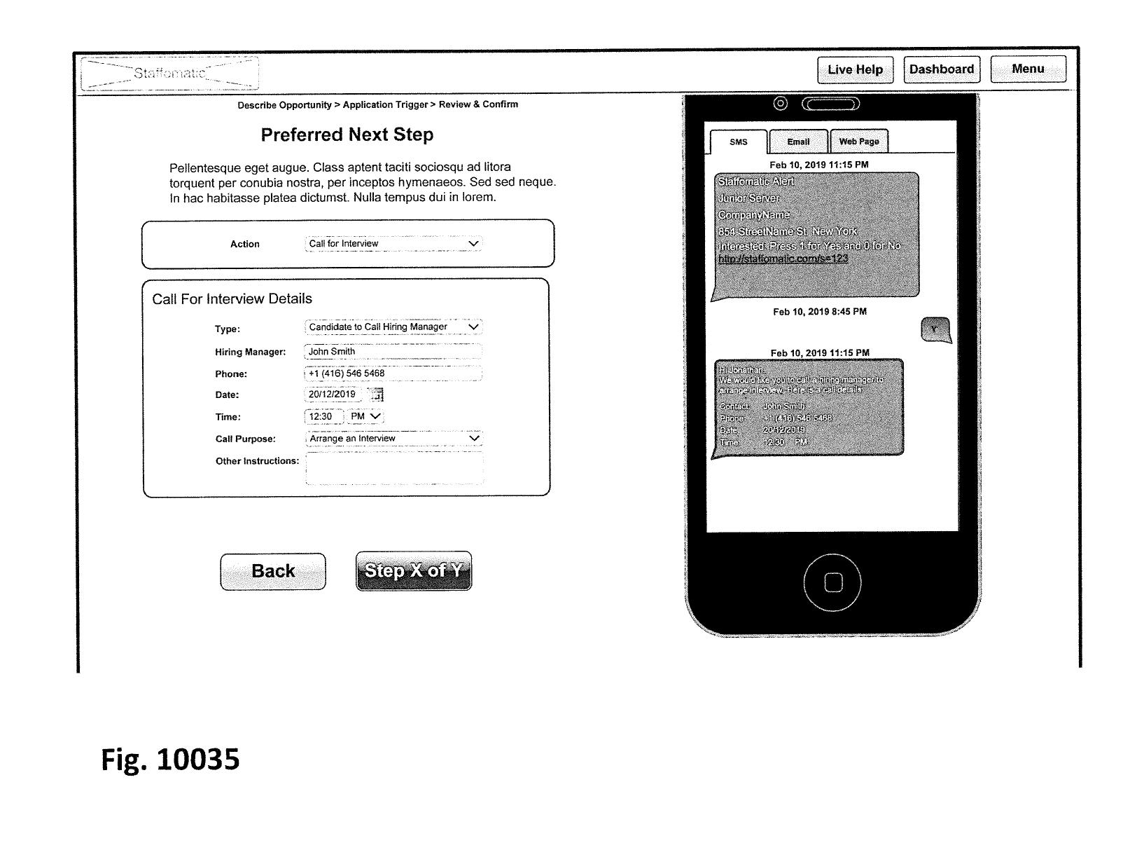

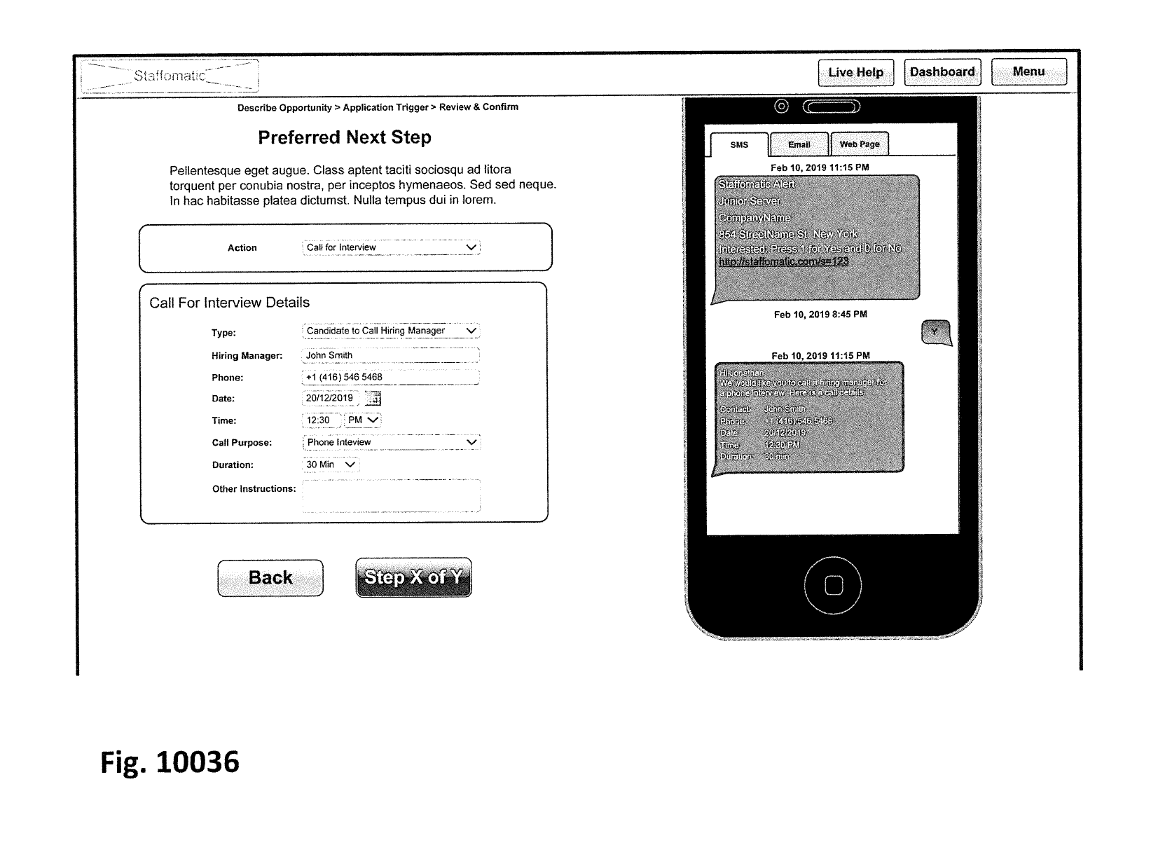

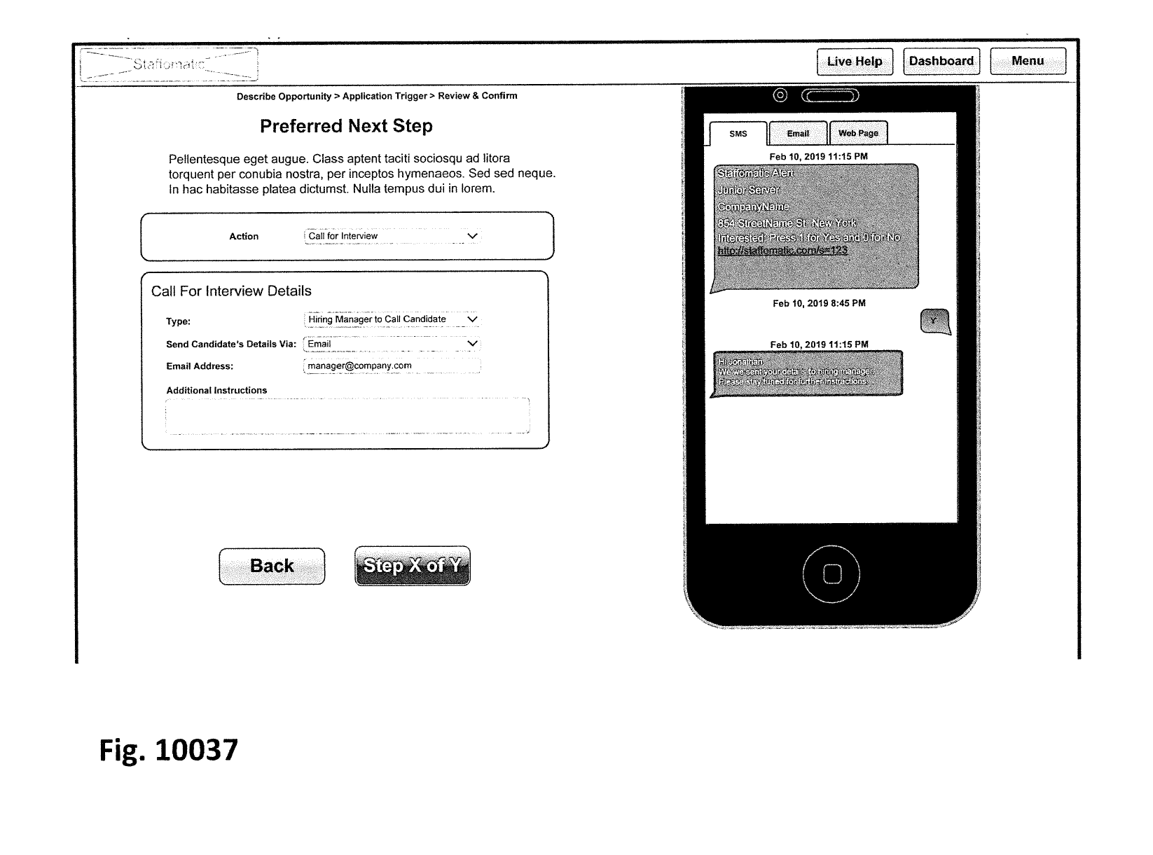

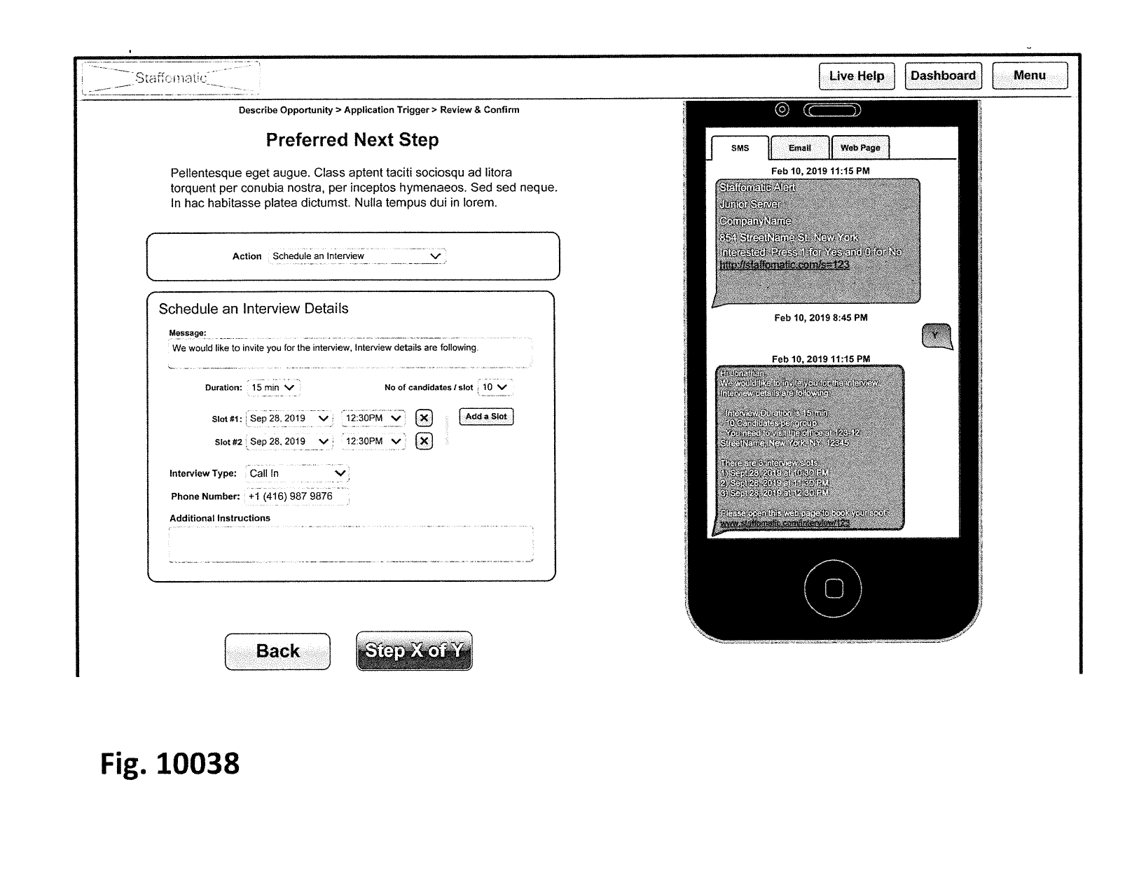

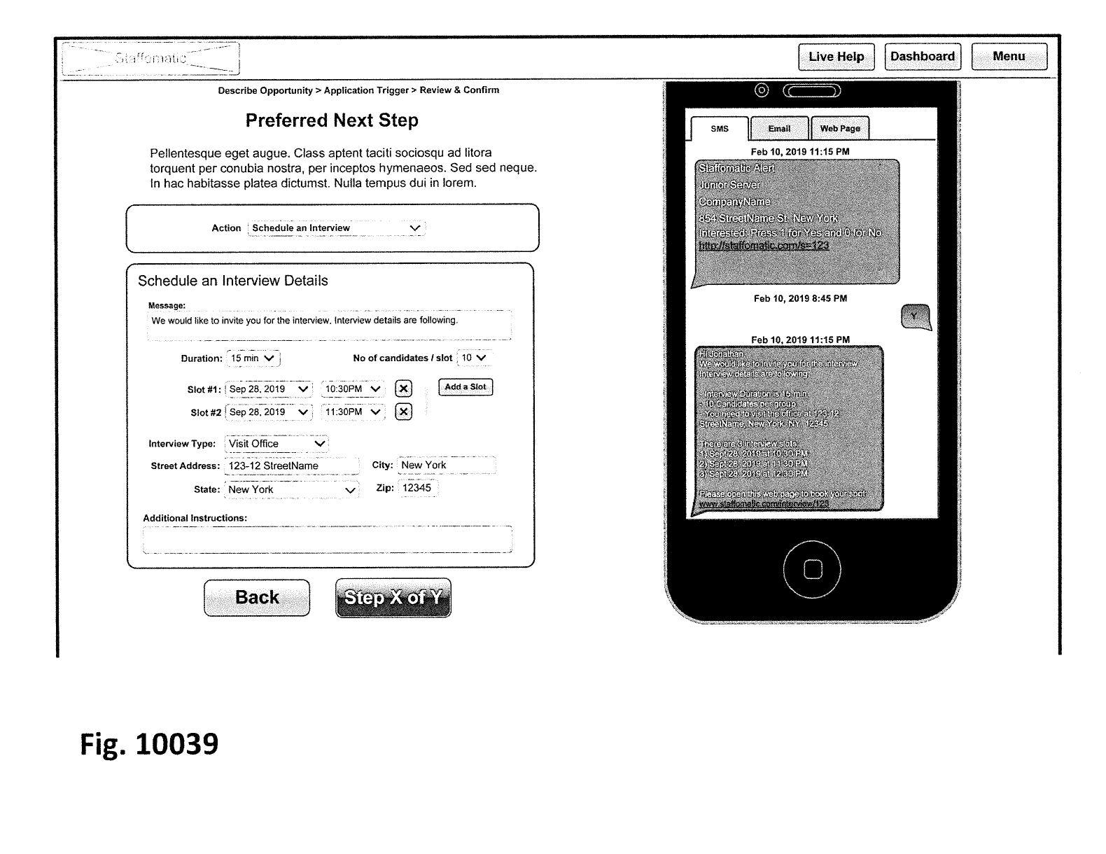

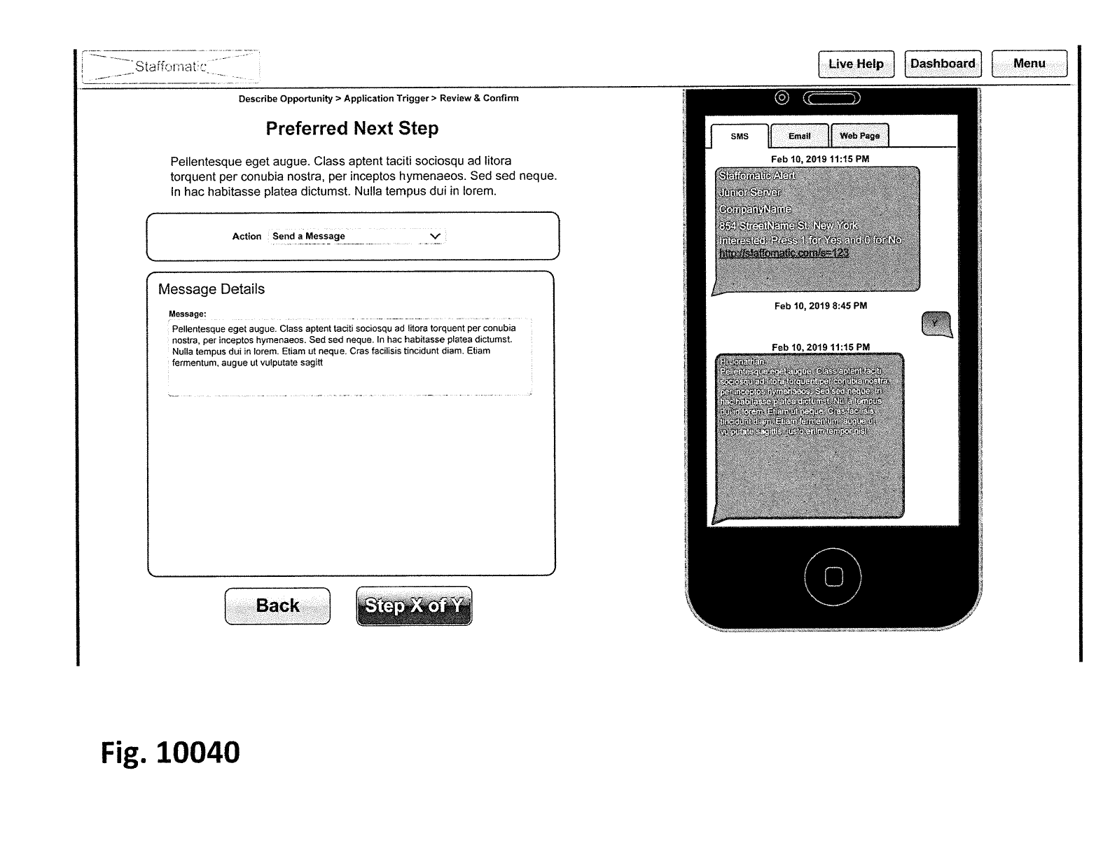

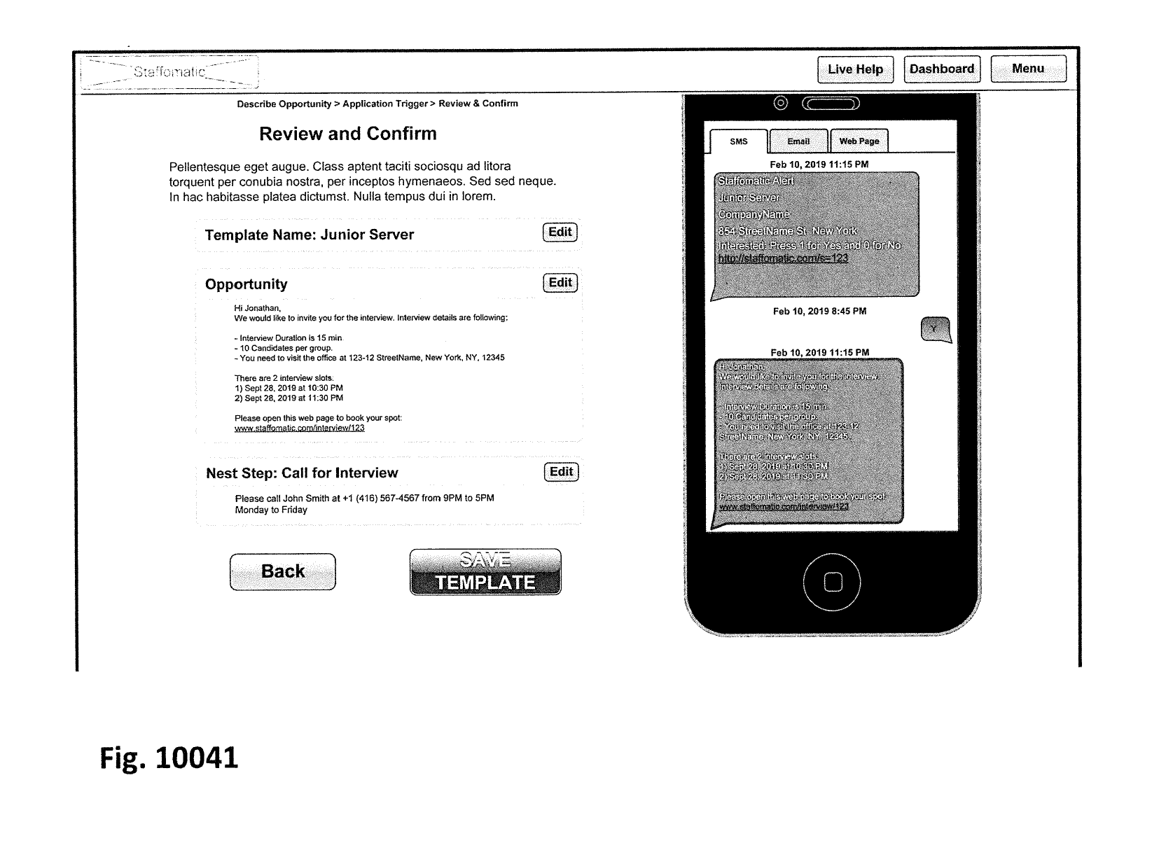

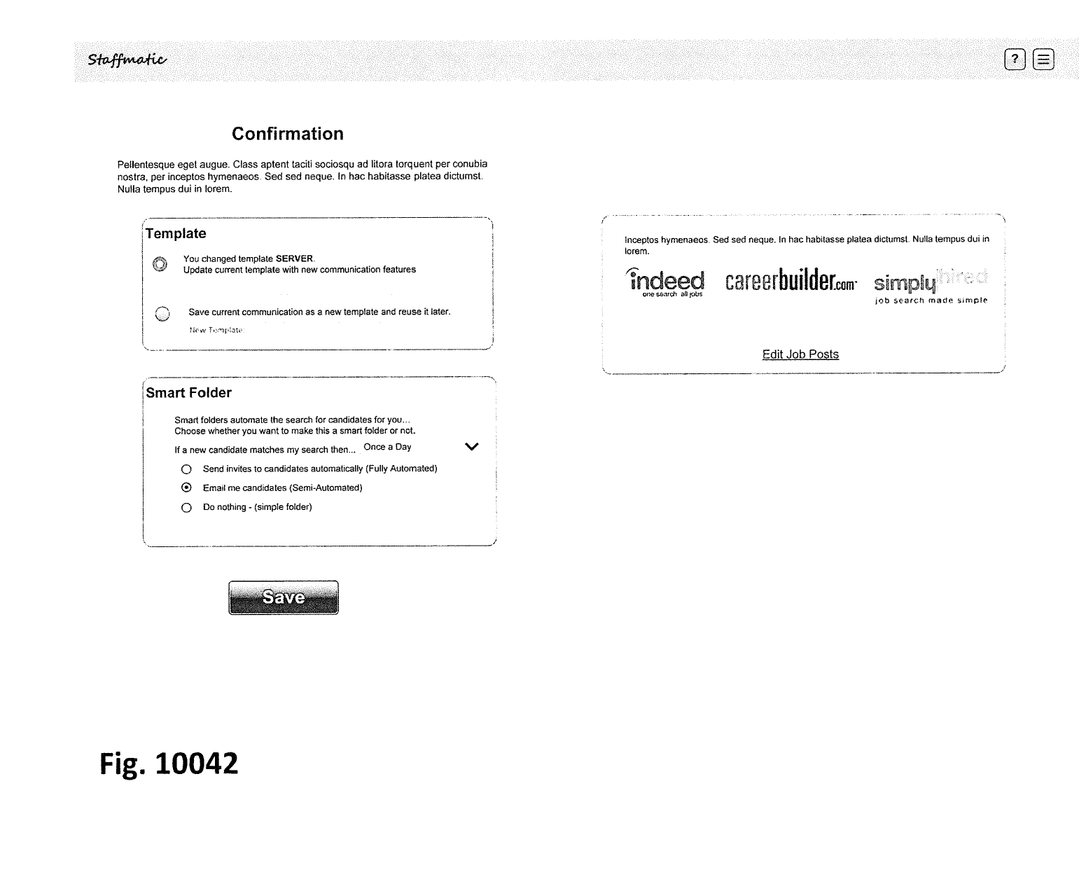

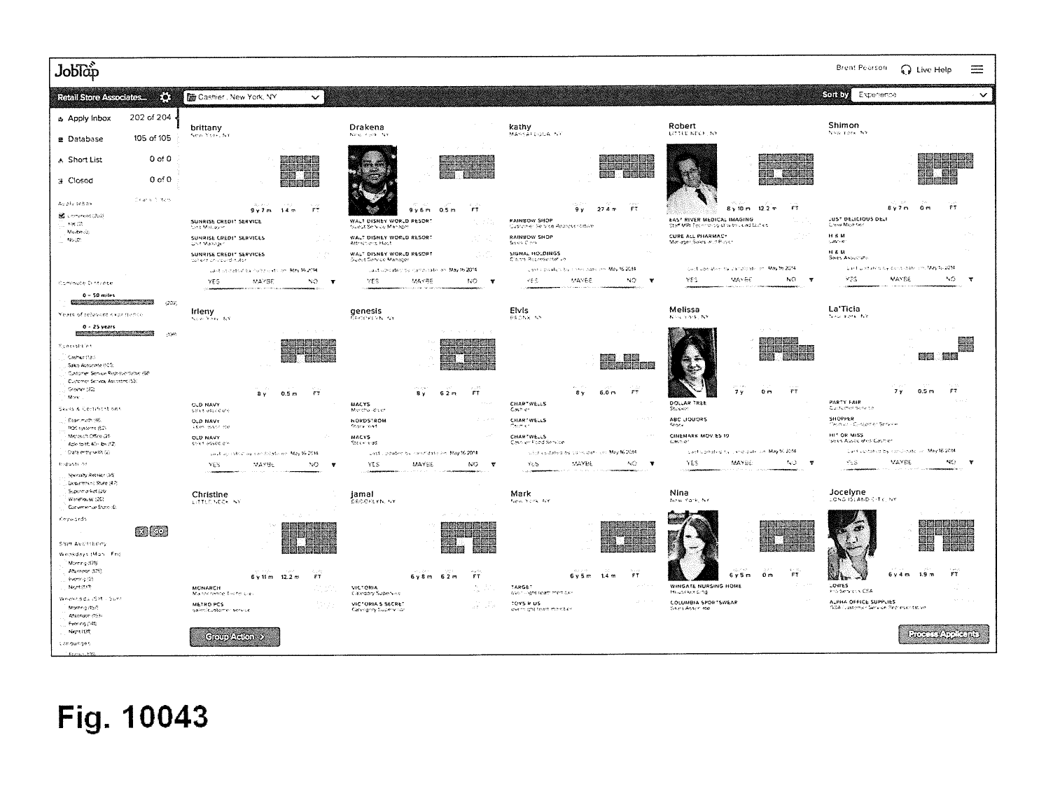

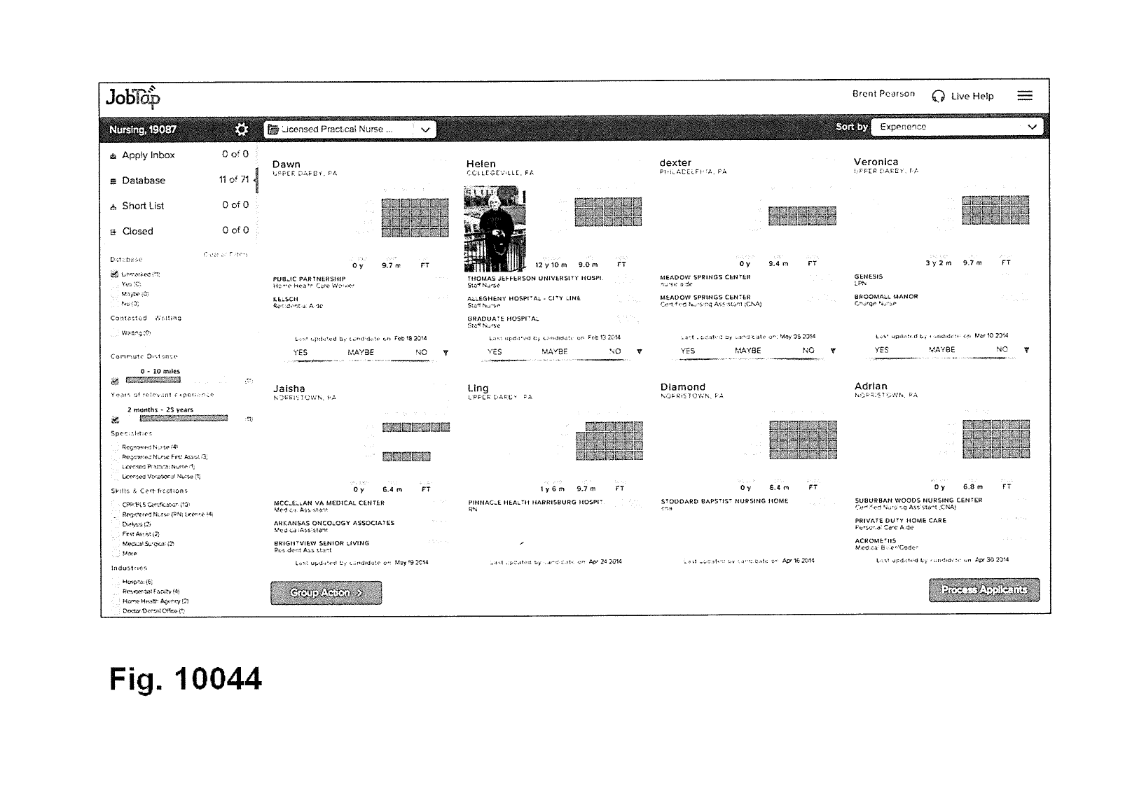

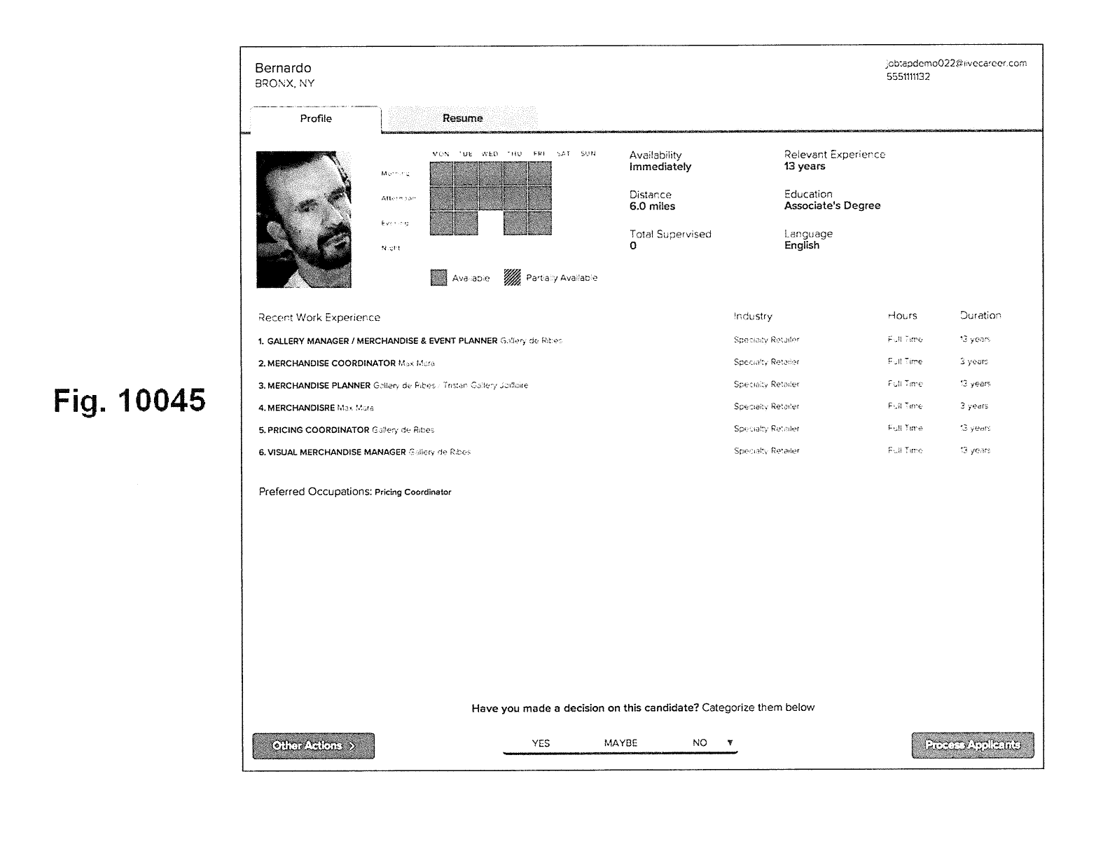

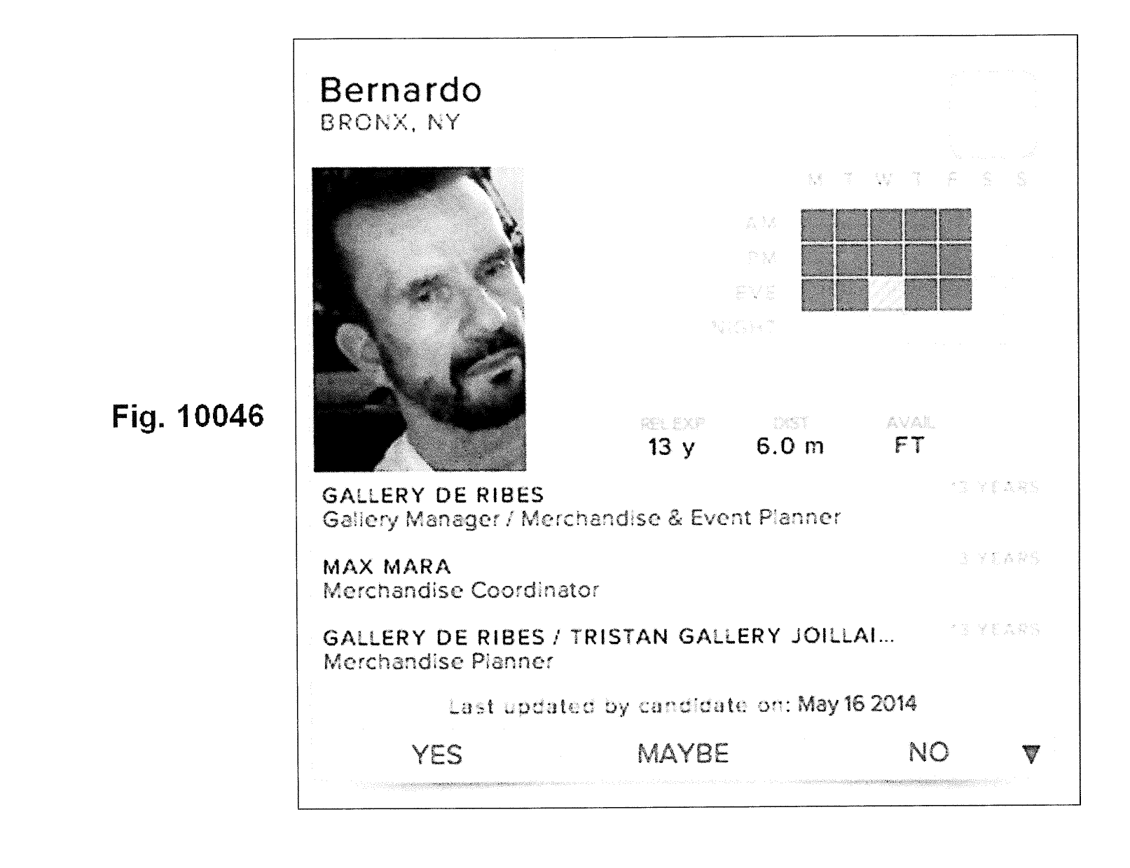

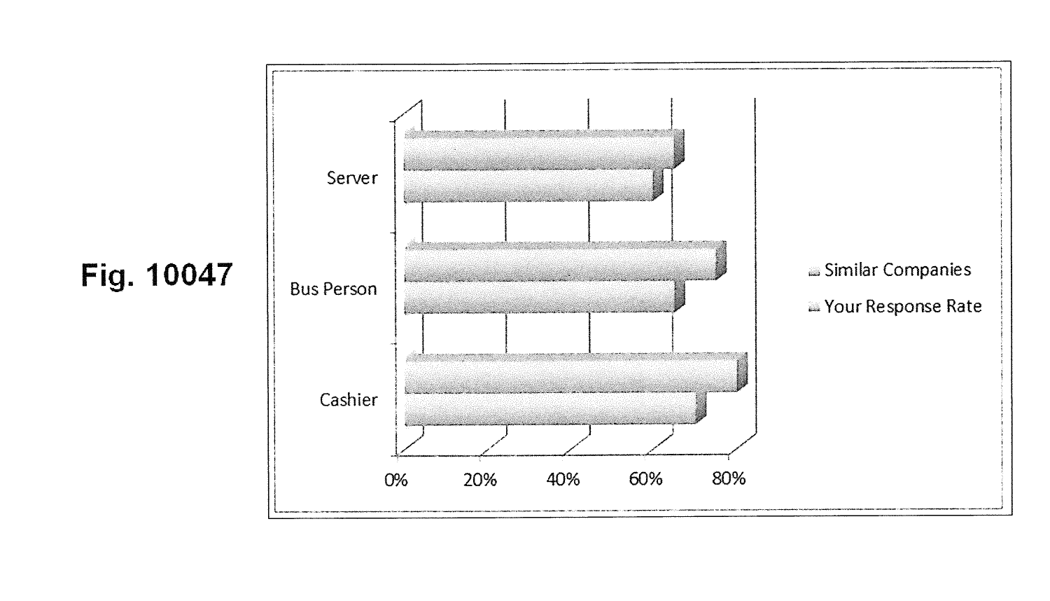

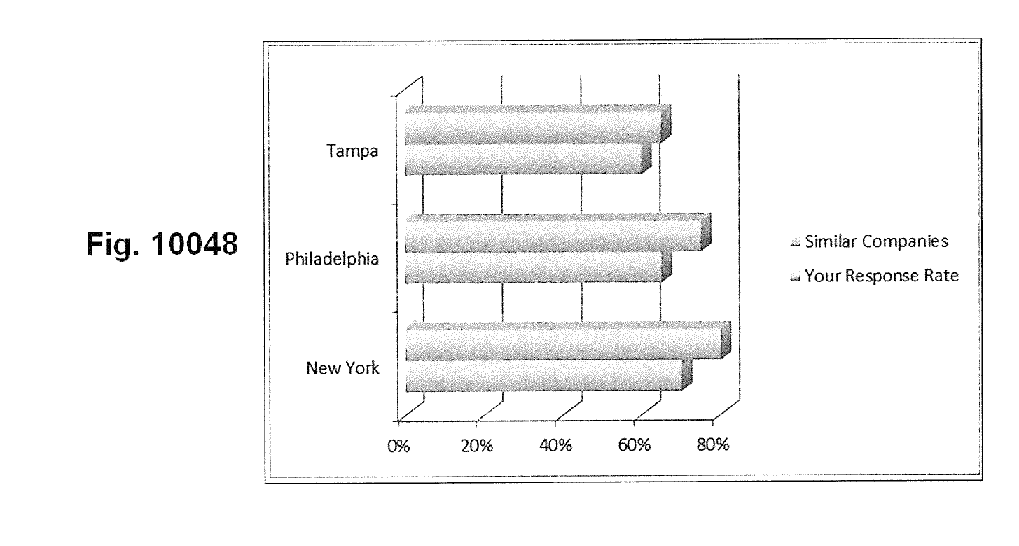

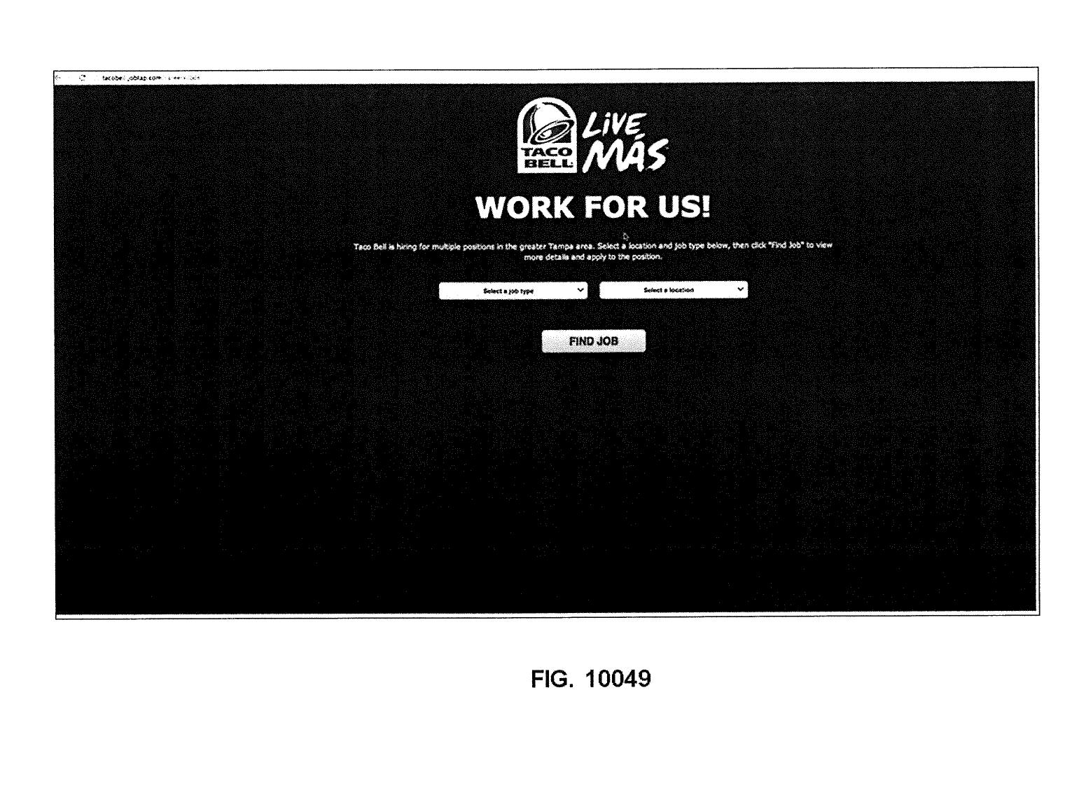

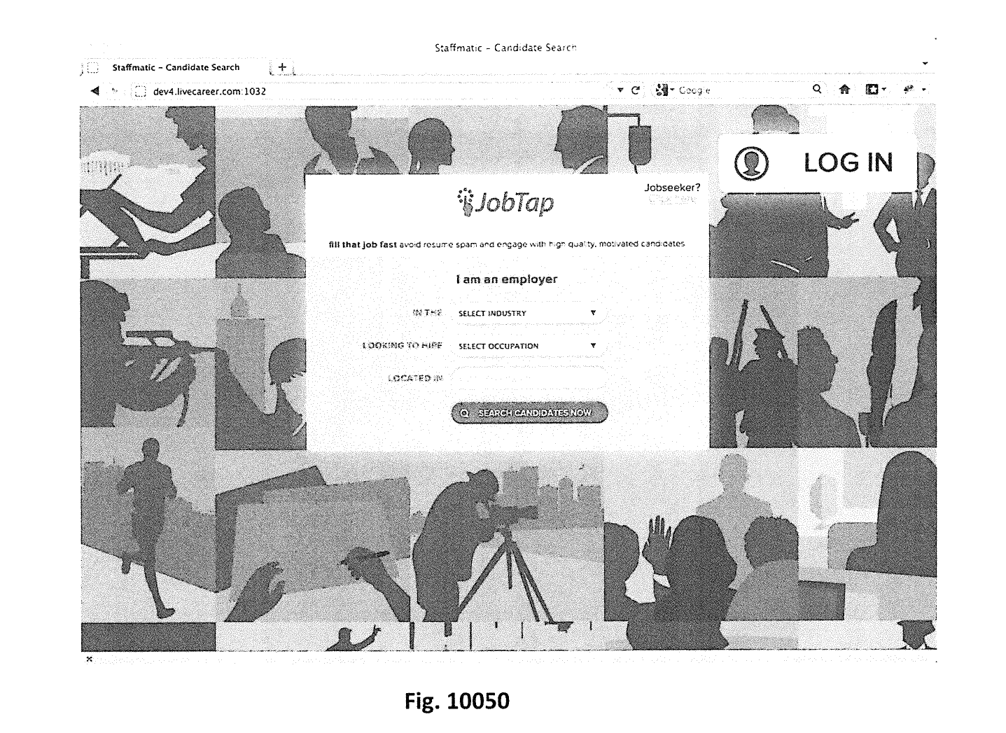

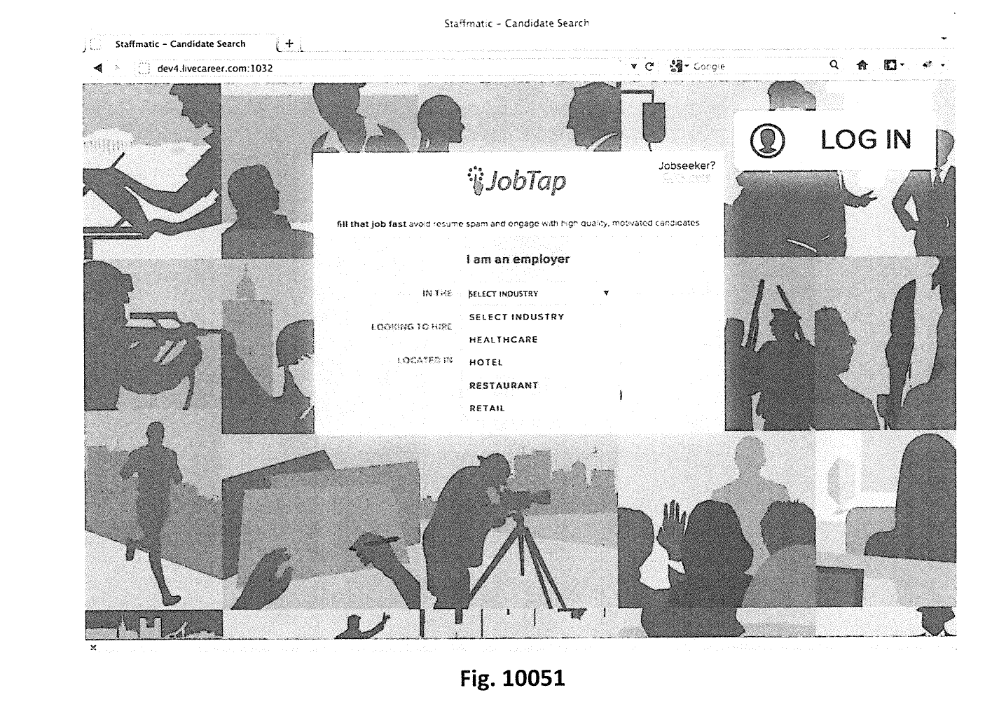

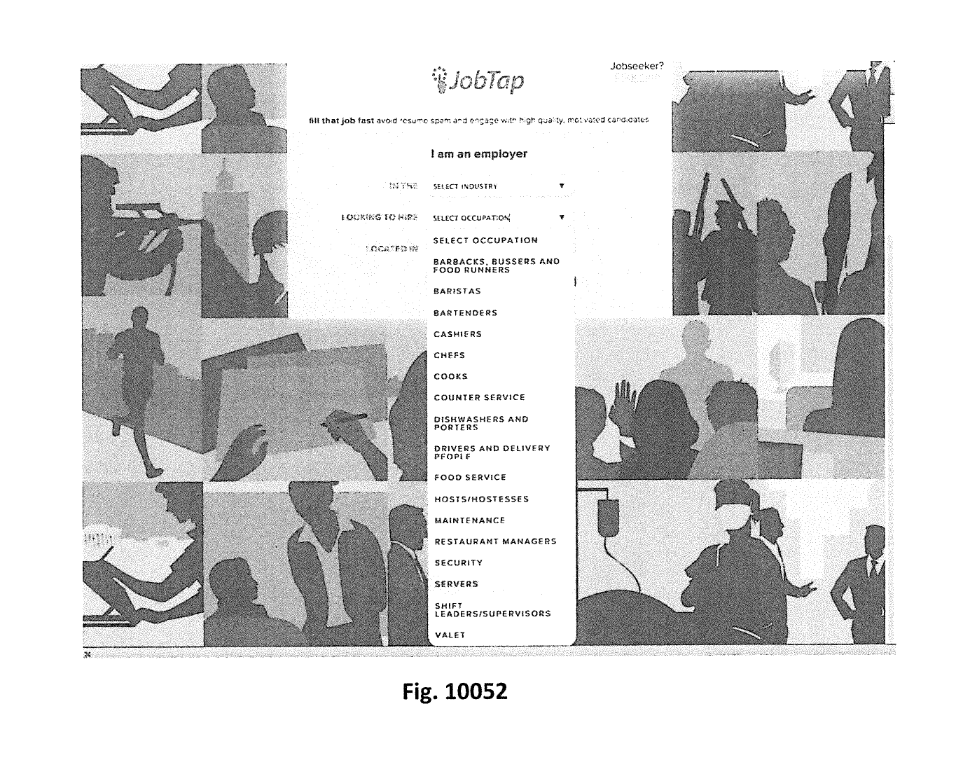

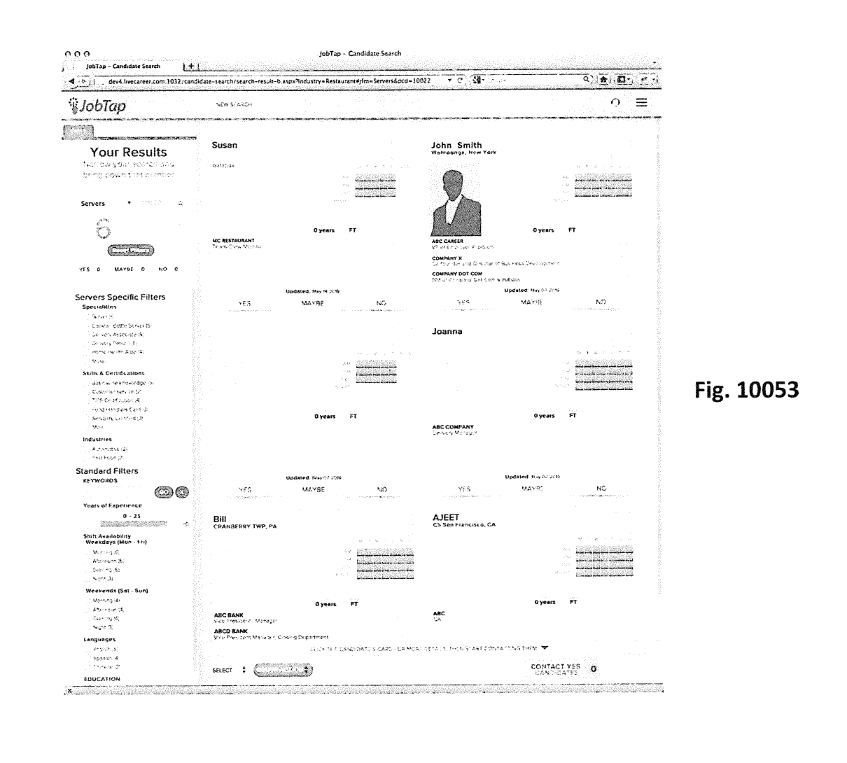

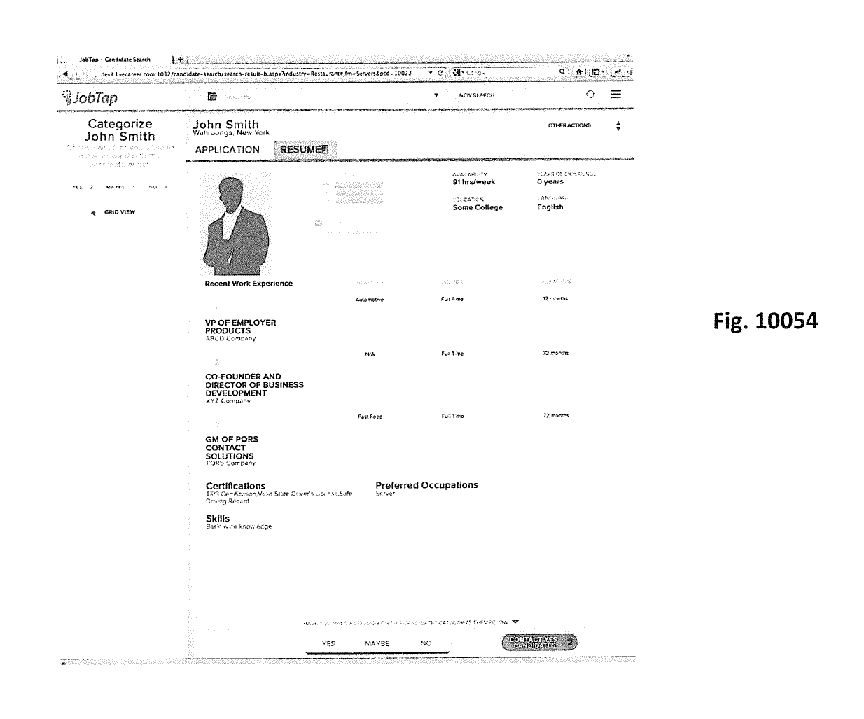

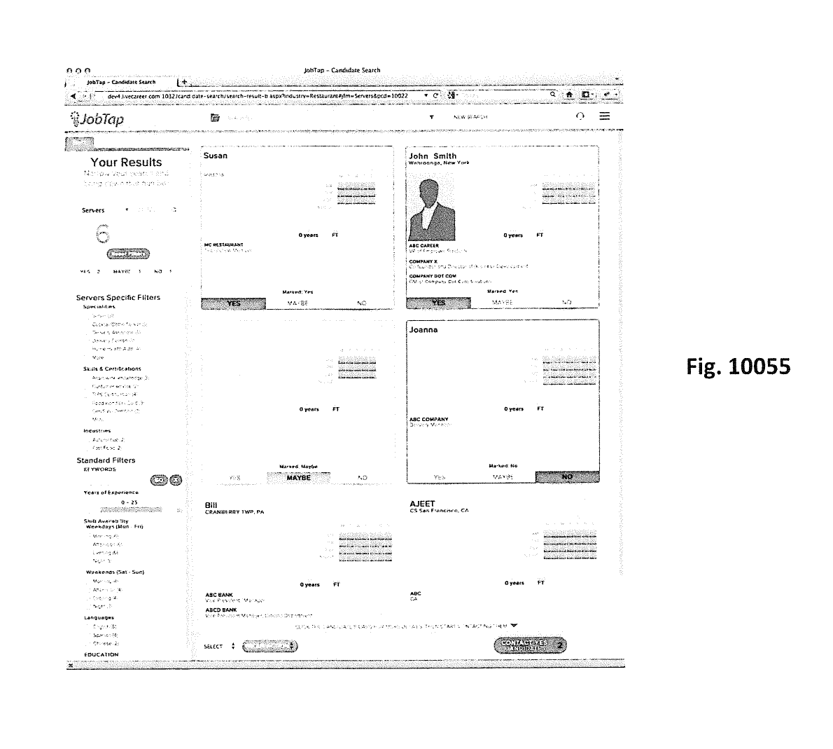

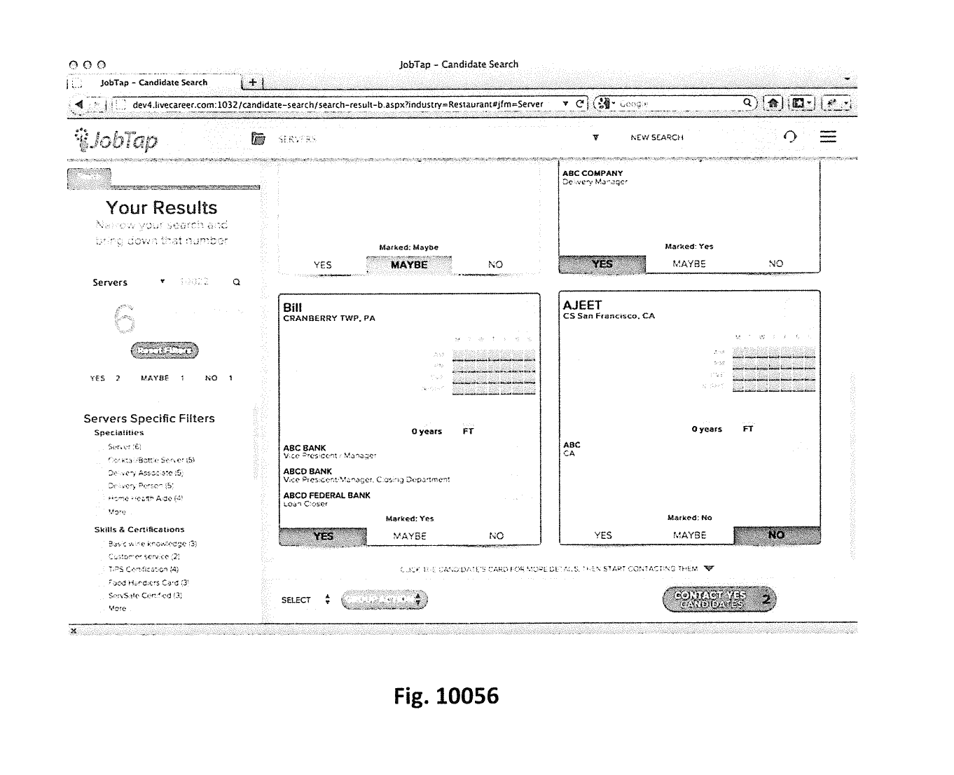

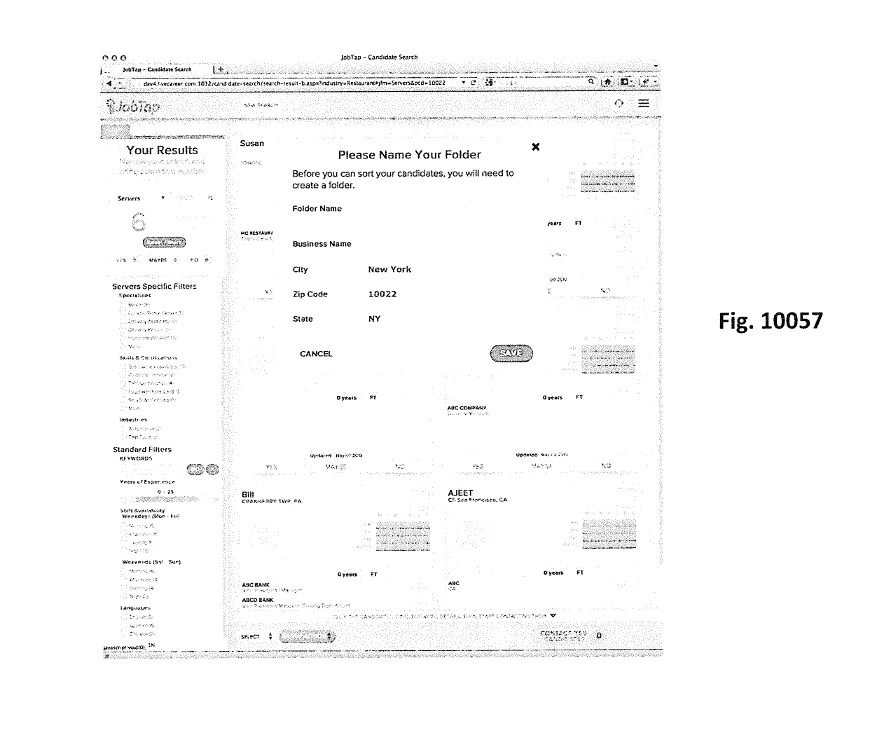

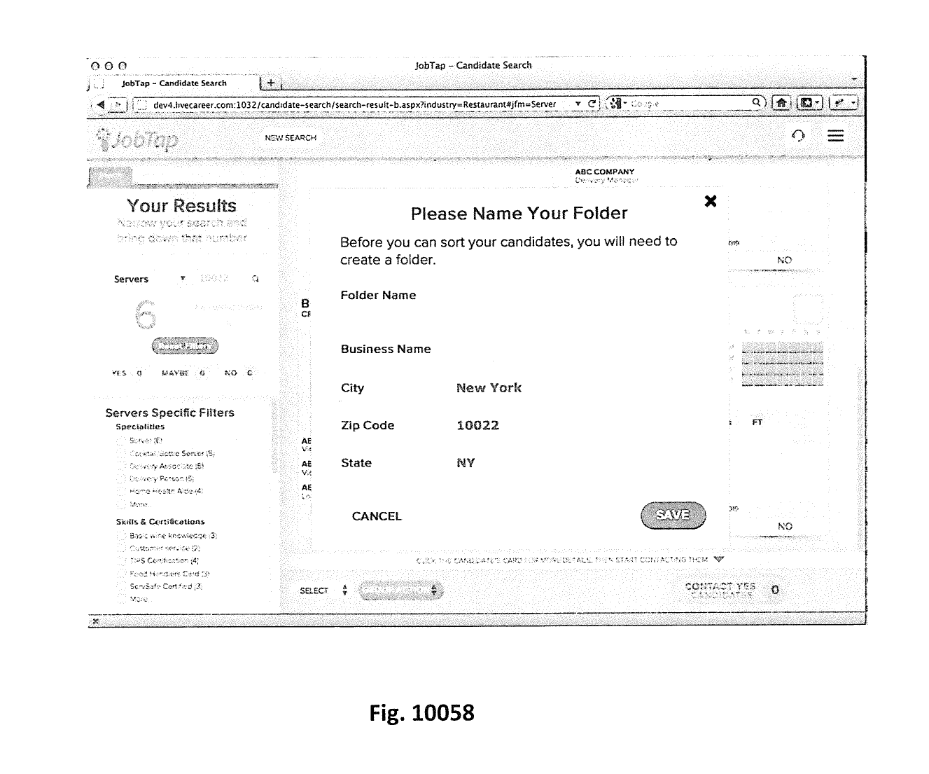

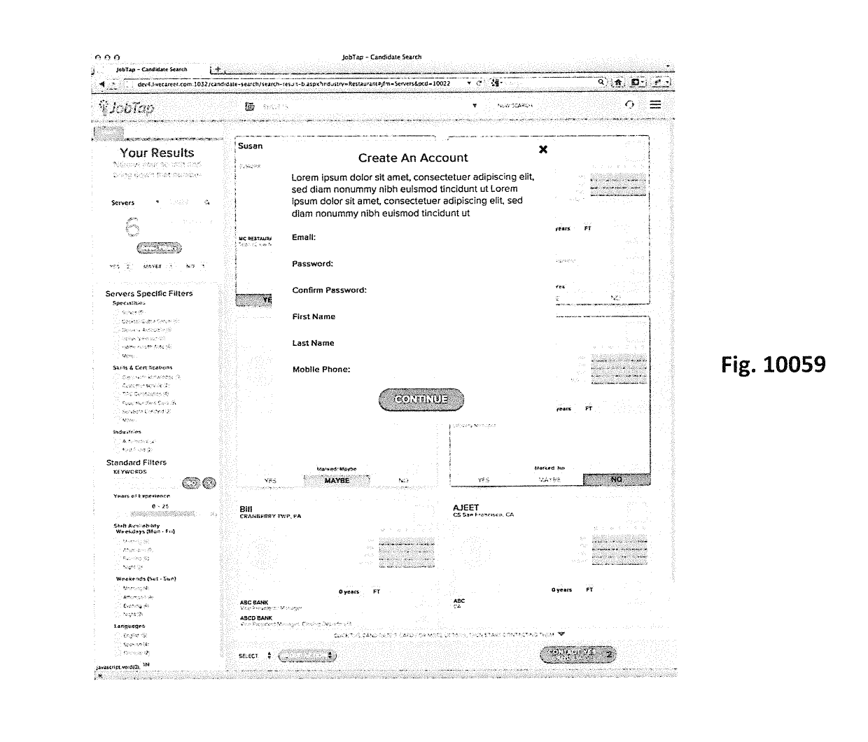

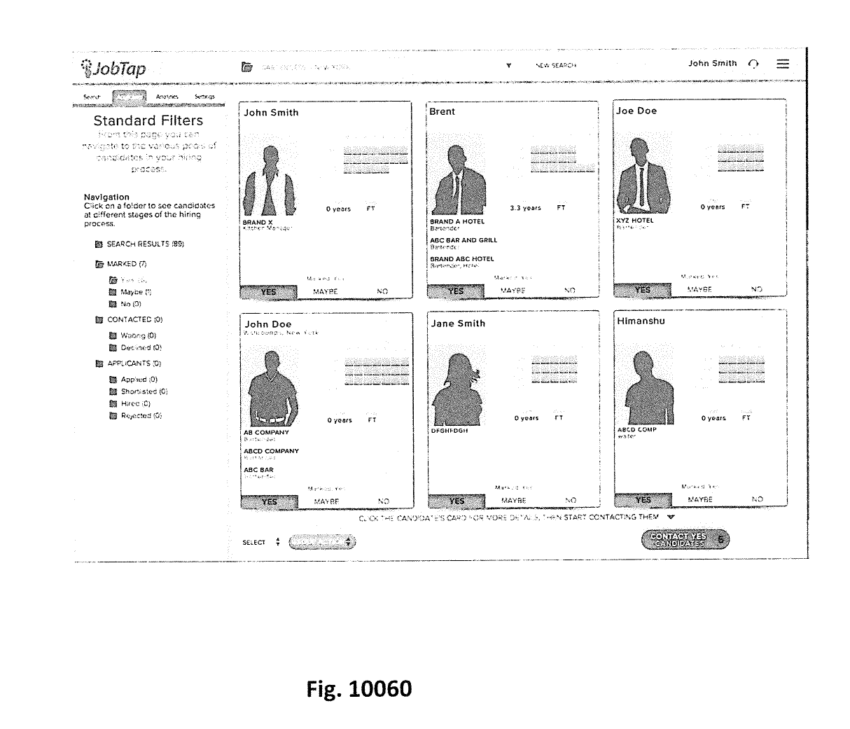

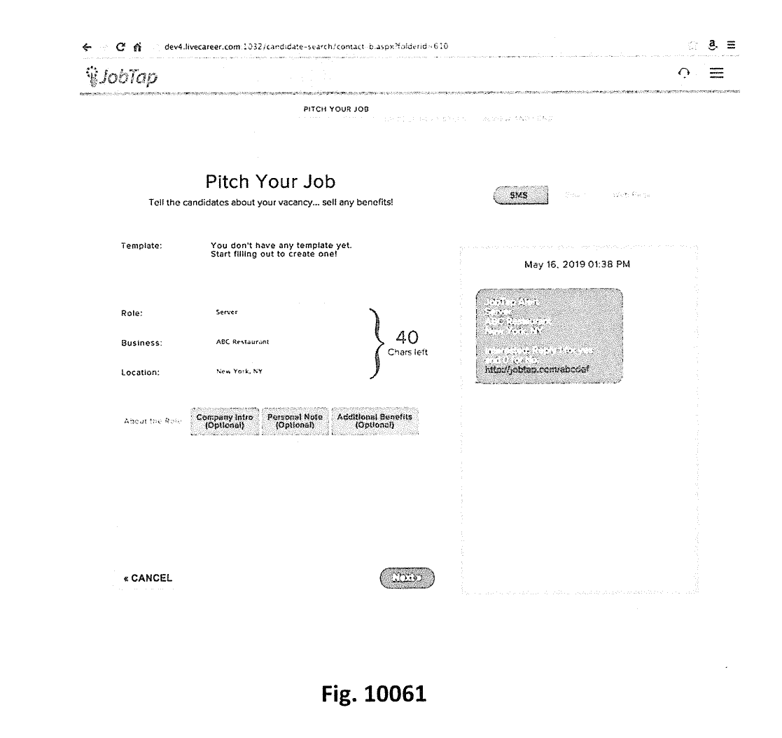

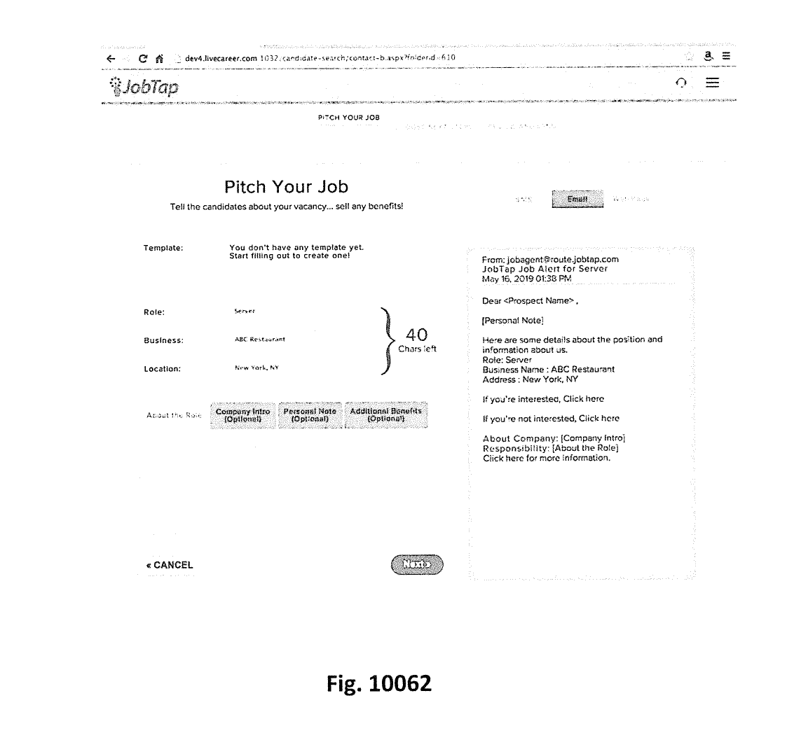

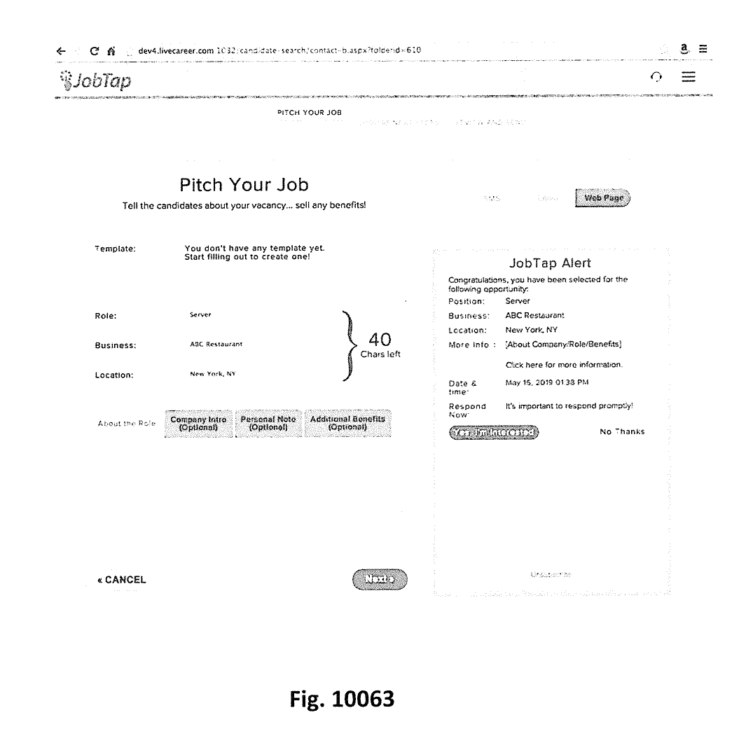

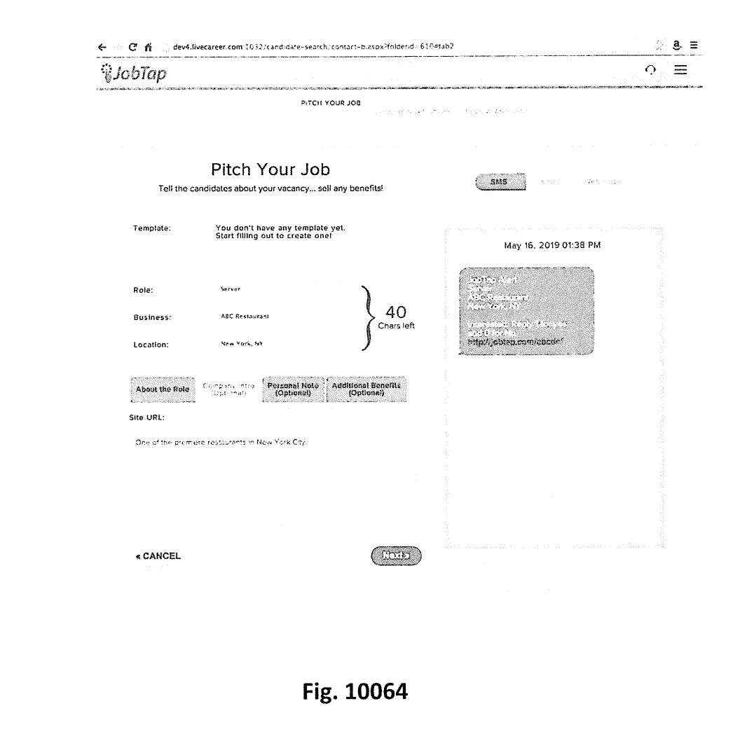

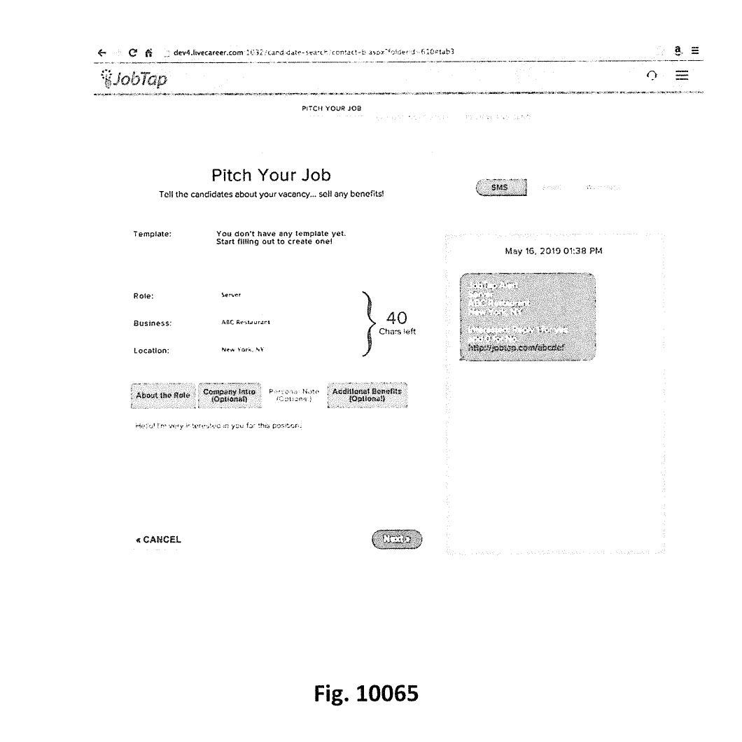

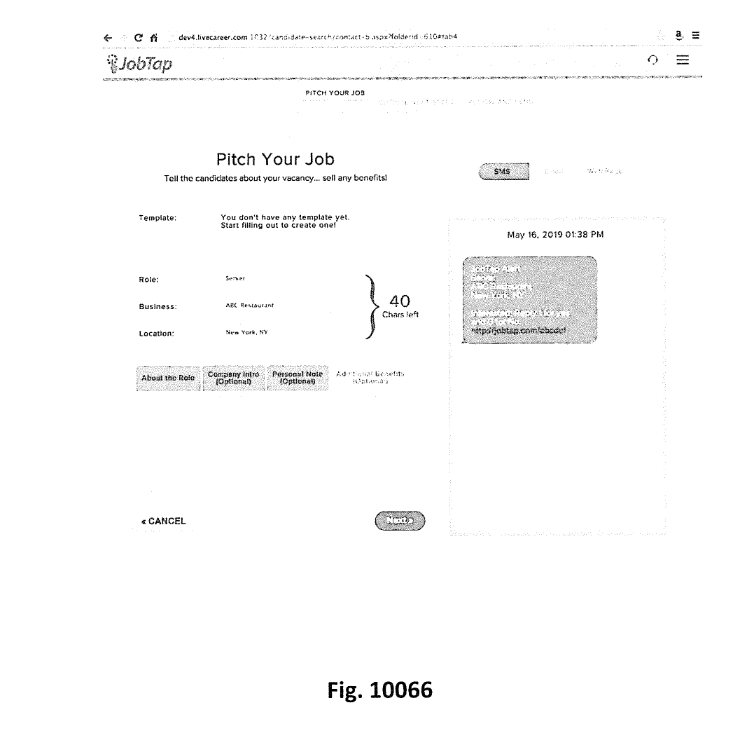

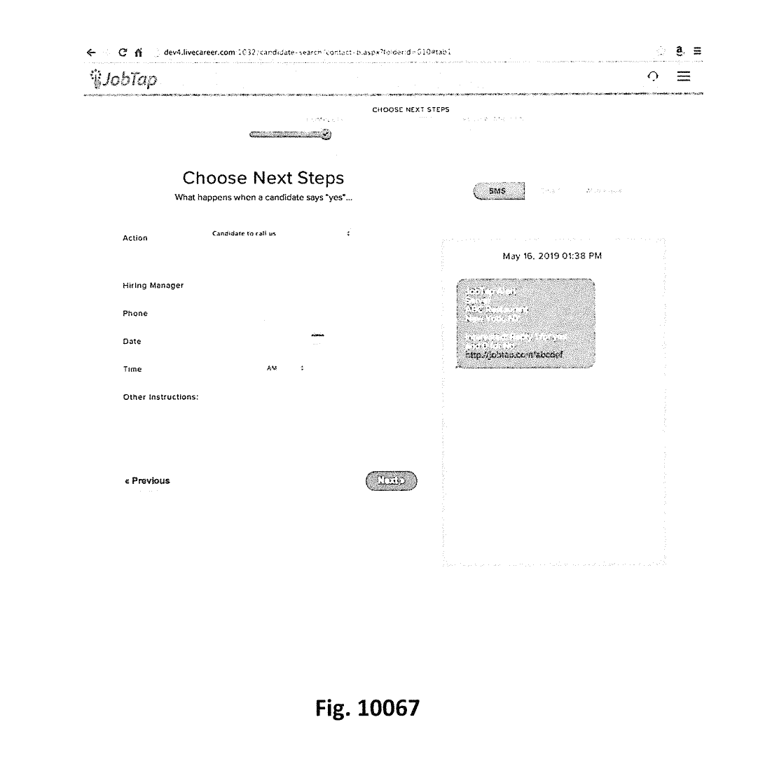

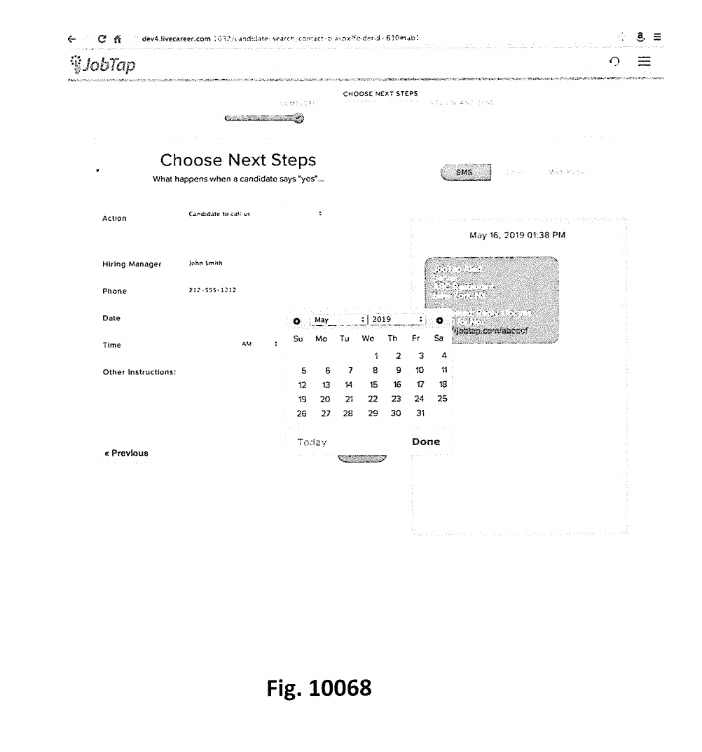

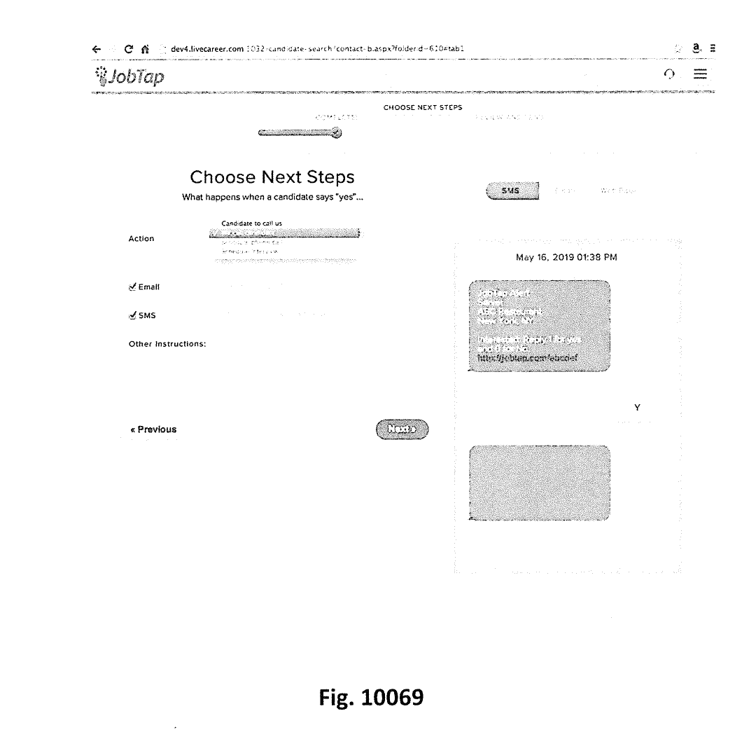

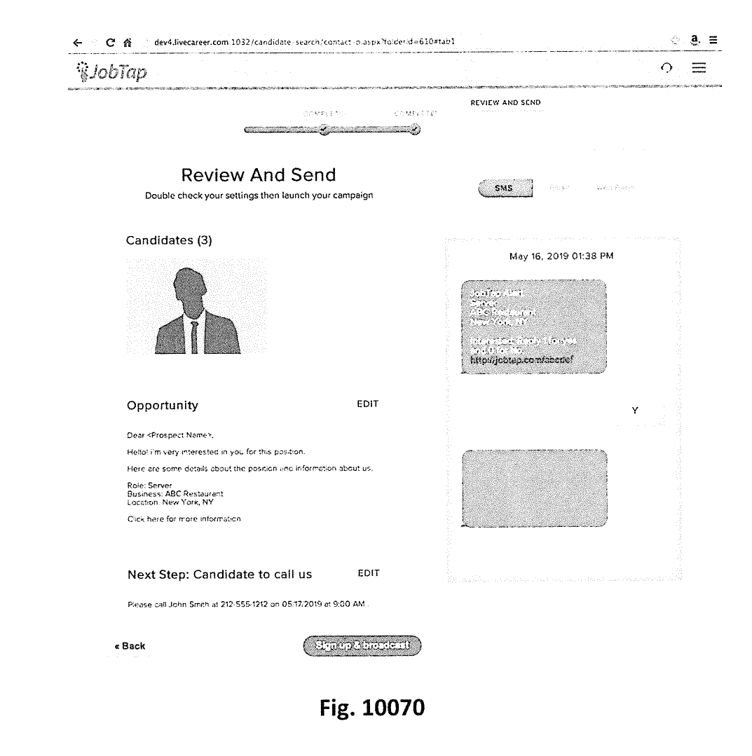

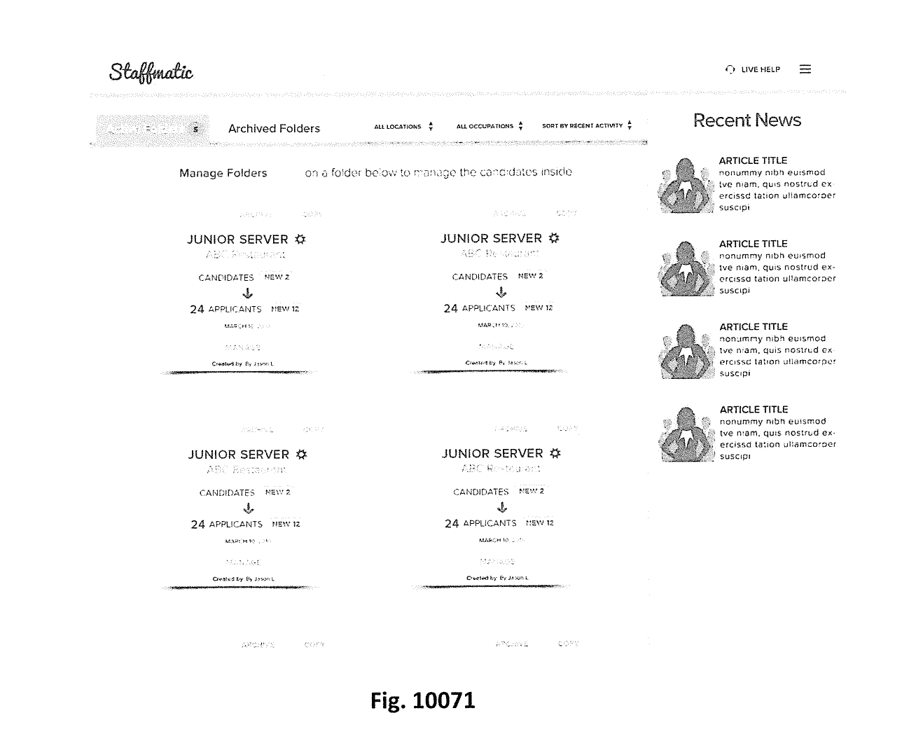

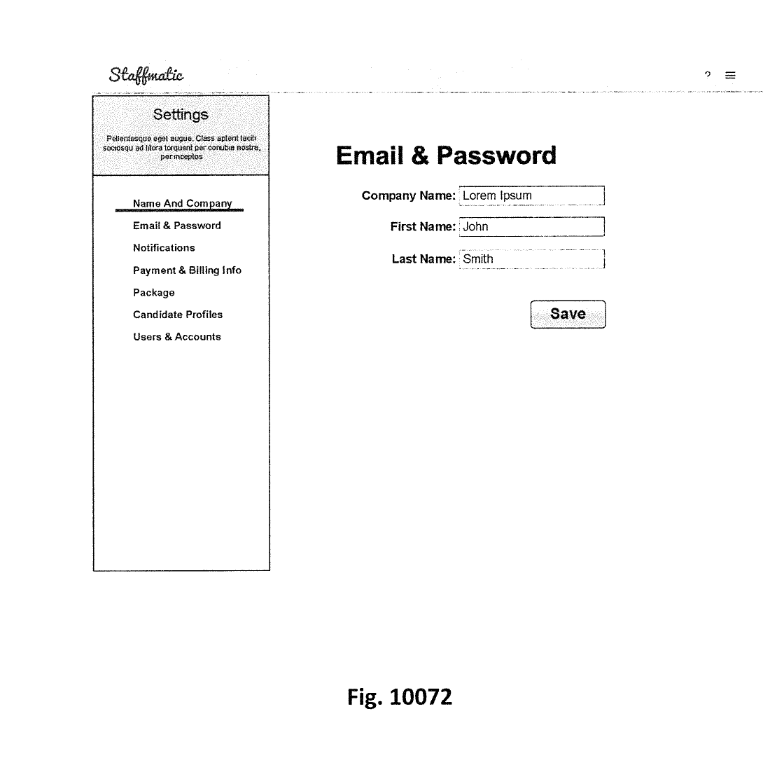

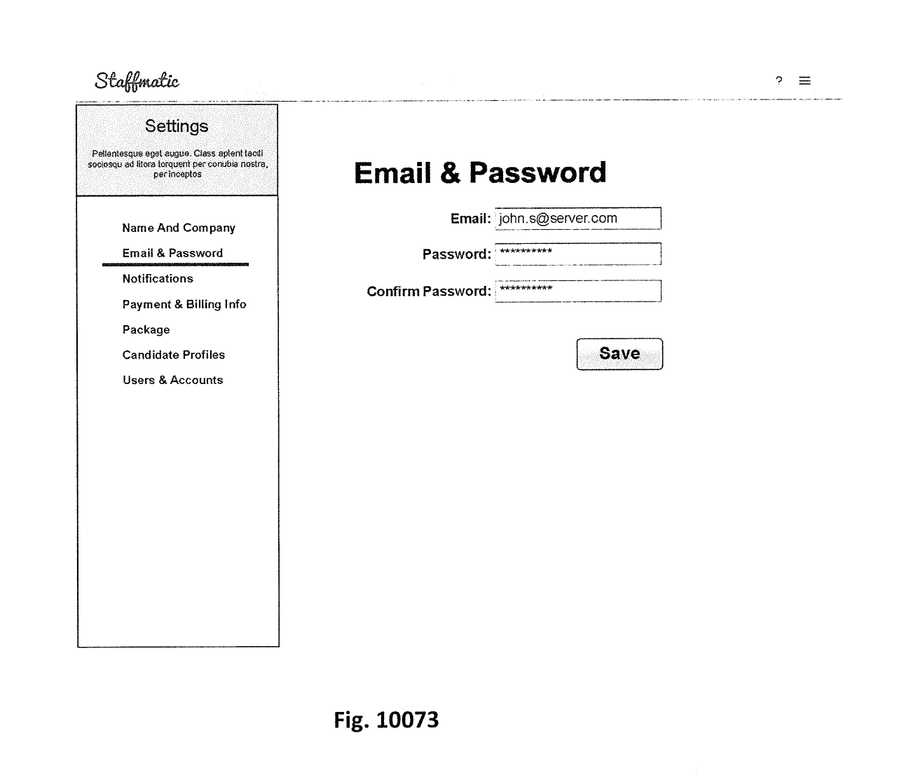

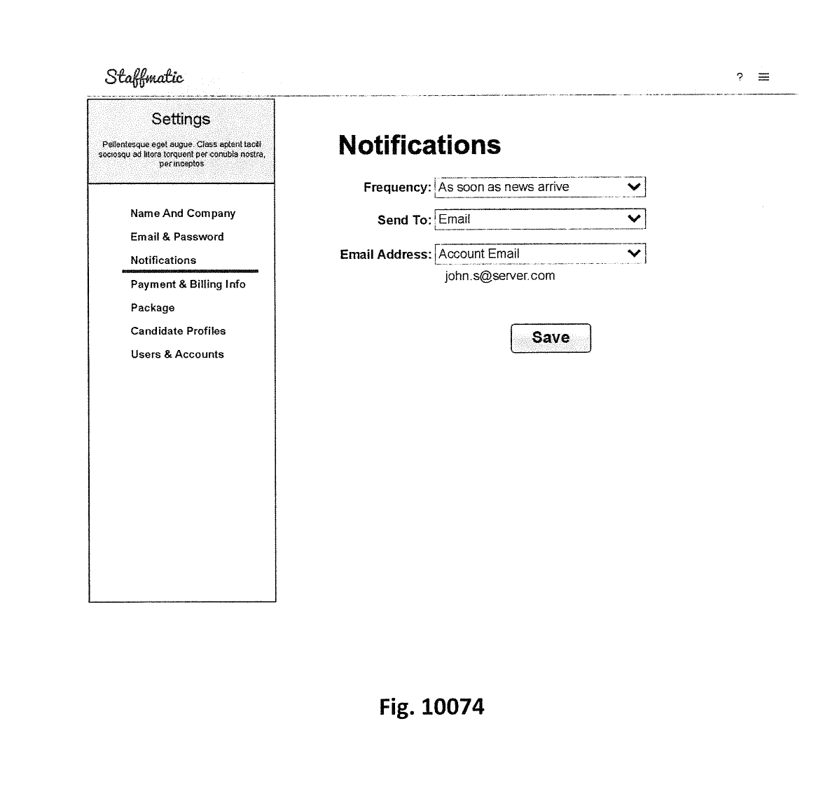

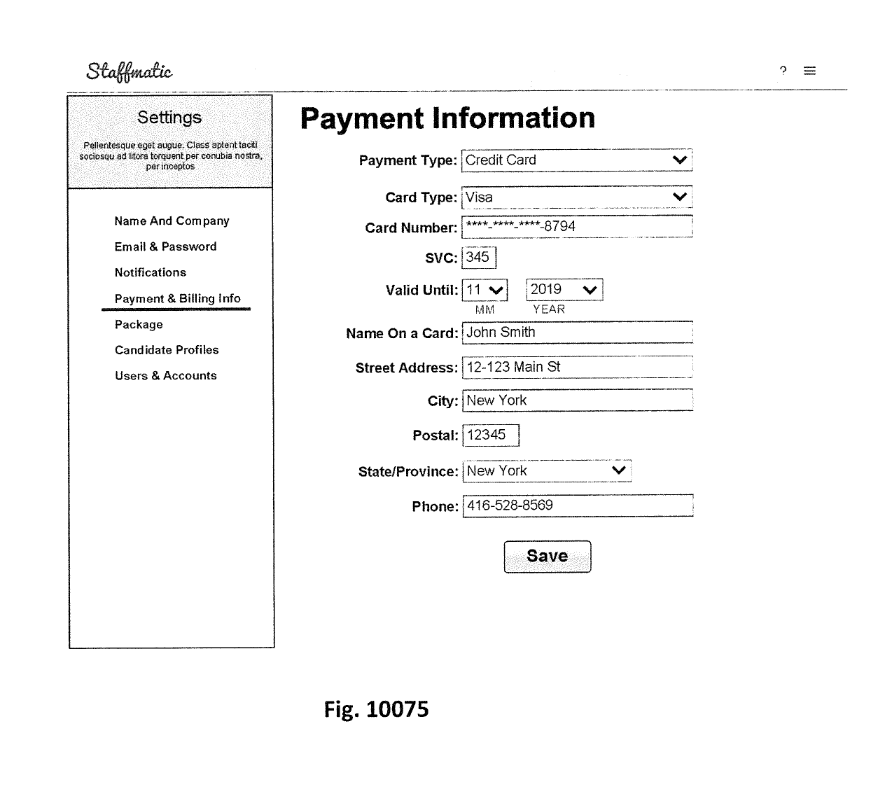

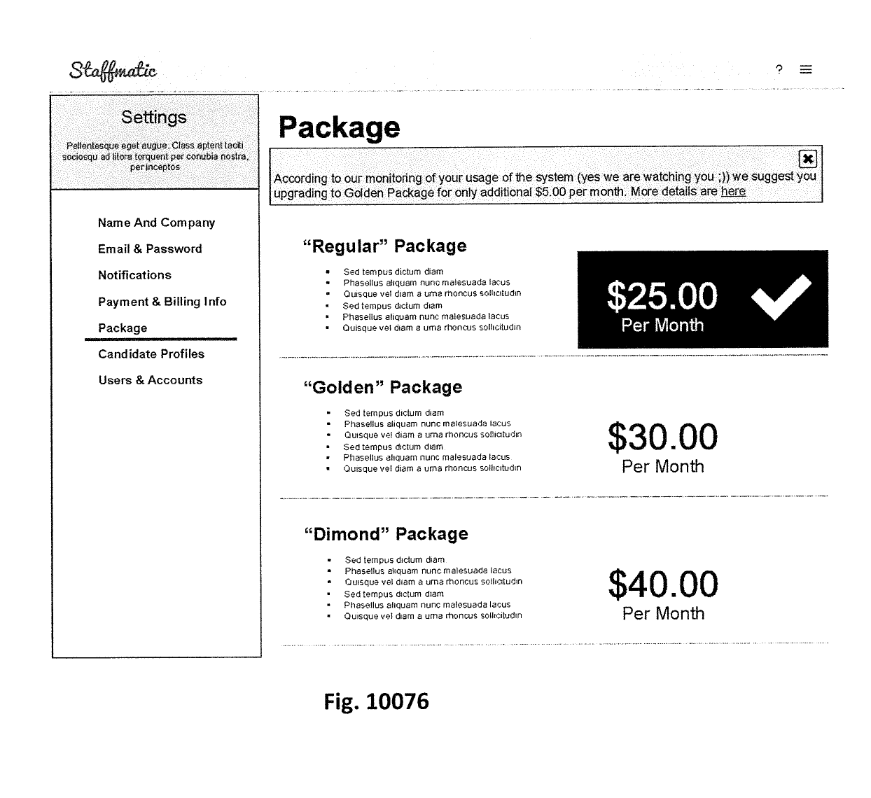

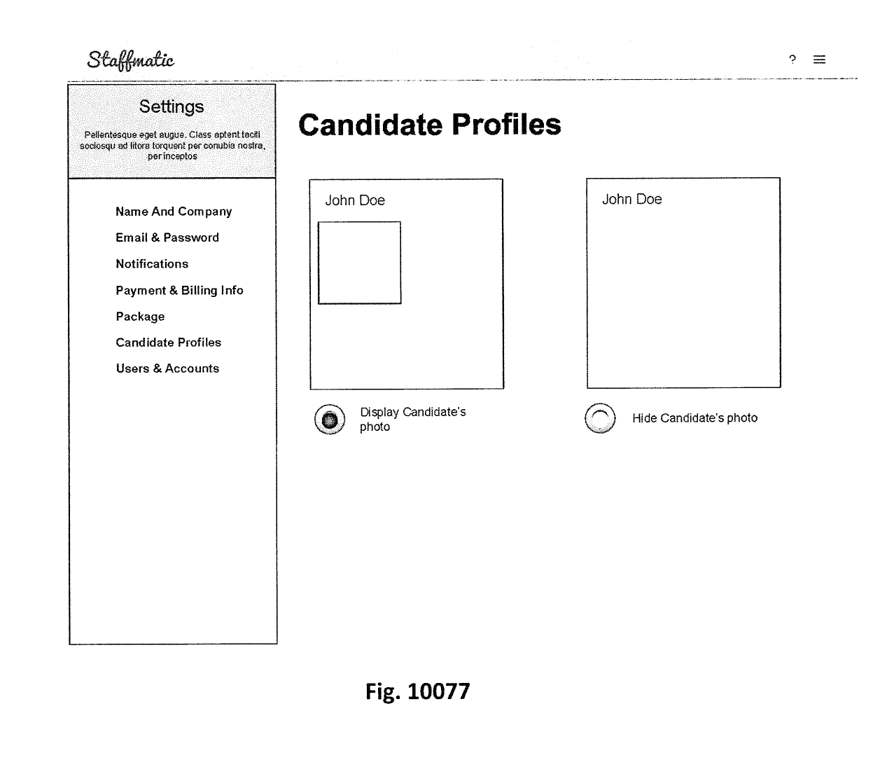

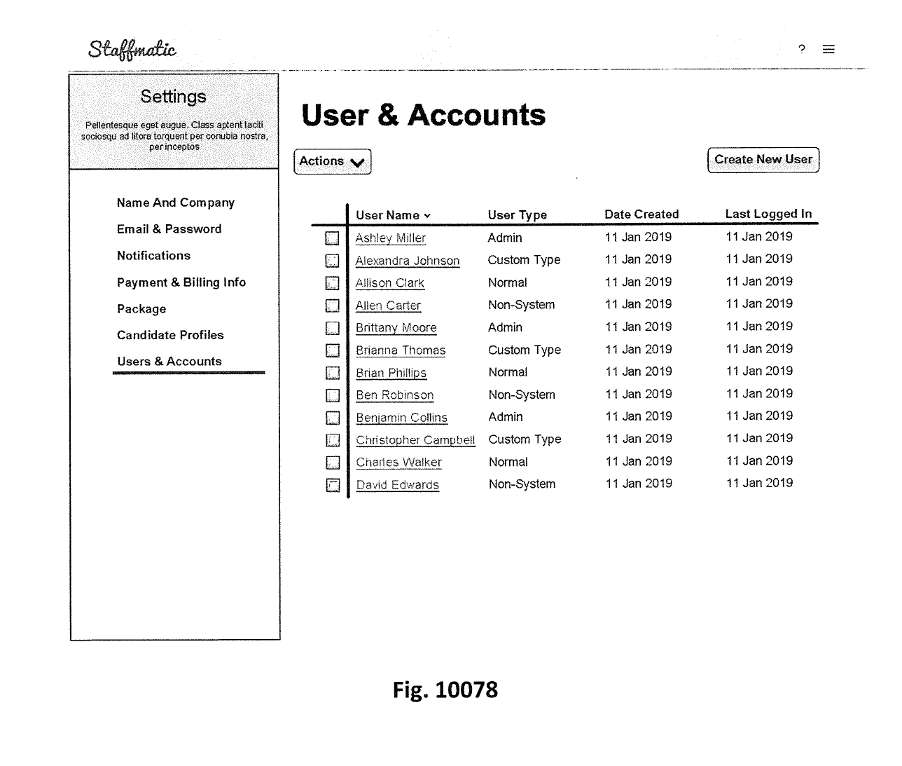

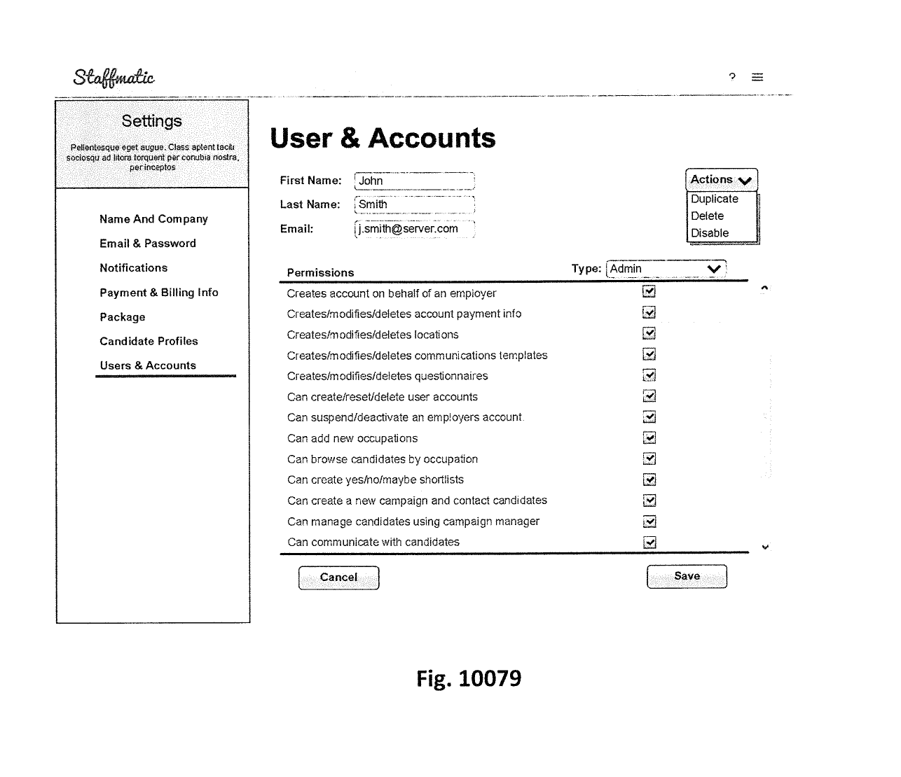

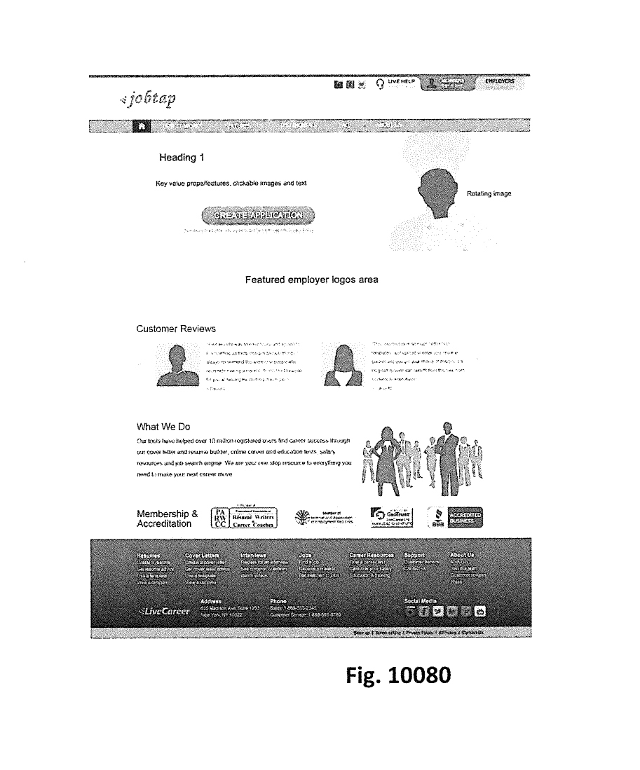

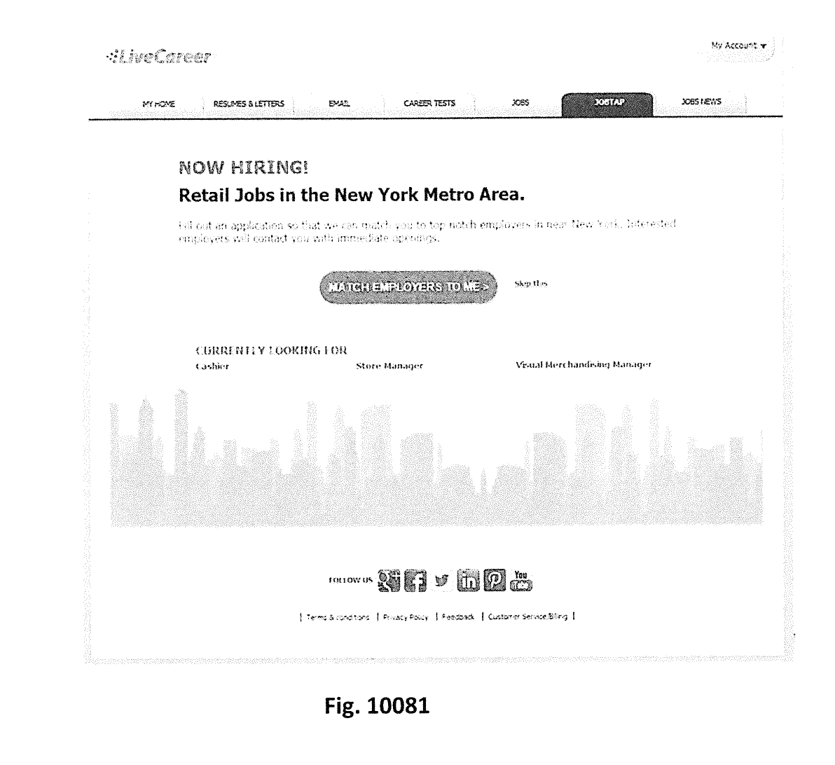

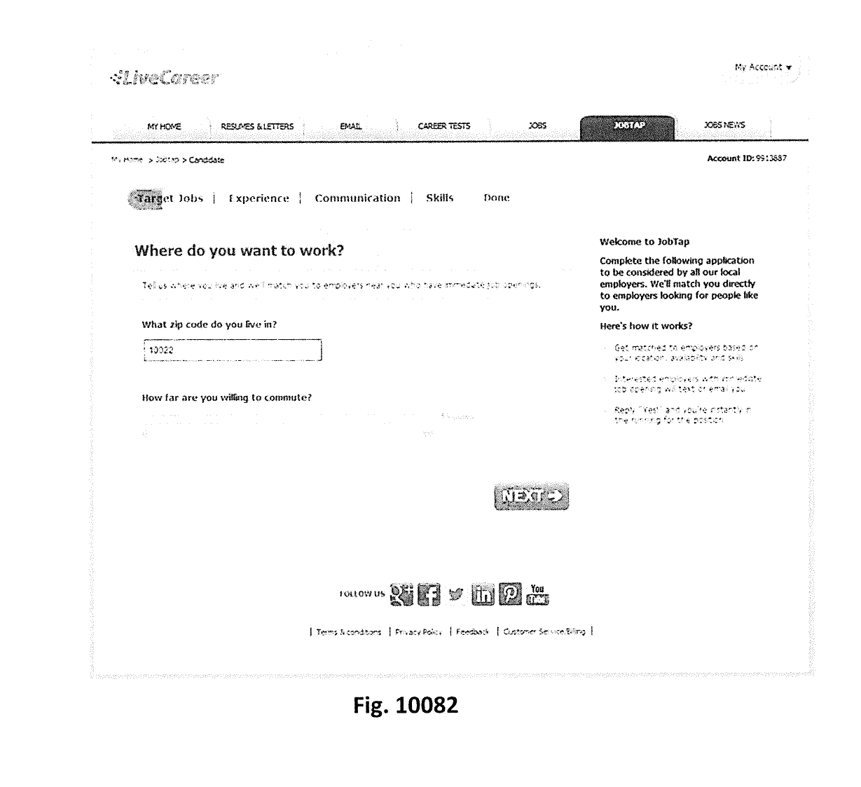

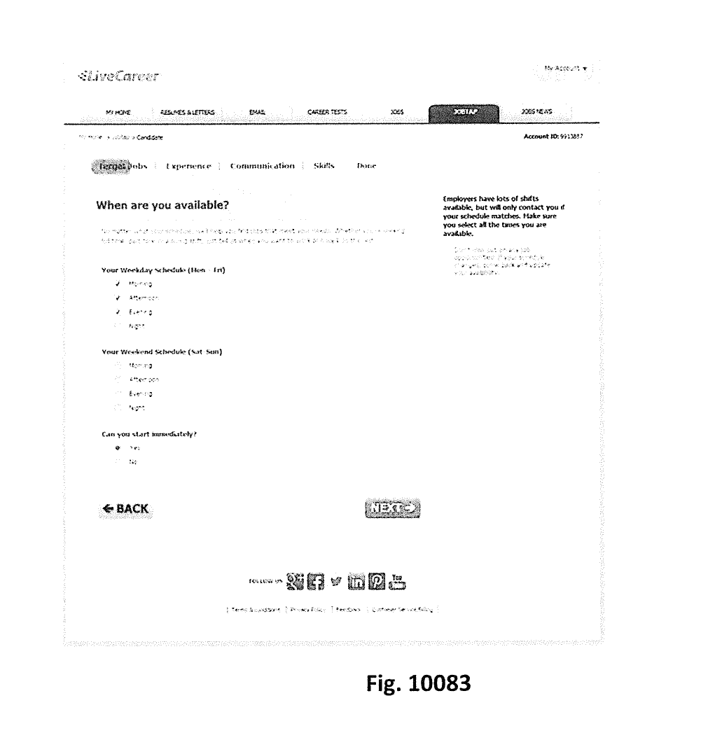

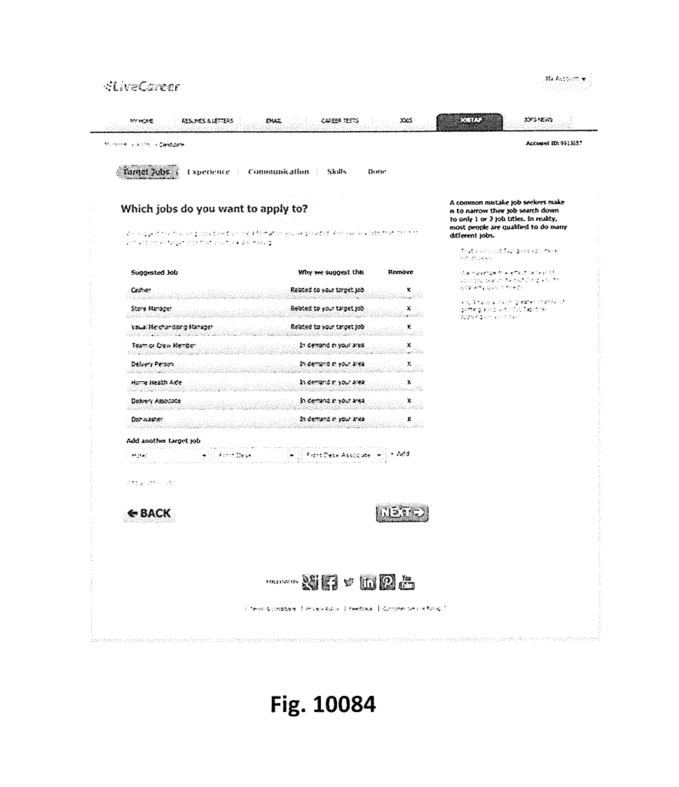

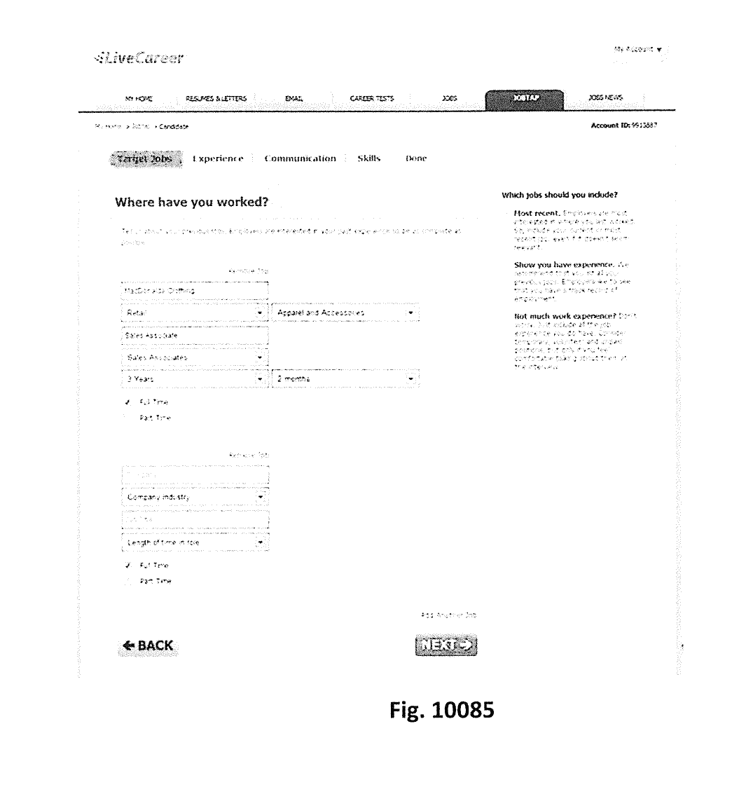

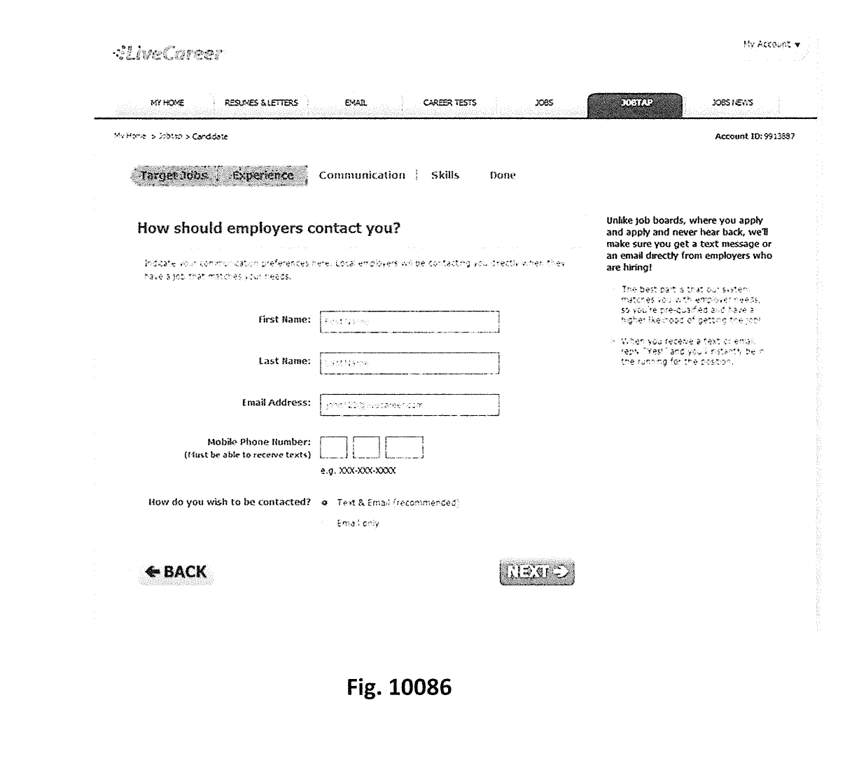

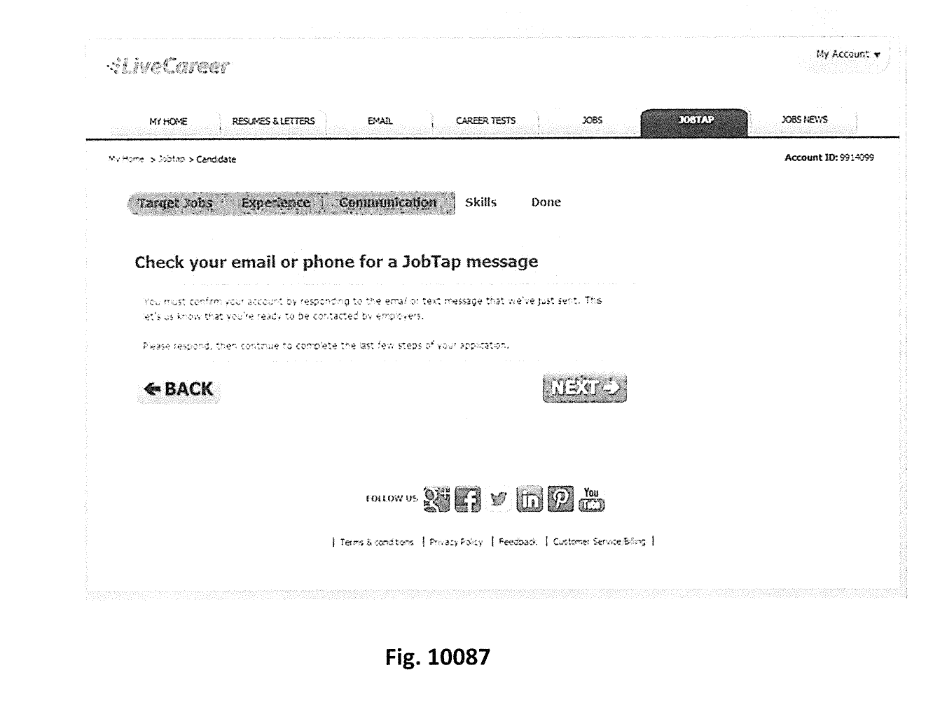

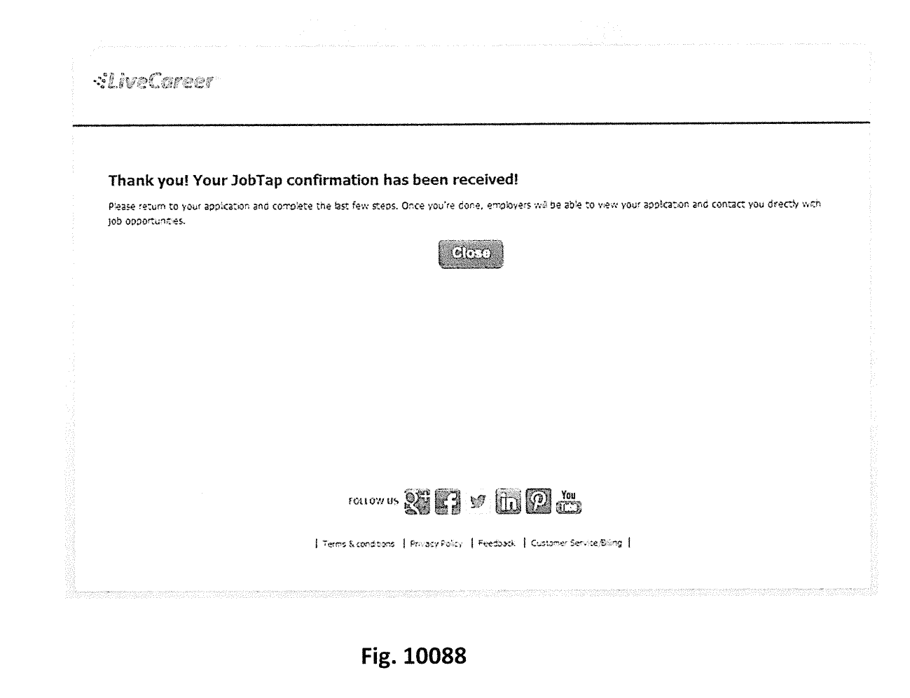

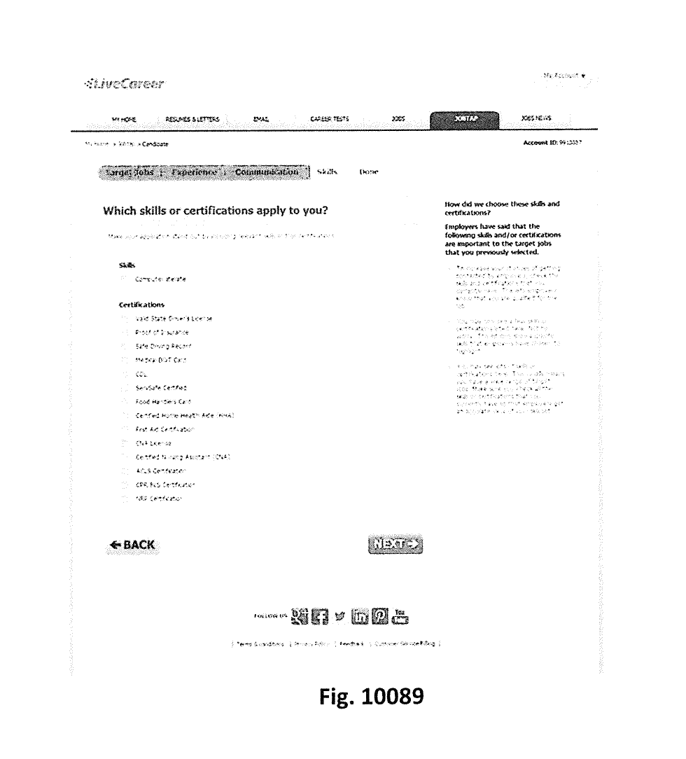

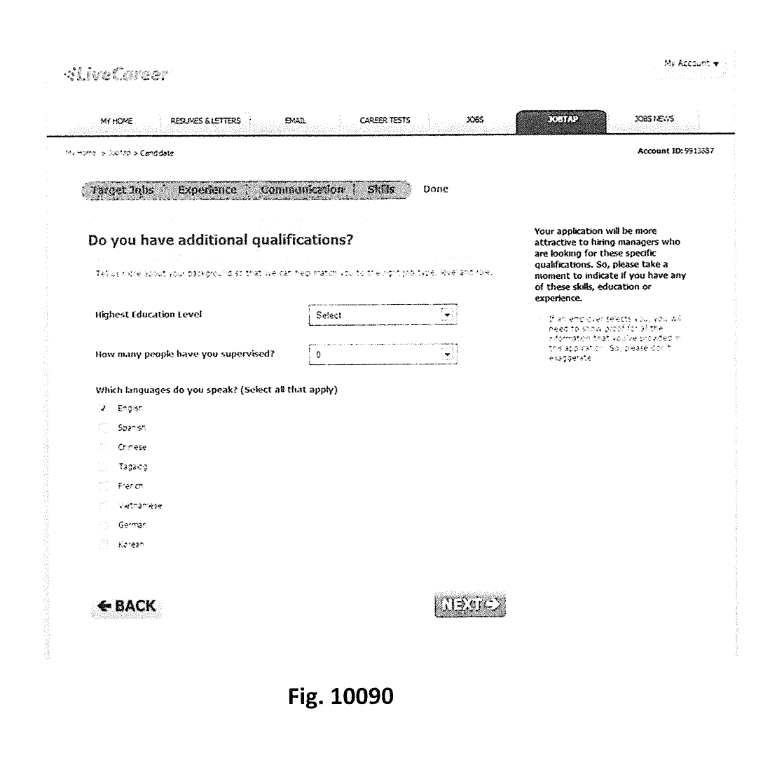

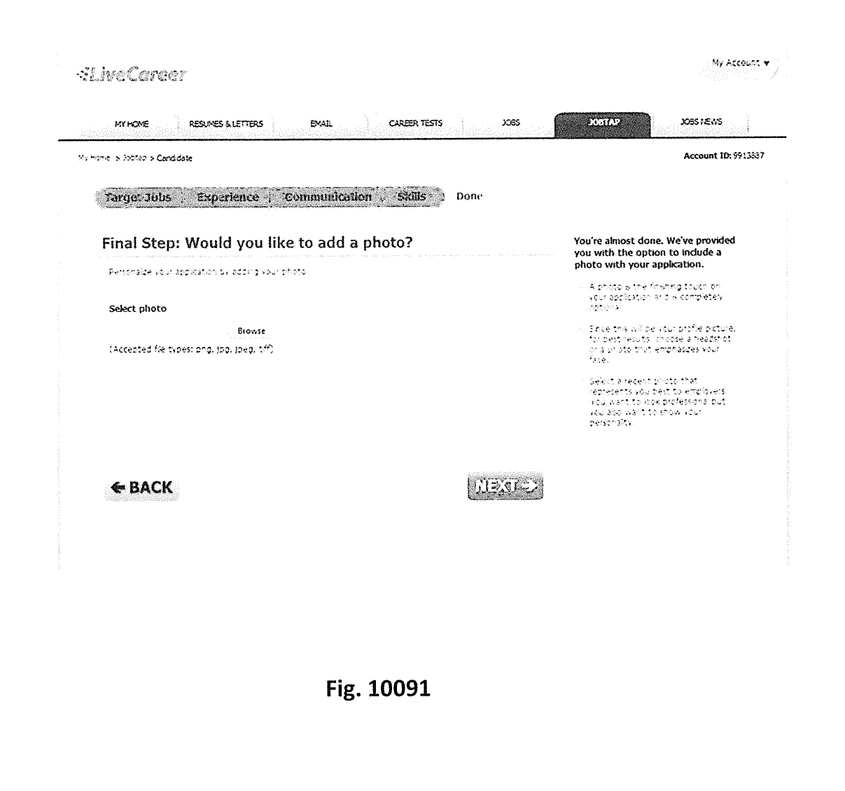

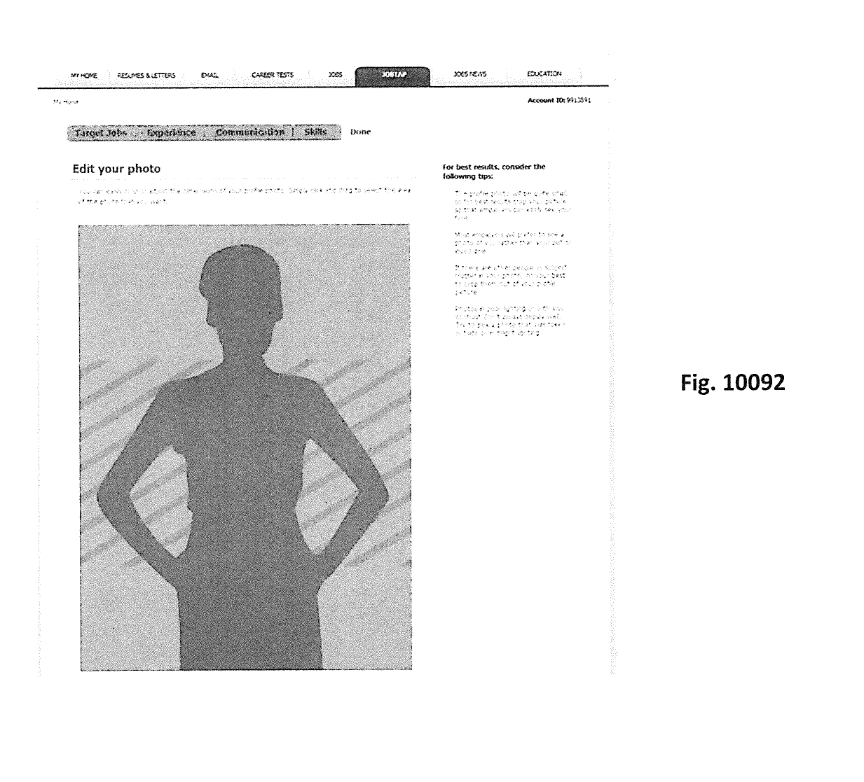

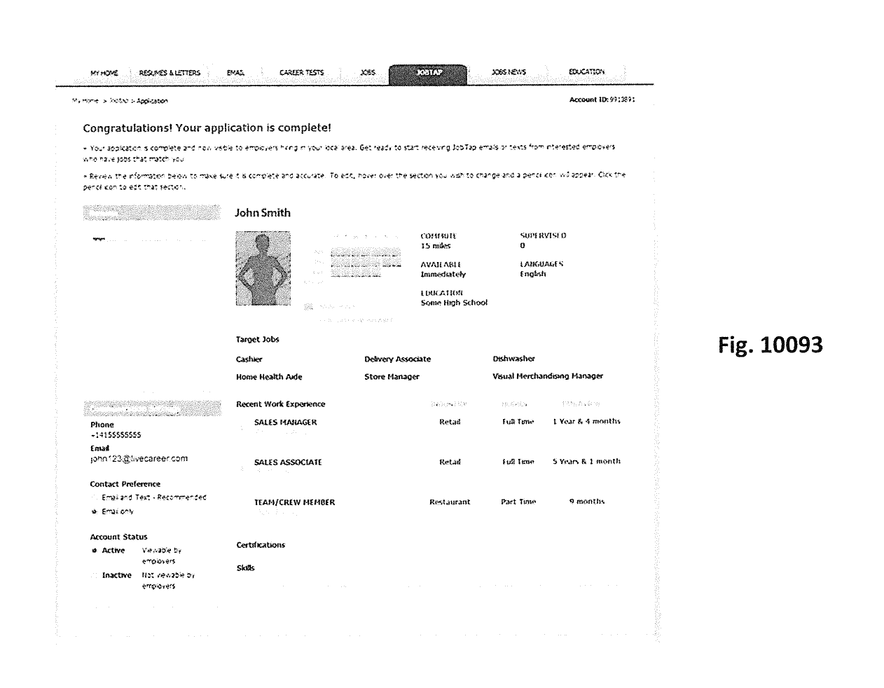

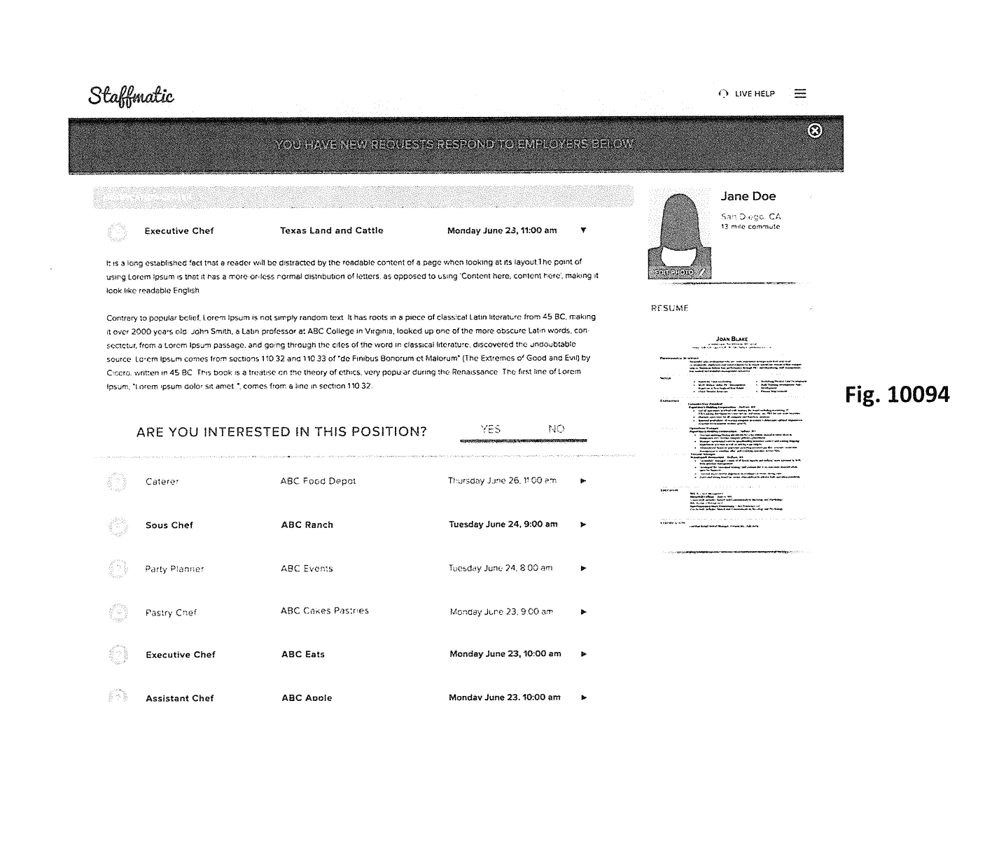

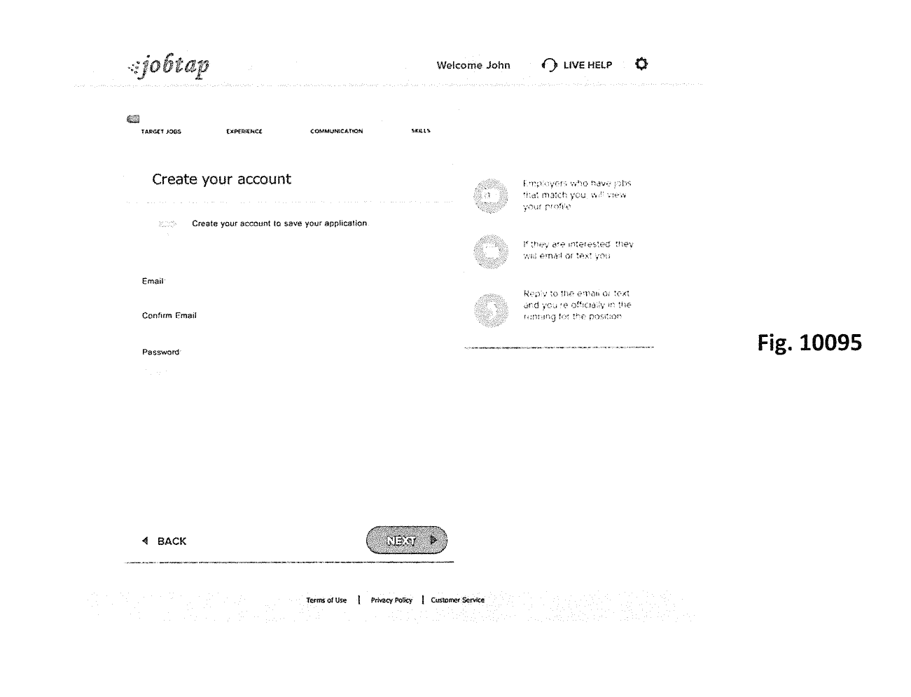

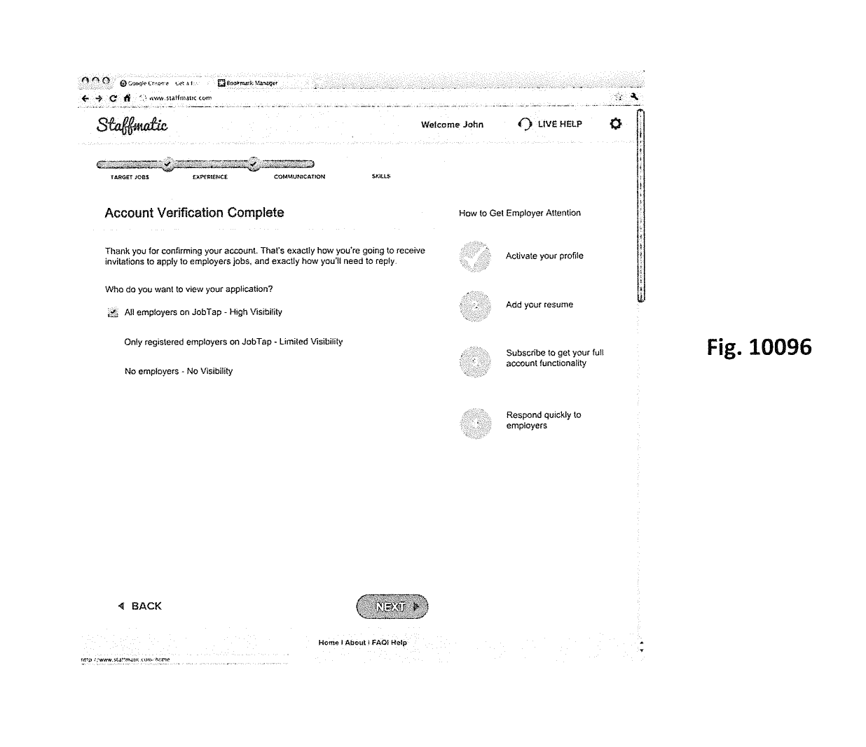

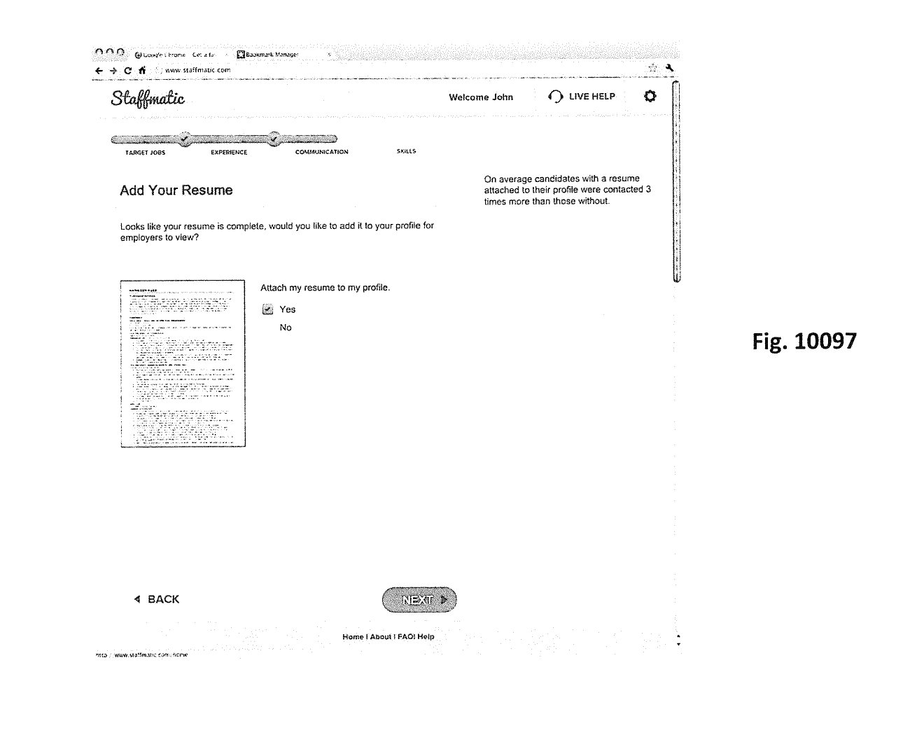

FIG. 10000 provides an illustration of an exemplary embodiment of the present invention. As shown in FIG. 10000, this particular embodiment may include one or more management computing entities 100, one or more candidate computing entities 105, one or more customer/employer computing entities 110, and one or more networks 115. Each of these components, entities, devices, systems, and similar words used herein interchangeably may be in direct or indirect communication with, for example, one another over the same or different wired or wireless networks. Additionally, while FIG. 10000 illustrates the various system entities as separate, standalone entities, the various embodiments are not limited to this particular architecture.

### Management Computing Entity

FIG. 10001 provides a schematic of a management computing entity 100 according to one embodiment of the present invention. In general, the terms device, system, computing entity, entity, and/or similar words used herein interchangeably may refer to, for example, one or more computers, computing entities, mobile phones, desktops, tablets, notebooks, laptops, distributed systems, watches, glasses, key fobs, RFID tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein. The management computing entity 100 may also include, be associated with, and/or be in communications with an active database stocking system, candidate/applicant tracking system, candidate database, customer/employer database, and/or the like. Thus, reference to the management computing entity 100 may also refer to such systems. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information/data, and/or similar terms used herein interchangeably.

As indicated, in one embodiment, the management computing entity 100 may also include one or more communications interfaces 220 for communicating with various computing entities, such as by communicating data, content, information/data, and/or similar terms used herein interchangeably that can be transmitted, received, operated on, processed, displayed, stored, and/or the like. For instance, the management computing entity 100 may communicate with candidate computing entities 105, customer/employer computing entities, and/or various other computing entities.

As shown in FIG. 10001, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a structured collection of records or data that is stored in a computer-readable storage medium, such as via a relational database, hierarchical database, and/or network database.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system.

As indicated, in one embodiment, the management computing entity 100 may also include one or more communications interfaces 220 for communicating with candidate computing entities 105, customer/employer computing entities, and/or various other computing entities, such as by communicating data, content, information/data, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the management computing entity 100 may include or be in communication with one or more input elements, such as a keyboard input, a mouse input, a touch screen/display input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances.

### Exemplary Candidate Computing Entity

A candidate/user may be an individual, a family, a company, an organization, an entity, a department within an organization, a representative of an organization and/or person, and/or the like. In one embodiment, a candidate may be seeking employment. In another embodiment, a candidate may be seeking to sell goods or services. As will be recognized, the term “candidate” is used generically for illustrative purposes in describing certain embodiments herein. FIG. 10002 provides an illustrative schematic representative of a candidate computing entity 105 that can be used in conjunction with embodiments of the present invention. In general, the terms device, system, computing entity, entity, and/or similar words used herein interchangeably may refer to, for example, one or more computers, computing entities, computing entities, mobile phones, desktops, tablets, notebooks, laptops, distributed systems, watches, glasses, key fobs, radio frequency identification (RFID) tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein. Candidate computing entities 105 can be operated by various parties. As shown in FIG. 10002, the candidate computing entity 105 can include an antenna 312, a transmitter 304 (e.g., radio), a receiver 306 (e.g., radio), and a processing Block 308 (such as those described above with regard to the management computing entity 100) that provides signals to and receives signals from the transmitter 304 and receiver 306, respectively.

The signals provided to and received from the transmitter 304 and the receiver 306, respectively, may include signaling information/data in accordance with air interface standards of applicable wireless systems. In this regard, the candidate computing entity 105 may be capable of operating with one or more air interface standards, communication protocols, modulation types, and access types. More particularly, the candidate computing entity 105 may operate in accordance with any of a number of wireless communication standards and protocols, such as those described above with regard to the management computing entity 100. In a particular embodiment, the candidate computing entity 105 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth, USB, and/or the like.

Via these communication standards and protocols, the candidate computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The candidate computing entity 105 can also download changes, add-ons, and updates, for instance, to its firmware, software (e.g., including executable instructions, applications, program modules), and operating system.

According to one embodiment, the candidate computing entity 105 may include a location determining device and/or functionality. For example, the candidate computing entity 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

According to one embodiment, the candidate computing entity 105 may include location determining aspects, devices, modules, functionalities, and/or similar words used herein interchangeably. For example, the candidate computing entity 105 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the user computing entity's 110 position in connection with a variety of other systems, including cellular towers, Wi-Fi access points, and/or the like. Similarly, the candidate computing entity 105 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The candidate computing entity 105 may also comprise a user interface (that can include a display 316 coupled to a processing Block 308) and/or a user input interface (coupled to a processing Block 308). For example, the user interface may be a candidate/customer application, browser, website/webpage, screen, display, page, user interface, and/or similar words used herein interchangeably executing on and/or accessible via the candidate computing entity 105 to interact with and/or cause display of information/data from the management computing entity 100, as described herein. The user input interface can comprise any of a number of devices allowing the candidate computing entity 105 to receive data, such as a keypad 318 (hard or soft), a touch display, voice or motion interfaces, or other input device. In embodiments including a keypad 318, the keypad 318 can include (or cause display of) the conventional numeric (0-9) and related keys (#, *), and other keys used for operating the candidate computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The candidate computing entity 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the candidate computing entity 105. As indicated, this may include a candidate application that is resident on the entity or accessible through a browser or other user interface for communicating with the management computing entity 100, customer/employer computing entity 110, and/or various other computing entities.

In another embodiment, the candidate computing entity 105 may include one or more components that are functionally similar to those of the management computing entity 100, as described in greater detail above.

### Exemplary Customer/Employer Computing Entity

A customer/employer may be an individual, a family, a company, an organization, an entity, a department within an organization, a representative of an organization and/or person, and/or the like. In one embodiment, a customer/employer may be seeking to hire one or more candidates to hire for employment. In another embodiment, a customer/employer may be seeking to purchase goods or services from one or more candidates. As will be recognized, the term “customer” is used generically for illustrative purposes in describing certain embodiments herein. In one embodiment, a customer/employer may operate a customer/employer computing entity 110 that includes one or more components that are functionally similar to those of the management computing entity 100 and/or the candidate computing entity 105. For example, in one embodiment, each customer/employer computing entity 110 may include one or more processing elements, one or more display device/input devices (e.g., including user interfaces), volatile and non-volatile storage or memory, and/or one or more communications interfaces. For example, the user interface may be a candidate/customer application, browser, website/webpage, screen, display, page, user interface, and/or similar words used herein interchangeably executing on and/or accessible via the customer/employer computing entity 110 to interact with and/or cause display of information/data from the management computing entity 100, as described herein. This may also enable to the customer/employer computing entity 110 to communicate with various other computing entities, such as candidate computing entities 105, and/or various other computing entities.

These architectures are provided for exemplary purposes only and are not limiting to the various embodiments. The term computing entity may refer to one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein.

### III. Exemplary System Operation

Reference will now be made to FIGS. 10003A, 10003B, and 10003C. FIGS. 10003A, 10003B, and 10003C are flowcharts illustrating operations and processes in accordance with one embodiment of the present invention. FIGS. 10004-10097 are exemplary input and output that can be produced in accordance with various embodiments of the present invention.

### Candidate Profiles

In one embodiment, a candidate (e.g., operating a candidate computing entity 105 executing a candidate application, browser, website/webpage, screen, display, page, user interface, and/or similar words used herein interchangeably) can input various information/data to create/generate or update/modify a candidate profile for storage and use by the management computing entity 100 (e.g., via a candidate database)—see FIGS. 10081-10097. A candidate profile can be associated with a candidate's account, program, information/data, and/or similar words used herein interchangeably. For example, a candidate profile may include a candidate name, email addresses, text message/notification addresses, social media addresses, usernames and/or other credentials, phone numbers, messaging/notification preferences, and/or physical addresses (which may be referred to herein as electronic destination addresses). In addition to biographical information/data, a candidate profile may also comprise a candidate's primary skill, work/job class, education information/data, languages, full-time equivalent value, base rate of pay, and/or preferred wage. Similarly, a candidate profile may also comprise the candidate's emergency contact information/data, birthday, languages spoken, driving distance to work or another geographic area, ethnicity, acceptable commuting distance, acceptable commuting time, acceptable work/job titles, acceptable shift schedules, benefit requirements, and/or the like. Other information/data could also be stored within a candidate profile, such as the candidate's certifications or licenses, experience, schedule preferences, availability (days, weeks, hours), religious holidays observed, allergies, and/or physical limitations (e.g., FIGS. 10045-10046). Such information/data may be manually input by a candidate (e.g., operating a candidate computing entity 105); automatically provided by a candidate; automatically provided by allowing access to other accounts, such as Amazon.com, Facebook, Gmail, Twitter, PayPal, and/or the like; automatically collected by various computing entities; and/or combinations thereof and other techniques and approaches. As will be recognized, in one embodiment, the management computing entity 100 and various other computing entities may create, access update, store, use, and/or have access to profiles for enrolled/registered candidates.

In one embodiment, candidates (e.g., operating a candidate computing entities 105) can navigate to specific websites/webpages to create/generate profiles, such as jobtap.com or livecareer.com. In this example, a candidate (e.g., operating a candidate computing entity 105) may be able to access jobs, occupations, work, positions, employment, and/or similar words used herein interchangeably for a variety of customers/employers. In another embodiment, the management computing entity may provide micro or mini websites/webpages that candidates (e.g., operating a candidate computing entities 105) can access for specific occupations/jobs/positions, specific customers/employers with one or more occupations/jobs/positions and/or the like. For instance, FIG. 10049 shows a micro or mini website/webpage for Taco Bell that allows candidates (e.g., operating a candidate computing entities 105) to create/generate profiles or otherwise be considered for occupations/jobs/positions with Taco Bell in geographic area. In another embodiment, candidates (e.g., operating a candidate computing entities 105) can scan, select, activate, or similar words used herein interchangeably barcodes, Aztec Codes, MaxiCodes, Data Matrices, Quick Response (QR) Codes, electronic representations, and/or the like that will direct the operating a candidate computing entity 105 to an appropriate interface for the same. As will be recognized, a variety of other approaches and techniques can be used to adapt to various needs and circumstances.

In one embodiment, the management computing entity 100 can impose configurable exclusivity parameters for candidates (e.g., candidate profiles) that enrolled/registered through a micro or mini website/webpage. For instance, if a candidate (e.g., operating a candidate computing entity 105) enrolls/registers with the management computing entity 100 through the Taco Bell micro or mini website/webpage, the management computing entity 100 can impose a configurable exclusivity parameter (e.g., 10 hours, 14 days, 30 days, after the profile has been viewed or accessed by the exclusive customer/employer, and/or the like) on the candidate's profile. That is, the management computing entity 100 can limit access to the candidate's profile to the exclusive customer/employer for a configurable time period (e.g., 10 hours, 14 days, 30 days) and/or until triggering event occurs (e.g., until the profile has been viewed or accessed by the exclusive customer/employer).

### Customer/Employer Profiles

In one embodiment, a customer/employer (e.g., operating a customer/employer computing entity 110 executing a customer/employer application, browser, website/webpage, screen, display, page, user interface, and/or similar words used herein interchangeably) can input various information/data to create/generate or update/modify a customer/employer profile for storage and use by the management computing entity 100—see FIGS. 10072-10081. A customer/employer profile can be associated with a customer's account, program, information/data, and/or similar words used herein interchangeably. In one embodiment, a customer/employer may have one or more customer/employer profiles, such as profiles that correspond to specific companies, subsidiaries, departments, locations, geographic areas, branches, jobs, and/or the like.

In one embodiment, to create/generate a customer/employer profile, for example, information/data associated with the customer/employer can be manually input by the customer/employer (e.g., operating a customer/employer computing entity 110); automatically provided by the customer/employer; automatically provided by allowing access to other accounts; automatically collected by various computing entities; and/or combinations thereof and other techniques and approaches. The customer/employer profile may include customer/employer information/data, such as the customer's name, address (or other location information), size information/data, branch information/data, department information/data, subsidiary information/data, location information/data, logo, and/or the like.

### Vending Machines, Campaigns, Pipelines, Searches, and Folders

In one embodiment, as shown in FIGS. 10005-10008 and 10050-10052, the customer/employer application (e.g., executing on the customer/employer computing entity 110) can cause display of instructions for interacting with the management computing entity 100 to identify potential candidates for filling staffing positions, employment positions, job positions, work positions, and/or similar words used herein interchangeably. To fill such positions, a customer/employer application (e.g., operating a customer/employer computing entity 110) can initiate, resume, or return to a vending machine, campaign, pipeline, search, folder, and/or similar words used herein interchangeably associated with the same.

In one embodiment, to initiate a campaign or pipeline for a position, as shown by element 44 of FIG. 10007, an enrolled/registered customer/employer (e.g., operating a customer/employer computing entity 110) can select a category of occupations/jobs/positions of interest. As will be recognized, in certain embodiments, the customer/employer can complete these steps as part of enrollment/registration. For instance, as the customer/employer (e.g., operating a customer/employer computing entity 110) inputs an occupation/job/position, the management computing entity 100 can provide a list or display of matching occupations/jobs/positions to the customer/employer computing entity 110 for display based on a match of the input and occupations/jobs/positions, as shown as element 45 of FIG. 10008. In another embodiment, a customer/employer (e.g., operating a customer/employer computing entity 110) can select or otherwise input a category of occupations/jobs/positions, such as selecting “accounting and finance” as the category of occupations/jobs/positions. In response, the management computing entity 100 can provide the customer/employer computing entity 110 with a list of occupations/jobs/positions for the selected category. The occupations/jobs/positions may be based on a taxonomy, for instance. In this example, the list of matching occupations/jobs/positions accounting and finance may comprise accountants, accounts payable/receivable, auditors, banking, bookkeepers, collections, controllers and treasurers, financial analysts, financial management, investment banking, payroll administrators, tax professionals, administrative assistants, data entry and word processing, executive assistants, office assistants, office management, receptionists, stenography and court reporting, and/or the like. As will be recognized, a variety of other techniques and approaches can be used to adapt to various needs and circumstances.

In one embodiment, after a position is selected, the customer/employer application can (in communication with the management computing entity 100) cause display of suggestions of other occupations/jobs/positions (shown as element 47 of FIG. 10009) that might be relevant based on other customers/employers who hire for similar occupations/jobs/positions. The occupations/jobs/positions can be displayed via the customer/employer computing entity 110 (in communication with the management computing entity 100) in slots grayed out with a Yes/No prompt (element 48 of FIG. 10009) with a prompt querying whether the customer/employer would like that kind of occupation or positions type added to the vending machine, campaign, search, pipeline, or folder.

In one embodiment, once the customer/employer identifies the occupations/jobs/positions, the customer/employer (e.g., operating a customer/employer computing entity 110) can select “Add” (shown as element 46 of FIG. 10008) to choose the same. This step adds the occupations/jobs/positions to the corresponding vending machine, campaign, pipeline, search, and/or folder. A vending machine, campaign, pipeline, search, and/or folder can be for any number of occupations/positions. The management computing entity 100 can then save/store the vending machine, campaign, search, pipeline, or folder in association with the customer's profile (Block 8 of FIG. 10003A and FIGS. 10016, 10042, and 10057-10060). This can allow the customer/employer (e.g., operating a customer/employer computing entity 110) and/or other entities to access the same.

In one embodiment, the management computing entity 100 can regularly, periodically, continuously, or in response to certain triggers search for and provide (e.g., “stock”) matching candidates for the customer/employer to review in association with the vending machine, campaign, search, pipeline, or folder in association with the customer's profile (Blocks 1, 2, and 3 of FIG. 10003A). To do so, the management computing entity 100 can identify and filter candidate profiles based on the designated criteria for the requested occupation/positions. Similarly, if vending machines, campaigns, searches, pipelines, or folders have been saved/stored previously by the management computing entity 100, the customer/employer (e.g., operating a customer/employer computing entity 110) can navigate between them, for example, under a “Manage Hiring” section (element 67 of FIG. 10022) and “Occupations” (element 66 of FIG. 10022)—see also FIGS. 10022-10071 and Blocks 1, 2, and 3 of FIG. 10003A. Otherwise, the customer/employer (e.g., operating a customer/employer computing entity 110) may be directed to the “Occupations” screen, display, interface, and/or similar words used herein interchangeably (e.g., FIG. 10009).

In one embodiment, the customer/employer (e.g., operating a customer/employer computing entity 110) can select one of the occupations/jobs/positions in the occupation slots (element 49 of FIG. 10009) to identify the corresponding types of candidates, at which point the customer/employer (e.g., operating a customer/employer computing entity 110) may be presented with search results for that occupation/job/position. If a customer/employer wants to view candidates from a previously saved/stored campaign, the customer/employer (e.g., operating a customer/employer computing entity 110) can do so by selecting a “Manage” button (element 65 and Block 8 of FIG. 10003A). The terms button, graphic, icon, image, function, feature, selection, hyperlink, activator, and/or similar words are used herein interchangeably. In one embodiment, this may direct the customer/employer into the vending machine, campaign, search, pipeline, or folder where he/she can review candidates (e.g., candidate profiles) from a plurality of lists: a Database list, an Apply Inbox list, a Favorite/Waiting list, a Closed list, and/or the like.

In one embodiment, the management computing entity 100 can automatically indicate/associate and cause display of candidate profiles solicited by a customer/employer for a given campaign in an “Apply Inbox” list, link, area, and/or similar words used herein interchangeably (see FIGS. 10043-10044). The management computing entity 100 can automatically indicate/associate and cause display of candidate profiles identified as part of a campaign or pipeline in a “Database” list. For candidates selected and/or contacted from the Apply Inbox list or Database list, the management computing entity 100 can automatically indicate/associate and cause display of the candidate profiles in a Favorite/Waiting list. Or, the management computing entity 100 can automatically indicate/associate the same as part of the Database list with an appropriate identifier (see FIGS. 10043-10044). The management computing entity 100 can automatically indicate/associate and cause display of candidate profiles have been contacted by the management computing entity 100 and have responded to a “Short” list. Once a customer/employer hires, rejects, or indicates a candidate as not being interested in the campaign, the management computing entity can indicate the corresponding profiles can cause display of the same in the “Closed” list. As will be recognized, the management computing entity 100 can associate the profiles with a given campaign or pipeline. And each candidate profile can have one or more indicators for the various campaigns or pipelines for which the respective candidates are being considered. For instance, Joe Doe may be on a Short list for a Taco Bell in Tampa, Fla., and be on a Closed list for a McDonald's in Tampa, Fla. (for being rejected by the customer/employee). In one embodiment, the management computing entity 100 can create/generate regular campaign or pipeline messages/notifications with updates or changes to the corresponding campaign or pipeline. For example, the messages/notifications may indicate the number of new candidates identified, the number of candidates and who responded after being contacted, and/or the like.

Through these lists, the customer/employer (e.g., operating a customer/employer computing entity 110) can view candidates the customer/employer solicited, candidates the customer/employer contacted, candidates the management computing entity 100 identified, candidates the customer/employer put in a favorite/waitlist list, candidates who responded to the customer/employer, candidates the customer/employer hired, and/or candidates the customer/employer rejected or deemed uninterested, and/or the like.

In one embodiment, a customer/employer (e.g., operating a customer/employer computing entity 110) can review and select matching candidates on the search page/results (e.g., FIGS. 10010-10015 and 10053-10056 and Block 6 of FIG. 10003A). For example, when a customer/employer (e.g., operating a customer/employer computing entity 110) opens the search page/results (e.g., FIGS. 10010-10015 and 10053-10056), a filter column (element 50 of FIG. 10010) is provided or presented where various criteria can be changed to adjust which candidates of the selected occupation/job/position will be shown. In one embodiment, the criteria are initially broad—such as identifying all candidate profiles within a specified geographic area (including a defined geofence). For instance, a campaign for a bartender in the zip code 30309 can return results of all candidate profiles for candidates who live in or are willing to work in or commute to the zip 30309 for a job as a bartender. This approach allows the customer/employer to be presented with the greatest number of matching candidates. If the customer/employer is returning to a search that was saved/stored previously (as a vending machine, campaign, search, pipeline, or folder), the search criteria may be set to what was set the last time the saved/stored search criteria were changed. Alternatively, if the customer/employer is presented with the search page/results by selecting an occupation from a previous search, the search can start with the last settings used for a search on that occupation within the current vending machine, campaign, search, pipeline, or folder.

In one embodiment, the management computing entity 100 may filter candidates based on a “freshness” indicator or factor (e.g., a flag, tag, or indicator in the candidate database)—e.g., only using active candidate profiles. For example, the management computing entity 100 can contact candidates (e.g., operating candidate computing entities 105) who have not interacted with the management computing entity 100 within configurable time period (e.g., hours, days, weeks, months) to confirm that the candidates are still seeking or interested employment opportunities. The management computing entity 100 may conduct such interactions via email, SMS, MMS, social media, the candidate application, and/or the like. In one embodiment, candidates may need to interact with the management computing entity 100 within the configurable time period for their profiles to be accessible or viewable by customers. For instance, the management computing entity 100 can create/generate and send/transmit/provide a text message to candidates every two weeks (or other configurable time period). The management computing entity 100 can maintain the candidates who respond to the text message, for example, as active. That is, their candidate profiles can be provided for review as part of campaigns or pipelines. In some embodiments, the management computing entity 100 may require responses from the candidates to be received within a configurable time period. That is, the management computing entity 100 may require candidates to response within 24-48 (or some other time period) to be considered as “active candidates” or “active candidate profiles.” For the candidates who do not respond (e.g., who do not reply to the text message), the management computing entity 100 can purge or inactivate their profiles such that they are not provided for review in a campaign or pipeline. That is, profiles for “inactive candidates” or “inactive candidate profiles” will not be returned as potential candidates for campaign or pipeline. This allows for campaigns or pipelines to only be “stocked” with candidates who are looking for work and have recently confirmed the same. That is, the management computing entity 100 does not consider inactive candidates for vending machines, campaigns, searches, pipelines, or folders.

In one embodiment, in addition to applying whatever criteria the customer/employer has selected or input, the management computing entity 100 (e.g., via matching algorithm) can filter out candidates whose preferences do not match the customer's position or work/job opening. Such criteria may include distance to the candidates' acceptable commute distance based on the customer's location (e.g., acceptable range), acceptable occupation/position/work/job titles, availability, preferred, and/or the like. Thus, the management computing entity 100 can first identify all active candidates (e.g., active candidate profiles) that match the initial occupation/position/work/job criteria and then can filter out candidates based on other specified criteria.

In one embodiment, the customer/employer (e.g., operating a customer/employer computing entity 110) may be able to filter on select criteria as well (for application by the management computing entity 100). Such criteria may include (1) wage range, (2) range of experience, (3) education level, (4) shift availability, (5) language, (6) keyword, (7) criteria specific to the occupation (such as sub-industry, skills, certifications, preferred occupation, and/or the like), and/or the like. In one embodiment, a sort tab (element 51 of FIG. 10010) can also be provided or presented for the customer/employer (e.g., operating a customer/employer computing entity 110) to adjust the primary sort order. In one embodiment, the default may be wage, but can be set to any other criteria, including candidate responsiveness. For candidate responsiveness, within the selected sort, candidates who are most likely to respond based on the management computing entity's 100 predictive analytics (which is described in greater detail below) for candidate responsiveness can be displayed first. In one embodiment, as the customer/employer (e.g., operating a customer/employer computing entity 110) updates the filters, the management computing entity 100 can provide for display the matching candidates instantly, along with an indication (element 52 of FIG. 10011) of how many candidates match the specified filters. For example, if no “highest education” requirement is specified, the customer/employer (e.g., operating a customer/employer computing entity 110) can select a particular education level (element 54 of FIG. 10012), and if not all of the candidates shown meet the minimum education level, the number of matching candidates (element 53 of FIG. 10012) would be appropriately reduced by the management computing entity 100 for display by the customer/employer computing entity 110. Similarly, a customer/employer (e.g., operating a customer/employer computing entity 110) can adjust the acceptable commute distance (e.g., acceptable range) for candidates that may decrease the number of candidate profiles displayed as part of the campaign or pipeline. The display filters can also indicate how many candidates match the criteria specified by the available filter settings, which allows the customer/employer to know how many more or fewer candidates can be seen by changing to the particular filter setting.

In one embodiment, if no candidates or a number of candidates below a configurable threshold at which profit can be expected to be optimal based on a historical correlation between the multiple of available matching candidates and profitability (e.g., determined by the management computing entity 100), or based on a configurable threshold (e.g., set by an administrator of the management computing entity 100), match the search criteria, the customer/employer (e.g., operating a customer/employer computing entity 110) can be presented or provided with an option to initiate/trigger an advertising request/campaign (Block 5 of FIG. 10003A) to reach additional candidates (described in greater detail below). It should be noted that an optimal threshold automatically determined by the management computing entity 100 can be changed by a system administrator, for example. Thus, an optimal threshold may also be considered a configurable threshold in various embodiments. Depending on the customer's contracted service level, the volume of business the customer/employer does with the service, and/or how long the customer/employer has been actively using the service, such an option may or may not be presented. If presented via the customer/employer computing entity 110, the option could serve as a prompt to the customer/employer to provide an explanation of why the criteria being sought is desired or important, or it might simply record the request. In another embodiment, when no candidates or a number of candidates below a configurable and/or optimal threshold (e.g., automatically determined or manually set) match the search criteria, the customer/employer (e.g., operating a customer/employer computing entity 110) may be provided with a survey that allows the customer/employer to indicate that he or she did not find the candidates desired. The survey may also query how many similar positions the customer/employer has open and/or how many similar positions the customer/employer fills a week, a month, or a year.

In one embodiment, the search page/results presented to the customer/employer may include five tabs (element 35 of FIG. 10004) indicating different views of candidates related to the search: Favorites; Yes; No; Maybe, and a Drop-down tab defaulting to a “Filtered” view. The drop-down tab which may initially default to “Filtered” may also have “Contacted” (element 39 of FIG. 10004) and “Qualified” (element 38 of FIG. 10004) options. As illustrated in FIG. 10018, when a customer/employer (e.g., operating a customer/employer computing entity 110) selects candidates to contact (element 59), the management computing entity 100 can provide for display to the customer/employer an option to post the search criteria as a work/job advertisement (element 63 of FIG. 10018 and Block 9 of FIG. 10003A). In one embodiment, a view of candidates who respond to a given work/job opening—regardless of whether candidates match the search criteria—can be accessed or reviewed through a drop-down option that may be referred to as a work/job board folder (element 36 of FIG. 10004). The candidate profiles that may be reviewed or accessed under the work/job board tab may indicate work/job candidates who do not meet the filter criteria with an indication to represent that the candidates do not match the specified criteria.

In one embodiment, the customer/employer computing entity 110 can cause display of candidate profiles on the search results page as “cards,” “baseball cards,” “candidate cards,” and/or similar words used herein interchangeably (element 55 of FIG. 10012 and FIGS. 10043-10046). If the customer/employer is interested in seeing more detail on a particular candidate, the customer/employer (e.g., operating a customer/employer computing entity 110) can select on the candidate card. And depending on the occupation, the customer/employer computing entity 110 (in communication with the management computing entity 100) may present or display different details on the card. For example, for a nurse, relevant certifications may be displayed by the customer/employer computing entity 110 at the top of the card. This may be used to display more information/data, as depicted in FIG. 10015, as well as Favorite, Yes, No, and Maybe buttons, which can be selected to add the candidate (e.g., candidate profile) to the appropriate list. The information/data displayed via the card depicted in FIG. 10015 can be configured by the customer, for example. For instance, once a candidate (e.g., candidate profile) has been added to one of the lists, the candidate profile can also be seen or accessed by selecting the corresponding Short list's tab at the top (element 56 of FIG. 10013) of the search results page.

In one embodiment, when a customer/employer (e.g., operating a customer/employer computing entity 110) selects a Favorite, Yes, No, or Maybe button on a candidate card for the first time on a search that has not been saved, the customer/employer computing entity 110 (in communication with the management computing entity 100) can provide a popup window (element 57 of FIG. 10016) prompting the customer/employer to save/store the vending machine, campaign, search, pipeline, or folder. Further, once at least one candidate is selected, a Contact Yes button (58 of FIG. 10017) can be displayed by the customer/employer computing entity 110 at the bottom of the search page/results. When the customer/employer (e.g., operating a customer/employer computing entity 110) selects the contact Yes button, a “Contacting” screen can be displayed (e.g., FIG. 10018). If the customer/employer (e.g., operating a customer/employer computing entity 110) quits or leaves the search page/results before adding any candidates to the Contact Yes or Favorite/Waiting lists, and it's the first time the customer/employer has quit a search for the selected filter criteria, the customer/employer computing entity 110 (in communication with the management computing entity 100) may display a mini survey asking if customer/employer found the candidates desired. The survey may also query how many similar positions the customer/employer has open and/or how many similar positions the customer/employer fills a week, month, or year.

### Manual Contacting

In one embodiment, the customer/employer (e.g., operating a customer/employer computing entity 110) can access a candidate screen, display, page, or interface to review or access, for example, small versions of the candidate cards (element 59 of FIG. 10018) of the selected candidates. The customer/employer (e.g., operating a customer/employer computing entity 110 in communication with the management computing entity 100) may be prompted to indicate the details of the opportunity (element 60 of FIG. 10018). In one embodiment, the details can be provided to the candidates (e.g., operating candidate computing entities 105) and included in an invitation by the management computing entity 100 (Block 7 of FIG. 10003A). Such invitations/messages/notifications can be sent to the candidates (e.g., operating candidate computing entities 105) in the format they prefer (e.g., based on their messaging/notification preferences), which may be via email, SMS message/notification, MMS message/notification, social media message/notification, voice message/notification, notification via the candidate application, and/or any other communication format. In one embodiment, such invitations/messages/notifications can be sent as SMS messages/notifications. In this example, a simultaneous image of a cell phone screen (element 61 of FIG. 10018) can be shown with a preview of how the invitation will be presented to the candidate (e.g., operating a candidate computing entity 105). In one embodiment, the preview displayed to the customer/employer via the cell phone screen can change as the customer/employer (e.g., operating a customer/employer computing entity 110) makes changes to the invitation details. The customer/employer may be charged per invitation sent or only when a candidate is hired. As will be recognized, a variety of other approaches and techniques can be used to adapt to various needs and circumstances.

In one embodiment, the screen, display, page, or interface may also include a “Post Your Ad” section where the customer/employer (e.g., operating a customer/employer computing entity 110) can check a checkbox (element 63) or otherwise indicate that he or she wants to post the opportunity as a work/job advertisement on the Internet or via some other medium (Blocks 9, 10, and 11 of FIG. 10003A). To do so, the customer/employer (e.g., operating a customer/employer computing entity 110) can simply select the default advertisement the management computing entity 100 creates or select an “Edit Ad” (element 62 of FIG. 10018) button to change how the advertisement appears. In one embodiment, if the customer/employer (e.g., operating a customer/employer computing entity 110) does not check the option to post the job, the management computing entity 100 can post an anonymous work/job advertisement on external work/job sites (Block 24 of FIG. 10003C), which will not provide the customer's name or other details (Blocks 10 and 12 of FIG. 10003A). For example, the anonymous posting may simply indicate the need for bartenders in the zip code 30309 or in Midtown Atlanta. Such an approach can be used to reach additional candidates who satisfy the needs of the customer/employer or others. Candidates (e.g., operating candidate computing entities 105) who respond to the anonymous advertisements are not necessarily distinguished from other candidates from the customer's perspective. If the customer/employer desires to edit the work/job advertisement, an Edit Ad page can be presented or provided to the customer/employer (e.g., operating a customer/employer computing entity 110) (e.g., FIGS. 10019 and 10061-10066). The management computing entity 100 can then use a mail-merge type approach to create/generate advertisement text based on the criteria the customer/employer entered for the work/job/opening/position. The customer/employer can also edit the text as desired.

In one embodiment, another step of the Contacting process may include prompting the customer/employer (e.g., operating a customer/employer computing entity 110) for the Next Steps if a candidate who is sent an invitation is interested in the corresponding opportunity/job opening (e.g., FIGS. 10020-10021 and 10067-10070). Available Next Steps may include (with or without the assistance of the management computing entity 100) calling the candidate for an interview, scheduling an interview, answering questions, conducting a video interview, providing an online test, storing or sending the information/data to an applicant tracking system, and/or the like. Through the management computing entity 100, customers/employers can indicate as many qualification steps as desired (or even that no steps are required), all of which can be set as the default qualification process for their vending machine, campaign, search, pipeline, or folder. These steps can be executed by the management computing entity 100 (Block 32 of FIG. 10003C) if a candidate responds indicating that he or she is interested (Block 26 of FIG. 10003C) in the job.

In one embodiment, if the specified step is call for an interview, the communication with the parties can be bi-directional, e.g., the option can indicate that the candidate should call the customer/employer or indicate that the customer/employer will call the candidate. In an embodiment in which the customer/employer wants the candidate to call him or her (shown above), the customer/employer (e.g., operating a customer/employer computing entity 110) simply enter the contact name, phone number, and a preferred time, and the management computing entity 100 can provide the same to the candidate (e.g., operating a candidate computing entity 105). If the customer/employer would prefer to call the candidate, once a candidate has indicated interest in the role/position (and become an applicant), the management computing entity 100 can provide a follow-up notification to the candidate (e.g., operating a candidate computing entity 105) indicating that the contact details have been forwarded to the customer/employer (name disclosed) and that the candidate should be contacted within a configurable time frame, for example (specified as a parameter). The customer/employer (e.g., operating a customer/employer computing entity 110) can receive a notification with the contact details of the work/job candidate (who may also be referred to herein now as an applicant).

In one embodiment, if the specified step is “Schedule Interview,” the customer/employer (e.g., operating a customer/employer computing entity 110) can be presented with a dialog screen (e.g., FIG. 10024) that allows the customer/employer to configure a set of interview “slots” that the candidates can self-book. This functionality supports 1-on-1 interview slots and allows multiple candidates to be booked into a specific slot.

Once the Next Steps preference is set/input, the customer/employer (e.g., operating a customer/employer computing entity 110) can select a button (element 64 of FIG. 10021) to initiate/trigger contacting the candidates by the management computing entity 100. Any candidates in the Favorites/Waiting list (Block 19 of FIG. 10003C) or Maybe list (Block 22 of FIG. 10003C) are not considered by the management computing entity 100 for contacting unless/until the customer/employer (e.g., operating a customer/employer computing entity 110) decides to change the candidate to a Yes (Block 21 of FIG. 10003C). However, the management computing entity 100 can store all identified candidate profiles (e.g., using flags for instance) in the corresponding vending machine, campaign, search, pipeline, or folder—regardless of whether indicated as a Yes, No, or Maybe (Blocks 20, 21, 22, and 23 of FIG. 10003C). Further, once a customer's messages/notifications have been transmitted to the selected candidates, the management computing entity 100 classifies the candidates as Contacted (Block 25 of FIG. 10003C), and they can be viewed by selecting the Contacted tab (element 37 of FIG. 10004) from the dropdown menu. In one embodiment, candidates who have been contacted/notified by the management computing entity 100 via SMS or MMS, for example, can simply respond to the same with a “Y” or “Yes” to indicate their interest in the position or an “N” or “No” to indicate their lack of interest. The management computing entity 100 can automatically indicate/associate the candidate profiles for the candidates who have responded “Yes” as being associated with the Short list. Similarly, the management computing entity 100 can automatically indicate/associate the candidate profiles for the candidates who have responded “No” as being associated with the Closed list. Candidates operating older computing entities may be allowed to respond with numbers such as “1” for yes and “2” for no. Additional options could include responding “3” to decline all jobs from this customer/employer and “4” to indicate the message/notification should be considered “spam.” And candidates who have not responded may be considered as waiting (Block 27 of FIG. 10003C). As will be recognized, a variety of other approaches and techniques can be used to adapt to various needs and circumstances. In one embodiment, the management computing entity 100 can classify any candidates who decline the work/job offer (Block 29 of FIG. 10003C) as Declined for this vending machine, campaign, search, pipeline, or folder.

In one embodiment, if a candidate indicates interest in a particular work/job (Block 26 of FIG. 1003), the candidate is then put through any qualification steps (Block 28 of FIG. 1003) defined by the customer/employer user (with or without the assistance of the management computing entity 100). If candidate fails the qualification, the management computing entity 100 can automatically indicate/associate the candidate as Rejected (element 33 of FIG. 10003C). Otherwise, the management computing entity 100 can automatically indicate/associate the candidate as a Qualified Applicant (Block 30 of FIG. 10003C). The customer/employer (e.g., operating a customer/employer computing entity 110) then has an opportunity to move any Qualified Applicants to a Short list (Block 31 of FIG. 10003C) or from a parked list (Block 34 of FIG. 10004) to a Short list.

### Automatic Contacting

In one embodiment, in addition to allowing the customer/employer to contact candidates manually as described above under Contacting Screen, the management computing entity 100 can also allow customers/employers to contact candidates automatically. In this example, for a given vending machine, campaign, search, pipeline, or folder, the customer/employer (e.g., operating a customer/employer computing entity 110) can indicate that any matching candidates should be contacted automatically (e.g., sent invitations/messages/notifications automatically by the management computing entity 100). To do so, the customer/employer (e.g., operating a customer/employer computing entity 110) can set contacting preferences and provide for customized messages/notifications to be presented or provided to candidates, just as they are able to do so in the manual/one-time contact approach. In one embodiment, the customer/employer (e.g., operating a customer/employer computing entity 110) can indicate a maximum number of additional candidates to contact per a configurable time period, a maximum amount to spend per configurable time period overall, or a maximum amount to spend per candidate, and/or the like—including other ceilings and caps that reflect the on-going market dynamics of a live marketplace.

In one embodiment, to access the auto-contacting agent of the management computing entity 100, the customer/employer (e.g., operating a customer/employer computing entity 110) can select the “Save” button (element 57) when viewing candidate search results, campaigns, or pipelines. The customer/employer computing entity 110 can then present or provide a “Folder Settings” dialog box (e.g., FIG. 10026). In one embodiment, if the “Smart Folder” setting is set to “Yes,” the customer/employer (e.g., operating a customer/employer computing entity 110) can select how frequently and/or when the agent should be run, such as regularly (e.g., hourly, daily, weekly), continuously, and/or in response to certain triggers (e.g., when ten new candidates are identified). The customer/employer (e.g., operating a customer/employer computing entity 110) can also indicate various actions to be taken, such as emailing the candidate list to customer/employer or contacting the candidates automatically with a template (e.g., FIG. 10027). In one embodiment, if “Email New Candidates” is selected by the customer/employer (e.g., operating a customer/employer computing entity 110), the customer/employer computing entity 110 (in communication with the management computing entity 100) can prompt the customer/employer for the email address to which the candidate list should be sent. As will be recognized, a variety of different techniques and approaches can be used to adapt to various needs and circumstances.

In one embodiment, if “Edit Candidate Invitation” is selected by the customer/employer (e.g., operating a customer/employer computing entity 110), the customer/employer can edit the template of the message/notification to be sent to candidates (e.g., FIG. 10028). In doing so, the customer/employer (e.g., operating a customer/employer computing entity 110) can be taken through the messaging/notification template setup process (as coordinated by the management computing entity 100, for example), which prompts them to describe the opportunity (e.g., FIGS. 10029-10042 and 10061-10070). Through the messaging/notification template process, the customer/employer (e.g., operating a customer/employer computing entity 110) may be able to provide an introductory statement about the customer's organization (e.g., FIG. 10030) and provide a link to the customer's web site (e.g., FIG. 10030), for example. In another embodiment, the customer/employer (e.g., operating a customer/employer computing entity 110) may be able to provide information/data that can be used by the management computing entity 100 to create/generate a webpage with the customer's information/data (e.g., for customers/employers without websites) (e.g., FIG. 10031). In one embodiment, the customer/employer (e.g., operating a customer/employer computing entity 110) can also indicate a personal note to be provided to the candidates (e.g., FIG. 10032).

In one embodiment, when the management computing entity 100 automatically contacts candidates by text message/notification, the management computing entity 100 can provide a link in the messages/notifications that provides access to view details about the job. As will be recognized, such a link may open a webpage, window, and/or the like (e.g., FIG. 10033). As will be recognized, a variety of other approaches and techniques can be used to adapt to various needs and circumstances.

In one embodiment, the customer/employer (e.g., operating a customer/employer computing entity 110) can indicate the action that will occur if the candidate (e.g., operating a candidate computing entity 105) indicates he or she is interested in the position (e.g., FIG. 10034). For example, if the customer/employer (e.g., operating a customer/employer computing entity 110) selects “Call for Interview,” the customer/employer (e.g., operating a customer/employer computing entity 110) is prompted for additional details about the interview appointment, which may include the identity of the customer/employer (such as the hiring manager) and the purpose of the call (e.g., FIG. 10035). That is, the customer/employer (e.g., operating a customer/employer computing entity 110) may have the option of indicating the purpose of the call, including arranging an in-person interview and doing an actual interview over the phone (e.g., FIG. 10036). The customer/employer (e.g., operating a customer/employer computing entity 110) can also indicate that the candidate should call the customer/employer (such as the hiring manager) or that the customer/employer (such as the hiring manager) will call the candidate (e.g., FIG. 10037). Alternatively, the customer/employer (e.g., operating a customer/employer computing entity 110) can use the management computing entity 100 to schedule an interview with the candidate by selecting “Schedule an Interview” from the “Action” drop-down (e.g., FIG. 10038). This may be used by the customer/employer (e.g., operating a customer/employer computing entity 110) to indicate the preference of a phone interview or an in-person interview (e.g., FIG. 10039). Additionally or alternatively, the customer/employer (e.g., operating a customer/employer computing entity 110) can simply choose “Send a Message” as the next action step (e.g., FIG. 10040).

In one embodiment, once the template has been configured, the customer/employer (e.g., operating a customer/employer computing entity 110 in communication with the management computing entity 100) may be prompted to confirm the details on a confirmation screen (e.g., FIG. 10041). Then, the management computing entity 100 can give the customer/employer (e.g., operating a customer/employer computing entity 110 in communication with the management computing entity 100) the option to save/store the template that was changed, or to save/store it as a new template name (e.g., FIGS. 10016, 10042, 10057-10058 and 10060). In one embodiment, candidates who have been contacted/notified by the management computing entity 100 can respond as described above. And as described, the customer/employer may be charged per invitation sent or only when a candidate is hired. As will be recognized, a variety of other approaches and techniques can be used to adapt to various needs and circumstances.

### Returning to a Saved/Stored Vending Machine, Campaign, Search, Pipeline, or Folder

After a vending machine, campaign, search, pipeline, or folder has been saved, the customer/employer (e.g., operating a customer/employer computing entity 110 in communication with the management computing entity 100) can return to the corresponding vending machine, campaign, search, pipeline, or folder (e.g., FIG. 10025) and view any vending machine, campaign, search, pipeline, or folder by selecting a “Manage” button (element 65 of FIG. 10022). In one embodiment, this may direct the customer/employer (e.g., operating a customer/employer computing entity 110) to the vending machine, campaign, search, pipeline, or folder to see candidates who have contacted, candidates who have been placed in the customer's Apply Inbox list, Database list, Favorite/Waiting list, Short list, Closed list, and/or the like. Or the customer/employer (e.g., operating a customer/employer computing entity 110) contact additional candidates by returning to the Search Results page/area, which may default to the last filter criteria they used. By returning to the Search Results page/area, in one embodiment, the management computing entity 100 may simply provide the previous search results. However, in another embodiment, the management computing entity 100 may perform a new search based on the saved/stored search criteria, which may alter the search results by identifying new candidates and/or removing previous candidates (based on freshness or other criteria, e.g., active candidates). In one embodiment this can be used to update a vending machine, campaign, search, pipeline, or folder.

In one embodiment, the management computing entity 100 can provide regular, periodic, or continual supply of candidates for any vending machine, campaign, search, pipeline, or folder such that new candidates (e.g., candidate profiles) can be automatically included in any active vending machines, campaigns, searches, pipelines, or folders. Accordingly, vending machines, campaigns, searches, pipelines, or folders can be considered active or inactive. In one embodiment, the management computing entity 100 can perform this function as the customer/employer (e.g., operating a customer/employer computing entity 110) is accessing a vending machine, campaign, search, pipeline, or folder, e.g., by filtering or contacting candidates. In this embodiment, the management computing entity 100 can provide new candidates to the vending machine, campaign, search, pipeline, or folder for the customer/employer to review. Thus, whenever the customer/employer (e.g., operating a customer/employer computing entity 110) returns to the vending machine, campaign, search, pipeline, or folder, the customer/employer can see any new relevant candidates. In another embodiment, the customer/employer (e.g., operating a customer/employer computing entity 110) does not need to return to the vending machine, campaign, search, pipeline, or folder. For example, the management computing entity 100 can automatically provide a list (e.g., email) of new candidates to the customer/employer (e.g., customer/employer computing entity 110). The customer/employer can then review the list and take any appropriate actions. Similarly, an auto-contacting agent of the management computing entity 100 can automatically contact any candidates matching specific criteria (e.g., send/transmit/provide invitations/messages/notifications automatically)—as described in greater detail below

In one embodiment, having a fresh supply of the types of candidates a customer/employer regularly recruits means that the customer/employer can always have access to and/or be presented with up-to-date results (e.g., candidates who are currently interested in in employment opportunities and who meet the saved/stored search criteria) for the same or similar positions in the future. That is, the candidates are actively interested in employment opportunities.

### Demand Driven Advertising

In one embodiment, to provide a continuous supply of qualified, interested, and available candidates, the management computing entity 100 can automatically deploy recruitment advertising campaigns (Block 16 of FIG. 10003B). By identifying qualified, interested, and available candidates, the management computing entity 100 can create/generate a double match between customers/employers and candidates. That is, not only do the candidates have to meet the criteria required by the customers, but the candidates must be interested in the jobs the customers/employers have available and be available to work when the customers/employers desire (e.g., be fresh or active).

### Passive Database Stocking

Various embodiments may provide the benefit of not only identifying candidates who satisfy a customer's specific criteria, but candidates who have recently affirmed they are seeking a new position. To do so, in one embodiment, the management computing entity 100 can be in communication or associated with a constant candidate source of new work/job candidates. This may be through a resume builder service, such as LiveCareer's web-based service that offers work/job seekers an opportunity to create/generate or improve a resume via the Internet. This flow of candidates to the management computing entity 100 from the resume builder service can provide a conduit for passively “stocking” vending machines, campaigns, searches, pipelines, or folders with candidates who are actively looking for new positions (e.g., FIGS. 10082-10097).

### Active Database Stocking

In one embodiment, active database stocking by the management computing entity 100 can be triggered in a number of ways, such as when there are indications that demand is increasing beyond current supply levels (Blocks 14, 15, 16, 17, and 18 of FIG. 10003B); when the current supply of candidates for a campaign, geographic area (e.g., country, state, province, county, city, postal code, area code, zip code, geofence, school district, voting district, commute distance (e.g., acceptable range), commute time (e.g., acceptable range), and/or the like), and/or occupation/position satisfies (e.g., is at or below) a configurable threshold; and/or the like. Such determinations/identifications can be performed by a variety of computing entities, including management computing entity 100. For example, if the management computing entity 100 determines that the number of bartender candidates for zip code 30309 falls below (e.g., does not satisfy) 40 candidates, the management computing entity 100 can initiate active database stocking. In another example, if the number of cashier candidates for a Taco Bell campaign in Tampa, Fla., falls below (e.g., does not satisfy) 8, the management computing entity 100 can initiate active database stocking. The management computing entity 100 can also initiate/trigger active database stocking in response to a customer-initiated advertising request/campaign (Block 13 of FIG. 10003B). Such a request may be the result of a customer's vending machine, campaign, search, pipeline, or folder for candidates having insufficient candidates available (e.g., being below a 100 candidates). As will be recognized, a variety of other approaches and techniques can be used to adapt to various needs and circumstances.

In one embodiment, the customer/employer (e.g., operating a customer/employer computing entity 110) can elect to initiate/trigger an advertising request/campaign (Blocks 4 and 5 of FIG. 10003A). In another embodiment, the management computing entity 100 can initiate/trigger active database stocking based on customer/employer searching activity, for instance. To do so, the management computing entity 100 may analyze customer/employer searching activity (e.g., specific customers, groups of customers, and/or all customers) to identify an increase in the number of general searches on a given occupation/job/position, for example, or an increase in the number of searches for specific candidate criteria. The management computing entity 100 may determine whether the searches meet or exceed a given threshold (e.g., optimal or configurable) or whether a trend is apparent or emerging. As will be recognized, a variety of other approaches and techniques can be used to adapt to various needs and circumstances.

In one embodiment, if the management computing entity 100 sends out invitations/messages/notifications on behalf of a customer, the management computing entity 100 may trigger active database stocking (element 16) if the number of candidates matching the search that led to those invitations/messages/notifications being sent out falls below (e.g., does not satisfy) a configurable threshold (e.g., optimal or configurable) at which profit can be expected to be maximized. For example, the management computing entity 100 can monitor searches where the customer/employer sent out invitations/messages/notifications within some configurable timeframe. The management computing entity 100 can determine a desired timeframe by business logic that predicts the likelihood of the customer/employer (e.g., operating a customer/employer computing entity 110) accessing the management computing entity 100 later to send/transmit/provide out additional invitations/messages/notifications. Or the timeframe may simply be configured by a system administrator of the management computing entity 100. In one embodiment, a definitive indication that more invitations/messages/notifications may be desired may be if the customer/employer (e.g., operating a customer/employer computing entity 110) has configured an Automatic Contact Agent (e.g., through the management computing entity 100), as previously described. For instance, the Automatic Contact Agent (e.g., through the management computing entity 100) may be configured to contact a certain number of matching candidates per day, which would provide a specific indicator of future customer/employer demand.

In one embodiment, whether active database stocking is triggered may also depend on whether the number of candidates matching the recent vending machine, campaign, search, pipeline, or folder is at or has fallen below a configurable threshold (e.g., optimal or configurable) at which profit can be expected to be maximized (or for other reasons), which may be a multiple of the number of invitations/messages/notifications that have been sent out on the customer's behalf by the management computing entity 100. The particular multiple may depend on the position and predicted profitability of the advertising that would be run, for example. In another embodiment, the management computing entity 100 may execute an algorithm of predictive analytics to determine that active database stocking should be triggered. As will be recognized, a variety of other approaches and techniques can be used to adapt to various needs and circumstances.

In one embodiment, if the management computing entity 100 determines that the quantity of candidates in a given geographic area with a given skillset falls below (e.g., does not satisfy) a configurable threshold (e.g., optimal or configurable) at which expected profit can be maximized (Block 18 of FIG. 10003B), the management computing entity 100 may initiate/trigger active database stocking. To do so, the management computing entity 100 can regularly, periodically, continuously, or in response to certain triggers scan the candidate database to determine the minimum multiple of candidates to whom invitations/messages/notifications have been sent for a given type in a given geographic area. Then, if the multiple of candidates falls below (e.g., does not satisfy) that determined minimum, the management computing entity 100 can initiate/trigger active database stocking (e.g., based on profitability). Or, the management computing entity 100 may execute an algorithm using predictive analytics to determine that active database stocking should be triggered.

### Sourcing Mechanisms for Database Stocking

In one embodiment, the management computing entity 100 can use various sources of candidates for active database stocking. The candidate sources may be work/job board postings, message/notification board postings, search engines, websites, radio programs, television programs, magazines blogs, newspaper websites, aggregation websites, and/or the like. In one embodiment, for each candidate source, the management computing entity 100 can specify criteria regarding the circumstances in which the candidate source should be used. Such criteria may include the urgency of the sourcing request, how many candidates are needed, the type of opening/position, the geographic area, the average acquisition costs of a candidate using this sourcing method, and/or the like.

In one embodiment, the management computing entity 100 can determine what candidate sources to use for a given occupation/position, geographic area, campaign or pipeline, customer/employer, program, and/or the like to determine using sourcing/stocking templates. A sourcing or stocking can indicate the candidate sources the management computing entity 100 can use to candidate source candidates and/or the distribution of the candidate sources to be used. For example, a sourcing/stocking template may indicate that for a bartender position in Midtown Atlanta, candidates should be sourced using 20% of the postings on Indeed.com, 30% of the postings on CareerBuilder.com, and 50% on Google.com. Moreover, the sourcing/stocking template can define a posting schedule. The posting schedule may indicate the number of times, for example, and the frequency the management computing entity 100 is to post or advertise for an occupation/position via one or more candidate sources. For instance, a posting schedule for a sourcing/stocking template may indicate that for a bartender position in Midtown Atlanta, the management computing entity 100 is to post four craigslist postings for the occupation/position the first week and two postings thereafter for six weeks. Similarly, the posting schedule may indicate that the management computing entity 100 is also to advertise the position every thirty days on CareerBuilder.com for two months. The posting schedules can be hourly, daily, weekly, biweekly, monthly, and/or the like. The management computing entity 100 can automatically semi-automatically initiate or provide the postings/advertisements using application programming interfaces (APIs) to the corresponding candidate source computing entities. To do so, the management computing entity 100 can provide the appropriate candidate sources (e.g., candidate source computing entities) with the relevant information/data for the electronic posting, advertisement, and similar words used herein interchangeably.

In one embodiment, the management computing entity 100 can automatically or otherwise update and modify sourcing/stocking templates. For example, for a given template, the management computing entity 100 can determine/identify the effectiveness of a given source (e.g., postings on Craigslist.com and Google.com). To do so, the management computing entity 100 can receive information/data from the various candidate sources (e.g., candidate source computing entities) associated with postings/advertisements and determine/identify the number of impressions (e.g., user views) for each electronic posting/advertisement. The management computing entity 100 can receive this information/data regularly, periodically, continuously, and/or in response to certain triggers. An impression may be the number of times the electronic posting/advertisement is returned as a result in a user's search. The management computing entity can also determine/identify the number of clicks, selections, and/or similar words used herein interchangeably based on the electronic posting/advertisement (e.g., user selections of the electronic posting/advertisement), the number of candidates sources as a result of the electronic posting/advertisement, the cost-per-click, the cost-per-candidate, and/or the like. The management computing entity 100 can then modify the sourcing/stocking templates for optimization. For instance, if the response rate (e.g., number of clicks/number of impressions, number of candidates sourced/number of impressions, number of candidates sourced/number of clicks) satisfies (e.g., is at or below) a configurable threshold, the management computing entity can automatically modify the sourcing/stocking template (e.g., to reduce the postings via the less effective candidate sources and to increase the posting via the effective candidate sources).

In one embodiment, for pay-per-click candidate sources, the management computing entity 100 may implement logic to translate a given need (e.g., Waiters in Chicago) to keywords (e.g., “chicago waiters”) and corresponding advertising bid strategies. The rules for such logic may be generalized across a particular work/job type, geographic area, and/or the like. Moreover, the rules for such logic may define keywords to include, keywords to exclude, negative keywords to add, and/or the like to the pay-per-click keyword criteria. Such rules may also define how corresponding postings/advertisements should be worded, displayed, and/or the like. For example, specific electronic posting/advertisement text copies/templates may be specified for given circumstances of positions and geographic areas. In one embodiment, the default behavior may be for multiple advertisement copies/templates to be used by the management computing entity 100 for any given position and geographic combination, where defined rules would then improve the electronic posting/advertisement template over time based on how well the electronic posting/advertisement performs with respect to its return on investment. For instance, information/data about how many openings are expected to be filled in the electronic posting/advertisement template may be included, such as “Now hiring 50 waiters in Chicago,” which can be used by the management computing entity 100 to determine if greater electronic posting/advertisement specificity results in greater electronic posting/advertisement performance (e.g., whether the click-through rate increases with advertisement specificity). Further, such rules may define video-based or image-based postings/advertisements to associate with given positions and/or geographic combinations. As will be recognized, a variety of other approaches and techniques can be used to adapt to various needs and circumstances, such as the management computing entity comparing various advertisement copies/templates, media, candidate sources, geographic areas, occupations/jobs/positions, and/or the like to identify the greatest advertisement performance

In one embodiment, the management computing entity 100 can track or monitor the performance of each candidate source (e.g., website, search engine, and/or the like) by geography, position type, and/or the like. This may allow the management computing entity 100 to generate and/or provide reports regarding which candidate sources are more or less cost effective.

In one embodiment, for a given position with a particular set of skills, the management computing entity 100 can initiate advertising varying levels of details. For example, a posting or an advertisement that is very specific about a position/opening may have a lower response rate from candidates and higher cost-per-click. However, because the electronic posting/advertisement is more targeted, it might be more cost effective at generating the specific types of candidates needed. Further, the management computing entity 100 can use analytics to evaluate both approaches, and depending on prior performance for a given position or category of positions, the management computing entity 100 may indicate which approach is recommended for a given circumstance. The management computing entity 100 may also implement rules defined by an administrator to require the management computing entity 100 to use a given approach regarding the level of detail be used in an advertisement. In various embodiments, the management computing entity 100 can provide administrators with reports to review the performance of any of the candidate sources to determine whether better efficiency or optimization is possible through improved rules.

In one embodiment, after viewing an electronic posting/advertisement, a potential candidate (e.g., operating a candidate computing entity 105) may select the electronic posting/advertisement and be directed to a screen, page, interface, or application in communication with the management computing entity 100 through which the candidate (e.g., operating a candidate computing entity 105) can create/generate a candidate profile. By creating the candidate profile as described above, the candidate may be considered by customers/employers for positions that match the candidate's profile. This process is similar to that as described above. As will be recognized, a variety of other approaches and techniques can be used to adapt to various needs and circumstances.

### Passing Costs on to Customers

In one embodiment, a customer/employer who needs to fill a difficult-to-fill position may be willing to pay a premium price for the service. In one embodiment, the fact that the customer/employer is willing to pay a premium can be factored into the rules executed by the management computing entity 100 for making sourcing determinations. For example, the management computing entity 100 might trigger a rule to use pay-per-click advertising or to bid a higher amount for traffic for customers/employers paying a premium than for customers/employers who are not paying or are not willing to pay a premium. In various embodiments, this may provide greater flexibility in the control of the types of advertisements used.

Similarly, the management computing entity 100 may set prices for using advertisements based on supply and demand. As will be recognized, a variety of other approaches and techniques can be used to adapt to various needs and circumstances.

Payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, BlueTooth low energy (BLE), and various other contactless payment systems. Further, such payment technologies may include PayPal Beacon, Booker, Erply, Leaf, Leapset, Micros, PayPal Here, Revel, ShopKeep, TouchBistro, Vend, and/or the like.

### Initiating and Suspending Active Database Stocking

In one embodiment, it may be useful to provide mechanisms for determining whether advertising campaigns should be initiated, reinitiated, and/or suspended. In one embodiment, the management computing entity 100 can initiate, reinitiate, and/or suspend advertising campaigns based on optimal and/or configurable thresholds regarding the number of candidates for a given occupation/job/position and/or geographic area. In one embodiment, the management computing entity 100 can automatically determine optimal thresholds based on profit indicators. For example, the management computing entity 100 can determine an optimal threshold using a given level of profitability and a number of candidates of an occupation/job/position compared to a number of invitations/messages/notifications being sent. In this example, if there is a given level of profitability for a number of candidates of an occupation/job/position compared to a number of invitations/messages/notifications being sent (e.g., optimal threshold), and profitability and the number of candidates in the occupation/job/position both decrease (e.g., drops below the optimal threshold), the management computing entity 100 can make such a determination and initiate or reinitiate an advertising campaign to increase profitability (e.g., by increasing the number of candidates to whom invitations/messages/notifications can be sent). In another embodiment, the management computing entity can initiate or reinitiate and advertising campaign when the number of candidates for a given occupation/job/position and/or geographic area falls below (e.g., does not satisfy) a configurable threshold (e.g., set by an administrator). Similarly, the management computing entity 100 may suspend an advertising campaign for a position or occupation/job/position in a geographic area, for example, when a configurable or optimal threshold of candidates is met or exceeded. For example, as previously described, after viewing an advertisement, a candidate (e.g., operating a candidate computing entity 105) may select the advertisement and be directed to a screen, page, interface, or application in communication with the management computing entity 100 through which the candidate (e.g., operating a candidate computing entity 105) can create/generate a candidate profile. By creating the candidate profile in a candidate database as described above, the candidate may be considered by customers/employers for positions that match the candidate's profile, which actively increases or stocks the pool of candidates from which customers/employers can view and/or select candidates: “active database stocking.” Thus, when the pool of candidates for a given occupation/job/position meets or exceeds or falls below (e.g., does not satisfy) a given threshold (e.g., optimal or configurable), the management computing entity 100 can suspend the advertising campaign and/or reinitiate it on an as needed basis.

Additionally or alternatively, the management computing entity 100 can initiate or suspend advertising campaigns based on price information. For example, if pay-per-click advertising through a given candidate source (e.g., website, search engine, and/or the like) meets or exceeds an optimal threshold (e.g., the cost has become too expensive), the management computing entity 100 can suspend pay-per-click advertisements for that candidate source (e.g., website, search engine, and/or the like). Similarly, if the pay-per-click advertising falls below (e.g., does not satisfy) an optimal and/or a configurable threshold, the management computing entity 100 can reinitiate pay-per-click advertisements for that candidate source (e.g., website, search engine, and/or the like).

Additionally or alternatively, the management computing entity 100 can initiate or suspend advertising campaigns based on other thresholds (e.g., optimal or configurable), such as when the total cost-per-advertising-campaign meets or exceeds a configurable threshold (e.g., optimal or configurable). For example, if a customer/employer (e.g., operating a customer/employer computing entity 110) provides a not-to-exceed budget for a total advertising campaign, the management computing entity 100 can suspend the advertising campaign when the budget is met or reaches a configurable threshold before the budget is met to reassess the effectiveness of the advertising campaign.

In one embodiment, the management computing entity 100 can determine when the cost-per-candidate meets or exceeds a configurable threshold (e.g., optimal or configurable) and suspend advertising campaigns when the cost-per-candidate meets or exceeds the configurable threshold (e.g., optimal or configurable). To do so, the management computing entity 100 can receive information/data from the various candidate sources (e.g., candidate source computing entities) associated with postings/advertisements. The management computing entity 100 can receive this information/data regularly, periodically, continuously, and/or in response to certain triggers. And the management computing entity 100 can determine when the cost-per-candidate falls below (e.g., does not satisfy) the configurable threshold (e.g., optimal or configurable) and reinitiate advertising campaigns accordingly. To do so, the management computing entity 100 can analyze any current or past advertising campaigns and determine the cost-per-candidate of reaching each type of candidate (e.g., occupation/job/position) based on advertising response rates (e.g., number of candidate profiles created/generated as a result of the advertising), costs for advertising, and/or the like. The management computing entity 100 can then store the cost information/data in a cost table. With the cost table, the management computing entity 100 can make cost-per-candidate determinations based on the cost table as well as analyzing recent history and taking into account current advertising market conditions and trends occurring because of seasonality. This allows for customers/employers to control the costs of their advertising campaigns at the candidate level. For example, if the historical average cost-per-candidate for a nurse is $20, and a particular candidate source is reaching nurse candidates at a cost-per-candidate of $22, the management computing entity 100 may suspend advertising for the candidate source in favor of a candidate source where candidates are being reached at a cost-per-candidate of $18.

In one embodiment, the management computing entity 100 can identify each position or occupation/job/position for each geographic area and determine how much, if any, additional revenue can be generated if more candidates were added to the candidate database beyond the current rate of candidates being added passively. Various revenue flows can be included to arrive at a total incremental revenue flow figure. For instance, the management computing entity 100 can make such determinations based on the expected additional revenue from an expected number of invitations/messages/notifications that would be sent by a customer/employer initiating an advertising request/campaign for a position for which sufficient candidates were not found (e.g., through the survey presented when no or few candidates were returned in a search or when the customer/employer quit a search page/results before selecting any candidates), reduced by the expected risk that the customer/employer might not send/transmit/provide the expected number of invitations/messages/notifications. Further, such a determination by the management computing entity 100 may be based on the expected additional revenue from invitations/messages/notifications sent by a customer/employer who historically sends invitations/messages/notifications to the occupation/job/position and geography combination being considered, where the invitations/messages/notifications sent per multiple of available candidates is computed, but is limited by the likely maximum invitations/messages/notifications that would be sent by these customers/employers given a sufficient supply of candidates. For example, if the management computing entity 100 determines that historically, 100 invitations/messages/notifications are sent to nurses in Chicago each month, and that historically there are 10 nurses available for each invitation sent, but in the current month, at the rate invitations/messages/notifications are being sent, only 80 would be sent in the month, and that the number of nurses available for each invitation sent in the current month is less than 10, that would be an indication that revenue would likely increase if more nurses in Chicago were added as determined by the management computing entity 100.

Additionally or alternatively, an administrator may input a revenue amount for a given occupation/job/position and/or geographic area for use by the management computing entity 100. This may be because the administrator wants to override the management computing entity's 100 revenue expectation determination based on various factors. Such factors may include customer/employer commitments to send/transmit/provide a minimum number of invitations/messages/notifications or a premium recruiting fee manually billed to the customer/employer that might not be considered by the management computing entity 100. The amount provided by the administrator may represent a dollar amount of advertising budget that can be expended and a time period during which the budget can be spent, for example. The premium recruiting fee amount may be used to reach an occupation/job/position and geographic area expressly entered by a customer/employer (e.g., operating a customer/employer computing entity 110). In one embodiment, for certain customers, occupations/jobs/positions, and/or geographic areas, the management computing entity 100 may be configured to allow for a loss on a given advertising campaign. For example, an administrator of the management computing entity 100 may make such an allowance for a certain level of advertising expenditure at a loss. For example, a decision to run advertising that would not normally be expected to be profitable may depend on the volume of other invitations/messages/notifications the customer/employer sends, how long the customer/employer has been a customer, and how frequently the customer/employer requests that invitations/messages/notifications be sent out for the position.

In one embodiment, the management computing entity 100 can monitor or scan the available candidate sources that reach the types of candidates for which incremental revenue is expected or for which an amount of advertising expenditure can be allowed based at least in part of the previously-described determinations (e.g., determining how much, if any, additional revenue can be generated if more candidates were added beyond the current rate of candidates being added passively). In such an embodiment, each candidate source (e.g., website, search engine, and/or the like) may have an initial estimated cost-per-candidate for reaching candidates of specific occupations/jobs/positions and/or in specific geographic areas. Thus, the management computing entity 100 can determine the current expected cost for the candidate source (e.g., website, search engine, and/or the like) based on the estimated expectation and any historical results that have been recorded using the cost table.

In one embodiment, the management computing entity 100 can also determine which medium of advertising (e.g., forms or types of advertising, such as banner, video, audio, advertisements on websites, and/or the like) would be the most profitable or generate the least loss per candidate acquired on which to deploy advertisements to reach the target candidates (e.g., candidates who have the desired qualifications). The management computing entity 100 may make such determinations by subtracting the expected cost from the expected revenue. As will be recognized, an candidate source could be used to target more than one occupation/job/position, if the occupations/jobs/positions are set as being able to be combined and/or the candidate source (e.g., website, search engine, and/or the like) is expected to be profitable to reach the candidates for the occupations types.

In one embodiment, the management computing entity 100 can also determine an overall maximum budget per configurable time period (e.g., per day) for reaching the targeted candidates in each target segment. For each candidate source (e.g., website, search engine, and/or the like), for example, the management computing entity 100 can determine and set a daily budget limit. The most profitable, viable candidate source should have its budget maximized, where the budget figure is not larger than the daily maximum for that candidate source and is not larger than the historical maximum budget that the candidate source has been able to spend in past campaigns. In one embodiment, the management computing entity 100 (or an administrator thereof) may set such budgets for each viable candidate source (e.g., website, search engine, and/or the like), starting with most profitable and continuing to the least profitable. As will be recognized, such budget allocations may be suspended or terminated once the sum of allocated budgets reaches the overall maximum budget per configurable time period (e.g., per day).

In one embodiment, for each candidate source being targeted, the management computing entity 100 can execute rules defined by a system administrator, for example, to determine the types of advertisements (e.g., banner, video, audio, advertisements on websites, television advertisements, radio advertisements, and/or the like) to place for a given advertising campaign, customer, occupation/job/position, geographic area, and/or the like. For example, such rules may identify the posting/advertisement templates for occupations/jobs/positions and/or geographic area combinations. The rules for the posting/advertisement templates may also indicate the level of detail to include in the advertisements (e.g., attributes the customers/employers are seeking) based, for example, on the customer's search criteria. In one embodiment, in addition to placing text advertisements, the management computing entity 100 may also deploy full page/multi-page work/job advertisements, such as those displayed on work/job listing websites. As will be recognized, the rules can also be used to test various configurations of advertising content to be included in such full page/multi-page work/job advertisements. Additionally or alternatively, the rules may define what images are to be or can be used for banner (or other) advertisements for specific occupations/jobs/positions and/or geographic area combinations. Similarly, the rules may define what videos are to be or can be used for video and television advertisements for specific occupations/jobs/positions and/or geographic area combinations. The rules may define what audio tracks are to be or can be used for audio/radio advertising. As will be recognized, a variety of other approaches and techniques can be used to adapt to various needs and circumstances.

In one embodiment, the management computing entity 100 can execute rules that define criteria for leads to accept through self-run and/or third party lead exchange platforms. The rules may also define parameters for sending alerts/notifications to candidates (or other parties) who may be able to refer relevant friends/contacts/co-workers, for instance. For example, an intensive care nurse in Chicago may be able to refer friends/contacts/co-workers in the same field as potential candidates who may lead to the friends/contacts/co-workers creating candidate profiles as described above.

In one embodiment, the management computing entity 100 can execute rules for how many different variations of text, image, audio, and/or video advertisements can be run concurrently, serially, or in parallel for multivariate testing purposes. The rules may also define the keywords or negative keywords that can be used for specific occupations/jobs/positions and/or geographic area combinations. The rules may also define (a) the specific advertisement copies/templates for specific occupations/jobs/positions and/or geographic area combinations and/or (b) the priority of various text copy and image combinations. The rules may also define limits to advertisement text copies/templates, images, and videos that are to be or can be used for specific advertising media.

In one embodiment, the management computing entity 100 can execute rules that define additional specificity (if available) within the type of occupation/job/position being targeted. For example, if a customer/employer is seeking chefs with dessert experience, the management computing entity 100 can adapt the advertisement to attract chefs with dessert-making experience. And the rules may define demographic and geographic targeting rules for specific occupations/jobs/positions and/or geographic area combinations. As will be recognized, a variety of other approaches and techniques can be used to adapt to various needs and circumstances.

In one embodiment, after determining the candidate sources and types of advertisements to place for a given advertising campaign, customer, occupation/job/position, geographic area, and/or the like, the management computing entity 100 can determine the expected performance of the advertisements permitted by the rules based on an initial expectation input or provided by the administrator, for example, and any historical information/data on the advertisements' performance in current, other existing, or previous advertising campaigns to arrive at a set of advertisements to run for each candidate source (e.g., website, search engine, and/or the like). In one embodiment, based at least in part on the previously described, the management computing entity 100 can generate an output of the target criteria (such as keywords, demographic and geographic information), budget levels, advertisement copies/templates, advertisement media, and/or the like that it has identified as being optimal. The output may be, for example, to a database table for presentation via a report.

In one embodiment, as described above, the management computing entity 100 can initiate, suspend, and/or reinitiate any advertisement campaigns based on such analyses/determinations. As will be recognized, the management computing entity 100 can implement various techniques and approaches to programmatically control advertising deployments, such as via the Bing and Google AdWords APIs.

Further, in one embodiment, in advertising media and networks operated by third parties, media to target candidates may include a self-run advertising network in which the cost of reaching candidates on such a network may vary based on publisher demand for advertising inventory. For example, a self-run network in which publishers bid in a reverse auction may be used. In this example, a publisher may indicate a willingness to run advertisements that pay a certain minimum amount of money based on, for example, impressions of the advertisement, clicks, or some action to take place by the audience of the advertisements after clicking. In one embodiment, the management computing entity 100 can query such advertisement network systems to determine if there is any advertisement inventory available that reaches the desired demographic, occupation/job/position, and/or geographic area at the desired maximum cost.

In another embodiment, instead of deciding to run advertising based on a decrease in available candidates below a configurable and/or optimal threshold, the management computing entity 100 may trigger an advertising campaign based on targeting advertisement media that have generated the highest proportion of candidates who are selected by customers. Thus, this may favor advertising on media that produce candidates who customers/employers desire or select most frequently. Additional criteria may include favoring media that produce candidates who are responsive to inquiries from customers/employers and/or notifications from the management computing entity 100. As will be recognized, a variety of other approaches and techniques can be used to adapt to various needs and circumstances.

### Additional Media Types

In one embodiment, in addition to the media types described above (e.g., sources), the management computing entity 100 may make use of dynamic advertisement panels embedded in websites, “host-and-post” opt-in offers, and/or “soft landing” email.

In one embodiment, advertisement panels can be used to advertise dynamic advertising content. The advertisement panels can be placed on various websites on the Internet and be used to determine the advertisement content that should be displayed (e.g., inserted) via the advertisement panels on the fly. That is, the management computing entity 100 can dynamically determine the advertisement content that should be displayed via the advertisement panels on the fly or in real time in response to requests from candidate source computing entities. For example, when a user request a webpage or other information/data from a candidate source computing entity, the source computing entity can send a request for content for the dynamic advertising panel to the management computing entity 100. The dynamic advertisement content can be set to feature work/job openings that need to be filled based, for example, on demand determined by the management computing entity 100 through active database stocking. Then, the location of the potential candidates accessing a specific application, webpage/website, browser (e.g., displaying pages), user interface, and/or the like can be determined from their Internet Protocol (IP) addresses. In response, the management computing entity 100 can determine and provide the advertisement content (e.g., to the candidate source computing entity) for display via the advertisement panels based on the potential candidates' locations and/or the subject matter or content of the specific application, webpage/website, browser (e.g., displaying pages), user interface, and/or the like. For example, if a potential candidate in Chicago accesses a website for a cooking show, the management computing entity 100 can determine that an advertisement for cooking related occupations/jobs/positions in Chicago should be inserted into the advertisement panels for this potential candidate.

Additionally, the management computing entity 100 may also take into account cookie information/data that was previously stored about a website on a potential candidate's computer, such as a career or resume building website. In the case of a visitor who previously viewed a career or resume building website, the management computing entity 100 can determine potential occupations/jobs/positions of interest based on the occupations/jobs/positions the potential candidate viewed previously using the cookie. The management computing entity 100 can then insert the corresponding content in the advertisement panels for display. As will be recognized, a variety of other approaches and techniques can be used to adapt to various needs and circumstances.

In one embodiment, an advertisement in the form of an opt-in offer (commonly considered a “host and post” offer) may be displayed in the pathway of a website. Such an advertisement may retrieve information/data from the management computing entity 100 via active database stocking regarding the types of candidates for which needs exist in various geographic areas. In one embodiment, a website hosting the advertisement can pass advertisement information/data about the kind of candidate who may be viewing the advertisement, and if no relevant advertisement text is available as a result of a lack of need for that kind of candidate, the management computing entity 100 may suppress the advertisement or send an instruction to the candidate source computing entity 100 to suppress the advertisement.

In one embodiment, similar to on-site advertisements, advertisements may take the form of emails sent by the management computing entity 100 based on demand criteria. For example, various computing entities can retrieve information/data from the management computing entity 100 as to which types of candidates are in need for various geographic areas. Such computing entities may include a customer/employer computing entity 110 (e.g., executing an candidate/applicant tracking application) that uses the retrieved information/data regarding the types of candidates who are needed to trigger soft landing email responses to candidates whose skills are not needed by the customer, but whose skills and geographic area match what is needed by others (as indicated by the management computing entity's 100 active database stocking). Such soft landing emails may be used to inform candidates that the customer/employer does not currently have a need for someone with their background, but that jobs are available elsewhere. The emails may provide, for example, a website address through which the candidate can select to sign up (e.g., create/generate a candidate profile)—(e.g., FIGS. 10082-10097). In one implementation, the emails may be sent by a third party instead of being sent by the management computing entity 100.

### Additional Concepts

### Automatically Creating Work/Job Advertisements Based on Search Filter Settings

In one embodiment, the management computing entity 100 can automatically create, generate, and/or draft work/job advertisements using the filter criteria the customer/employer (e.g., operating a customer/employer computing entity 110) sets when searching through available candidates or establishes for a vending machine, campaign, search, pipeline, or folder. For example, if a customer/employer (e.g., operating a customer/employer computing entity 110) selects a pay rate of $15 per hour using a slider control, for example, the management computing entity 100 can add text to the work/job description in an advertisement, such as adding “Pays $15 per hour” to the work/job description. Further, the management computing entity 100 may also include other information/data, such as desired skills, target work/job title, and/or the like deemed appropriate to include in such advertisements. These advertisements can be used in the advertising campaigns as described previously.

In the above display of a customer/employer computing entity 110, the customer/employer (e.g., operating a customer/employer computing entity 110) has set the search filter to a wage range of $10 to $25 per hour. In this scenario, the management computing entity 100 can add text to a work/job description of an advertisement for the position that reads “Pays between $10 and $25 per hour, depending on experience.” Similarly, since the customer/employer (e.g., operating a customer/employer computing entity 110) has selected an experience range of 2 to 8 years, the management computing entity 100 can insert text into a work/job description of an advertisement for the position that reads “Requires between 2 and 8 years of experience.”

In one embodiment, associating filter options with text to automatically insert into or add to a work/job description for an advertisement can apply for virtually any type of filter interface. In the above screen, for example, the customer/employer (e.g., operating a customer/employer computing entity 110) can select from multiple options. And each option can be associated with template text to insert or add. For example, if a customer/employer (e.g., operating a customer/employer computing entity 110) selects “Knowledge of wines,” the management computing entity 100 can insert text into a work/job description of an advertisement for the position that reads “Requires knowledge of wines.”

In one embodiment, the management computing entity 100 may use text templates to add to such work/job descriptions. The text templates may reference variables that may change depending on filter settings. Table 1 below is an exemplary data table that may be used by the management computing entity 100 to associate filter settings with descriptive text.

TABLE 1

| Filter Setting | Descriptive Text |
|---|---|
| Wage | Pays between [LOW_RANGE] and |
| | [HIGH_RANGE] per hour. |
| Experience | Requires between [LOW_RANGE] and |
| | [HIGH_RANGE] years of experience. |

### Providing Real-Time Labor Market Information

In one embodiment, the management computing entity 100 may provide value to customers/employers by providing real-time labor market information/data to candidates and/or customers. This may include (a) informing customers/employers how much more they would have to pay per hour if they select additional skills for candidates and/or (b) informing candidates how much more they could make if they earn a degree, possess a skill, or have a certification. As will be recognized, such information/data may be based on market demand for the base occupation/job/position, specified skills, and/or the like.

In one embodiment, candidates (e.g., operating candidate computing entities 105) may be prompted to enter their required hourly rates. The management computing entity 100 can then scan the database to determine the average hourly rate, for example, that is demanded by candidates in the target market in which customers/employers are seeking candidates. When additional skills are added, the management computing entity 100 can re-determine the average hourly rates by excluding candidates who do not match the additional filters (see Table 2 below).

TABLE 2

| | |
|---|---|
| Role You Want To Fill: | Your selected options: |
| [symbol] | Role: Server |
| Desired Skills: | Skills: None specified |
| [symbol] Knowledge of Wines | Based on selected criteria, the average wage |
| [symbol] Online Ordering Systems | demanded by candidates is: $10/hour |
| [symbol] Reservation Systems | |

For example, the above shows exemplary output (as determined by the management computing entity 100) of a wage analysis for a server role with no skills selected: $10/hour (see Table 3 below).

TABLE 3

| | |
|---|---|
| Role You Want To Fill: | Your selected options: |
| [symbol] | Role: Server |
| Desired Skills: | Skills: Knowledge of Wines |
| [symbol] Knowledge of Wines | Based on selected criteria, the average wage |
| [symbol] Online Ordering Systems | demanded by candidates is: $12/hour |
| [symbol] Reservation Systems | |

However, if a candidate or customer/employer selects the “Knowledge of Wines” skill, the management computing entity 100 may determine the average with the added as an increase to $12/hour and cause display of the same via the appropriate computing entity. In various embodiments, this may be beneficial to both candidates and customers.

In one embodiment, if a customer/employer hires a more-qualified candidate, the management computing entity 100 can generate notifications (e.g., emails, messages, notifications, and/or the like) to candidates who were invited but not hired. Such notifications may include information/data as to why another candidate was hired. Such notifications may also recommend paths to obtain similar positions by, for example, earning additional certifications. To do so, the management computing entity 100 may compare the additional skills of the candidate who was hired to the candidate who was not hired (e.g., based on the candidate profiles) to determine what recommendations should be provided via the notifications. For example, the management computing entity 100 can query the candidate database to identify any skills the hired candidate has that the candidate who was not hired does not have. Where possible, the management computing entity 100 can also recommend training courses to the candidate that can be used to obtain the identified skills Table 4 below provides a programmatic example of such an implementation.

TABLE 4

| Skill | Suggested Course | Course Cost |
|---|---|---|
| Knowledge of Wines | Wine Steward Class | $100 |
| Responsible Serving of | Alcohol Responsibility | $150 |
| Alcohol | Certification Class | |

In one embodiment, market data can be used to highlight the skill or skills that were most likely the driving factors in the customer's decision. To do so, the management computing entity 100 may perform a regression test to check the statistical relevance of skills that the candidate who was not hired lacks in relation to the skills of candidates who have been hired by customers. As will be recognized, a variety of other approaches and techniques can be used to adapt to various needs and circumstances.

### Candidate Return on Investment Calculator

In one embodiment, the management computing entity 100 can analyze the difference in average hourly rates between candidates who have and who do not have a particular certification or skill. Then, the management computing entity 100 can analyze the costs to obtain such certifications or skills and determine the estimated return on investment for the candidate: the length of time it may take for the certification to pay off or another measure such as whether it pays off on a relative basis. As will be recognized, a variety of other approaches and techniques can be used to adapt to various needs and circumstances.

### Brand Scores

In one embodiment, the management computing entity 100 can determine brand scores for customers/employers, for customers/employers based on geographic areas, for specific occupations/positions for customers/employers, and/or at specific candidate sources. The brand scores may be based on response rates (e.g., interview request response rates, registration/enrollment rates, and/or the like) from candidates for postings/advertisements at one or more candidate sources (e.g., FIGS. 10047-10048). To determine/identify brand scores, the management computing entity 100 can receive information/data from the various candidate sources associated with postings/advertisements provided to the candidate sources (e.g., candidate source computing entities). The management computing entity 100 can receive this information/data regularly, periodically, continuously, and/or in response to certain triggers. The information/data may comprise the number of impressions, number of clicks (e.g., selections), the number of candidates sourced, the geographic areas for the postings/advertisements, and/or the like.

In embodiment, for each electronic posting/advertisement for a customer/employer, the management computing 100 can determine/identify the number of clicks (e.g., selections) that resulted from the electronic posting/advertisement (e.g., user selections of the electronic posting/advertisement). For example, if Company A has an electronic posting/advertisement for a server on Craigslist.com in Tampa, Fla., and received 5 clicks for the posting/advertisement, the management computing entity 100 can determine Company A's brand score for server in Tampa as being 5%. Similarly, if Company B has a posting/advertisement on for a server on Craigslist.com in Tampa, Fla., and received 47 clicks (e.g., selections), the management computing entity 100 can determine Company B's brand score for a server in Tampa as being 47%. As will be recognized, a variety of other techniques and approaches can be used to adapt to various needs and circumstances.

In one embodiment, for a given customer/employer, a brand score can be based on one or more occupations/positions, geographic areas, and/or the like. For instance, based on the received information/data, the management computing entity 100 can determine/identify that Company A has a relatively low brand score (5%) for servers in Tampa (e.g., 5 clicks for 100 impressions), but has a relatively high brand score (51%) for cashiers (e.g., 51 clicks for 100 impressions). Similarly, the management computing entity 100 can determine/identify that Company A has a relatively low brand score (5%) for servers in Tampa (e.g., 5 clicks for 100 impressions), but has a moderate brand score (34%) for servers in Atlanta, Ga. (e.g., 5 clicks for 100 impressions).

The management computing entity 100 can then provide the brand score the customer/employer (e.g., via a customer/employer computing entity 110). In one embodiment, the management computing entity 100 can also provide a brand score index. The brand score index may comprise the brand scores of other customer/employers with similar occupations/positions and/or in similar geographic areas. FIG. 10048 shows an exemplary brand score index for a company compared to a composite of multiple other companies in the same geographic areas. By exploring these ratios, customers/employers can have a better understanding as to the “attractiveness” of their occupations/positions. As will be recognized, a variety of other approaches and techniques can be used to adapt to various needs and circumstances.

### Invitation Content

In one embodiment, the management computing entity 100 may vary the content of invitations/messages/notifications to candidates from customers/employers to increase response rates (e.g., interview request response rates). Such content may include statistics to persuade candidates to respond “Yes.” For example, the invitation may include text that reads “This company pays 50% more per hour than others in this industry,” “This company has a short interview process,” or “Did you know that your friend John Doe (e.g., a Facebook friend) works at this company.” Similarly, the content may provide questions to which candidates can respond, such as “Does the customer/employer have realistic salary expectations?”. As will be recognized, a variety of other approaches and techniques can be used to adapt to various needs and circumstances.

### Pricing Supply Stock Based on Market Available Demand

In one embodiment, the management computing entity 100 may have supply and demand data for many occupations types and geographic areas, such as data indicating that there are more nurses (e.g., employed nurses, nurses seeking employment, or nursing positions open) in New York than Chicago. If there are more nurses in New York than Chicago, the management computing entity 100 can automatically price nursing positions higher to customers/employers in Chicago, for example. In one embodiment, the management computing entity 100 may generate a salary calculator and data not based on historic data or work/job posting information/data which is not very accurate, but use actual real-time wage data being offered or accepted through the management computing entity 100. Such a salary calculator may be implemented as a tool where interested parties, such as candidates or clients, could look up the going rate for a given work/job title in a given location. As will be recognized, a variety of other approaches and techniques can be used to adapt to various needs and circumstances.

### Determining/Identifying Candidates Geographic Areas or Locations

In one embodiment, customers/employers may want to reach to candidates based on the candidates' current geographic areas or locations. For example, a restaurant in the Dubai Mall may have an immediate need to interview candidates who are currently in the same mall. Thus, the customer's (e.g., operating a customer/employer computing entity 110) search criteria may indicate that the customer/employer wants to contact candidates who are in the immediate geographic area of the customer/employer.

In one embodiment, to identify such candidates within a specific geographic area or at a specific geographic location, the management computing entity 100 can define geofences are the geographic areas or locations of the customers/employers (e.g., an acceptable range). For example, for the restaurant in the Dubai Mall, the management computing entity 100 can define a geofence around the Dubai Mall, a one mile radius from the center point of the restaurant's location, and/or the like. Geofences may be defined to surround a geographic area or location, such as surrounding countries, regions, states, counties, cities, towns, interstates, roads, streets, avenues, toll roads, zip codes, area codes, ways, exit and entrance ramps, delivery routes, bus routes, taxis routes, industrial parks, neighborhoods, off-road areas (e.g., areas without paved roads), private land areas, parking lots (e.g., at malls or other establishments), driveways, and/or the like. The geofences may be defined, for example, by the latitude and longitude coordinates associated with various points along the perimeter of the geographic area. Alternatively, geofences may be defined based on latitude and longitude coordinates of the center, as well as the radius, of the geographic area. Geofences may be as large as an entire country, region, state, county, city, or town (or larger). The geographic areas, and therefore the geofences, may be any shape including, but not limited to, a circle, square, rectangle, an irregular shape, and/or the like. Moreover, the geofenced areas need not be the same shape or size. Accordingly, any combination of shapes and sizes may be used in accordance with embodiments of the present invention. Similarly, a geofence may overlap or reside wholly within another geofence.

In one embodiment, after one or more geofences have been defined, the location of candidate computing entities 105 can be monitored. For example, the location of candidate computing entities 105 can be determined with the aid of location-determining devices and/or other telemetry location services (e.g., cellular assisted GPS or real time location system or server technology using received signal strength indicators from a Wi-Fi network). By using the candidate computing entity's 105 location, an appropriate computing entity (e.g., management computing entity 100, candidate computing entity 105, and/or customer/employer computing entity 110) can determine, for example, when the candidate computing entity 105 enters, exits, is within, and/or is outside a defined geofence. In one embodiment, the management computing entity 100 can determine/identify the geographic area or location of each candidate when the candidate accesses the candidate application, for instance, or during certain times of the day or in response to certain triggers.

When the monitoring computing entity 100 identifies candidates within a specific geographic area or location (e.g., within an acceptable range), the monitoring computing entity 100 can provide messages/notifications regarding the customer's immediate need to candidates who are within or outside the geographic area or location and who match the customer's other criteria. Moreover, the management computing entity 100 can filter the candidate profiles to, for instance, only show candidate profiles for a campaign or pipeline that are currently within a defined geofence. Thus, the candidates may be able to quickly arrive at the customer's physical location. As will be recognized, a variety of other approaches and techniques can be used to adapt to various needs and circumstances.

### Supply Driven Advertising of Candidates to Customers

In one embodiment, if the management computing entity 100 identifies a surplus of a certain type of candidate, the management computing entity 100 may initiate/trigger marketing to customers/employers using autodialers, emails, and/or the like. For example, if there are more candidates of a certain type available in a geographic area, the management computing entity 100 can search customers/employers in the customer/employer database to find any who have looked for those types of candidates in the specific location. With such a match, the management computing entity 100 can initiate/trigger an outreach campaign to notify the customers/employers of the candidate availability.

In another embodiment, the management computing entity 100 can post a supply driven advertisement to the greater market notifying the market of candidates in occupations who could be hired right away, such as nurses available in New York who are available to start this week. Because there are certain types of positions where customers/employers have a constant need to hire certain types of candidates, such positions can be used to drive revenue.

In one embodiment, the management computing entity 100 can prioritize running supply driven marketing campaigns for positions that internal data indicates is within the category of being a constant need for customers. The management computing entity 100 can offer an auto-contacting agent function, for example, that allows customers/employers to indicate criteria of candidates for whom they want to automatically send/transmit/provide invitations/messages/notifications for interviews. Based on the work/job types for which customers/employers have configured auto-contacting agents, the management computing entity 100 may determine that such work/job types are in constant need. As will be recognized, a variety of other approaches and techniques can be used to adapt to various needs and circumstances.

### Suggesting Work/Job Types for Candidates to Target

In one embodiment, the management computing entity 100 may maximize the likelihood of candidates being selected by customers/employers by suggesting work/job titles or occupations/jobs/positions for which they are qualified. For example, candidates (e.g., operating candidate computing entities 105) who sign up for the service can select any number of desired work/job titles or occupations/jobs/positions, regardless of their prior work experience. The management computing entity 100 can determine, however, the likelihood that a customer/employer will select candidates with a given work history and/or experience for a given work/job title or occupation/job/position. In an embodiment in which candidate profiles are provided to a customer/employer (e.g., operating a customer/employer computing entity 110) in search results only if the candidates indicate they are seeking the work/job title or occupation/job/position for which the customer/employer is searching, the likelihood of a customer/employer selecting a candidate for that work/job title or occupation/job/position may vary based on various factors. The factors may include shift availability, skills, geographic proximity, work experience (such work history analysis could include work/job titles that are the same or in the same family of work/job titles as positions held by the candidate in consideration), and/or the like.

In one embodiment, a candidate (e.g., operating a candidate computing entity 105) who creates a profile may, after entering his or her work experience, be provided (by the management computing entity 100) with work/job titles or occupations/jobs/positions for which he or she may want to indicate an interest. The provided work/job titles or occupations/jobs/positions may be based on the work/job titles or occupations/jobs/positions for which customers/employers have selected other candidates with similar work experience.

In one embodiment, the management computing entity 100 may also maximize the likelihood of candidates being selected by customers/employers by suggesting work/job titles or occupations/jobs/positions for which the candidates are qualified by considering how candidates with a given work history progress through the hiring funnel when being considered for a particular work/job title or occupation/job/position. To do so, the management computing entity 100 may consider a variety of funnel statistics across all customers/employers or across select customers/employers that would be most relevant to the candidate in consideration, such as customers/employers in their geographic area. Such funnel statistics may take into account or include how quickly these types of candidates (e.g., based on occupation/job/position, demographic information/data, and/or the like) respond to customer/employer invitations/messages/notifications, whether these candidates respond yes, other relevant metrics, and/or the like. The management computing entity 100 can glean such third-party demand data in real time or near real time as candidate profiles are created, candidates are contacted by customers, candidates progress through hiring funnels, and/or candidates are hired by customers. This approach enables the management computing entity 100 to use actual marketplace or demand data (e.g., based on customers/employers using the services of the management computing entity 100 to hire candidates). Additionally or alternatively, data from a variety of external sources can also be used, such as data from the Bureau of Labor Statistics. As will be recognized, a variety of other approaches and techniques can be used to adapt to various needs and circumstances.

### Application to Other Areas

Although the preceding is described in the context of providing candidates to customers/employers for employment, the above-described concepts may be applied to a variety of other areas. For example, in place of customers/employers seeking candidates, customers/employers may desire goods or services from candidates. Thus, customers/employers may be parties who would like to purchase goods or pay for services that are available through various candidates. In such a case, the above-described concepts can be used to match candidates with goods or services available to customers/employers seeking those goods or services. As will be recognized, a variety of other approaches and techniques can be used to adapt to various needs and circumstances.

In another embodiment, customers/employers may be seeking candidates who are potential sales leads—candidates who may be interested in purchasing goods or services from customers. In such a case, the above-described concepts can be used to match candidates interested in particular goods or services to customers/employers providing those goods or services. As will be recognized, a variety of other approaches and techniques can be used to adapt to various needs and circumstances.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
for a campaign for an employment position, identifying one or more active candidate profiles from a first plurality of active candidate profiles for the campaign for the employment position, wherein:
(a) an active candidate profile identifies a candidate who has responded to a notification within a configurable time period indicating interest in the employment position, and
(b) each of the one or more active candidate profiles indicate that the respective candidates are within an acceptable range from the location of the employment position.

2. The computer-implemented method of claim 1, wherein the acceptable range is selected from the group consisting of a commute time and a commute distance.

3. The computer-implemented method of claim 1, wherein (a) the acceptable range is geofenced area and (b) each of the one or more active candidate profiles is identified based at least in part on the current location of a computing entity associated with the active candidate profile.

4. The computer-implemented method of claim 1, wherein the employment position is selected from the group consisting of an employment position with a particular employer and a particular type of employment position.

5. The computer-implemented method of claim 1, wherein only active candidate profiles are accessible for the campaign for the employment position.

6. The computer-implemented method of claim 1 further comprising determining whether a number of the first plurality of active candidate profiles for the campaign satisfies a configurable threshold.

7. The computer-implemented method of claim 1, wherein each of the one or more active candidate profiles is associated with one list of a plurality of lists for display.

8. The computer-implemented method of claim 1 further comprising:
receiving a request to access the campaign; and
responsive to receiving the request to access the campaign, identifying additional active candidate profiles from a second plurality of active candidate profiles.

9. The computer-implemented method of claim 1, wherein an employer pays a fee for the electronic search.

10. An apparatus comprising at least one processor and at least one memory including program code, the at least one memory and the program code configured to, with the processor, cause the apparatus to at least:
for a campaign for an employment position, identify one or more active candidate profiles from a first plurality of active candidate profiles for the campaign for the employment position, wherein:
(a) an active candidate profile identifies a candidate who has responded to a notification within a configurable time period indicating interest in the employment position, and
(b) each of the one or more active candidate profiles indicate that the respective candidates are within an acceptable range from the location of the employment position.

11. The apparatus of claim 10, wherein the acceptable range is selected from the group consisting of a commute time and a commute distance.

12. The apparatus of claim 10, wherein (a) the acceptable range is geofenced area and (b) each of the one or more active candidate profiles is identified based at least in part on the current location of a computing entity associated with the active candidate profile.

13. The apparatus of claim 10, wherein the employment position is selected from the group consisting of an employment position with a particular employer and a particular type of employment position.

14. The apparatus of claim 10, wherein only active candidate profiles are accessible for the campaign for the employment position.

15. The apparatus of claim 10, wherein the memory and program code are further configured to, with the processor, cause the apparatus to determine whether a number of the first plurality of active candidate profiles for the campaign satisfies a configurable threshold.

16. The apparatus of claim 10, wherein each of the one or more active candidate profiles is associated with one list of a plurality of lists for display.

17. The apparatus of claim 10, wherein the memory and program code are further configured to, with the processor, cause the apparatus to:
receive a request to access the campaign; and
responsive to receiving the request to access the campaign, identify additional active candidate profiles from a second plurality of active candidate profiles.

18. The apparatus of claim 10, wherein an employer pays a fee for the electronic search.

19. A computer program product comprising at least one non-transitory computer-readable storage medium having computer-readable program code portions stored therein, the computer-readable program code portions comprising:
an executable portion configured to for a campaign for an employment position, identify one or more active candidate profiles from a first plurality of active candidate profiles for the campaign for the employment position, wherein:
(a) an active candidate profile identifies a candidate who has responded to a notification within a configurable time period indicating interest in the employment position, and
(b) each of the one or more active candidate profiles indicate that the respective candidates are within an acceptable range from the location of the employment position.

20. The computer program product of claim 19, wherein the acceptable range is selected from the group consisting of a commute time and a commute distance.

21. The computer program product of claim 19, wherein (a) the acceptable range is geofenced area and (b) each of the one or more active candidate profiles is identified based at least in part on the current location of a computing entity associated with the active candidate profile.

22. The computer program product of claim 19, wherein the employment position is selected from the group consisting of an employment position with a particular employer and a particular type of employment position.

23. The computer program product of claim 19, wherein only active candidate profiles are accessible for the campaign for the employment position.

24. The computer program product of claim 19 further comprising an executable portion configured to determine whether a number of the first plurality of active candidate profiles for the campaign satisfies a configurable threshold.

25. The computer program product of claim 19, wherein each of the one or more active candidate profiles is associated with one list of a plurality of lists for display.

26. The computer program product of claim 19 further comprising:
an executable portion configured to receive a request to access the campaign; and
an executable portion configured to, responsive to receiving the request to access the campaign, identify additional active candidate profiles from a second plurality of active candidate profiles.

27. The computer program product of claim 19, wherein an employer pays a fee for the electronic search.
